(19) United States
(12) Patent Application Publication
(10) Pub. No.: US 2026/0311120 A1
(43) Pub. Date: Oct. 8, 2026

(54) METHOD FOR TRACKING TRANSFER(S) OF A MATERIAL AND A PRODUCT CONTAINING SAID MATERIAL IN A DECENTRAL NETWORK

(71) Applicant: BASF SE, Ludwigshafen Am Rhein (DE)

(72) Inventor: Henning SCHWABE, Ludwigshafen am Rhein (DE)

(21) Appl. No.: 18/880,615

(22) PCT Filed: Jun. 23, 2023
(86) PCT No.: PCT/EP23/67183

§ 371 Date: Jan. 2, 2025

(30) Foreign Application Priority Data
Jul. 5, 2022 (EP) 22183049.0
Jul. 5, 2022 (EP) 22183050.8
Jul. 5, 2022 (EP) 22183059.9
Jul. 5, 2022 (EP) 22183064.9
Jul. 5, 2022 (EP) 22183065.6
Jul. 5, 2022 (EP) 22183074.8
Jul. 6, 2022 (EP) 22183367.6

(51) Int. Cl. G06Q 10/087

(52) U.S. Cl. CPC G06Q 10/08744

(57) ABSTRACT

Disclosed herein is a computer-implemented method for tracking at least one transfer associated with a material and at least one product containing the material in a decentral network. The decentral network includes a distributed ledger that includes multiple member nodes and the distributed ledger includes material transfer transactions containing material data associated with the material and product transfer transactions containing product data associated with the at least one product containing the material.

### TECHNICAL FIELD

The present disclosure relates to a computer-implemented method and an apparatus for tracking at least one transfer associated with a material and at least one product containing the material in a decentral material network, a use of the transfer balance generated by the inventive method or using the inventive apparatus to validate material transfers associated with a material and product(s) containing the material, and a computer element.

### TECHNICAL BACKGROUND

The present disclosure relates, in general terms, to validating transfers associated with a material and product(s) containing said material in a distributed system by determining the mass balance of said transfers.

Such a distributed system comprises an arbitrary number of producer and consumer nodes. Apart from the end consumer, all nodes consume products made of mass flows to produce other products made of mass flows. In such a distributed system, forecasting and steering of production/consumption nodes is desired to achieve target values of system wide verifiable key performance indicators (KPI), such as total emissions of distributed system (GHG, air/water/land pollution), total recycling quota of distributed system, environmental impact profile of distributed system, etc..

These system wide KPIs contrast with local indicators valid only for a single pair of nodes. Local “success stories” are known to create displacement effects (“carbon leakage” where GHG emissions increase in other producer countries, i.e., parts of the network) or rebound effects (where local production improvements are overcompensated by increased overall consumption) so that system performance gets worse overall while local performance is improving.

The standard implementation of a distributed system is either a hub-and-spoke system or a peer-to-peer system. Hub-and-spoke systems suffer from strong centralization that give the hub owner either monopolistic power over all participating production and consumption nodes or lead to unwieldy, inept bureaucracy as all participants share ownership of the central hub (“shareholder democracy”). Peer-to-peer networks are good at steering local KPIs between supplier and consumer. Yet, P2P networks have no means to guarantee complete, uninterrupted supply chains without missing links, let alone verifiable mass balances of supply chains, in particular circular supply chains, since no central authority has oversight. Introducing a mass balance authority to a peer-to-peer network would in turn lead to the hub-and-spoke system with shareholder bureaucracy.

To steer a material-based distributed system, it is decisive to establish the mass balance of said distributed system. Controlling the mass balance on both node and distributed system level allows to identify which nodes must be steered to achieve the system wide target KPI. To this end the distributed mass balance may be coupled with an optimization algorithm such as MILP algorithm or an evolutionary or genetic optimization algorithm. This task is very similar to steering a set of process units in chemical manufacturing system.

The existing technology of choice to establish a mass balance across a distributed system of diverse legal entities is a consensus mechanism implemented on a distributed ledger, such as a blockchain, which is transparent, ensures integrity by design and provides public verifiability of some statement. Mass balancing entails tracking that the mass of material being transferred is consistent over all steps in the production chain involving the material or products produced from said material. In particular, it may be used for ensuring that material does not simply disappear from the value chain. Mass balancing can be performed system wide, i.e. over a complete supply chain for a given product or group of products, on company-level or on product level, i.e. for a specific product. System wide mass balancing can be performed by monitoring the total input amount, i.e. the total amount of raw materials supplied to upstream participants of the production chain, and the total output amount. In case of a linear process where the produced products are not recycled and the complete product is disposed on a landfill, the total output amount corresponds to the amount of products disposed to the landfill. For circular processes where products are at least partly recycled or reused, the total output amount corresponds to the total amount of recycled products plus the total amount of unrecycled products (i.e. waste products) disposed on a landfill. Mass balancing on a company-level can be performed as previously mentioned by comparing the total amount of materials purchased by said company and the total amount of products produced by said company. To perform mass balancing on product-level, apart from the total amount of starting materials and the total amount of product resulting from said starting materials, also the recipe containing information about the ratios or amounts of starting materials used to produce the product is necessary to perform mass balancing.

To monitor the mass flow within a production chain, information about mass input and mass output can be stored on a distributed ledger to provide public verifiability. Everyone who has access to the distributed ledger (e.g., governmental authorities or non-governmental organizations) can read each of the amounts, sum them up, and compare the resulting amount to each other. This approach moreover allows to monitor certain predefined quota (i.e. maximum values stipulated by governmental regulations, minimum values stipulated by governmental regulations, etc.), such as CO₂ emissions of each company within the production chain or of the complete distributed system, by accessing the distributed leger and reading each of the produced amounts, sum them up, and compare the resulting amount to the predefined quota.

While this approach ensures transparency and enables verifiability, it may be associated with some disadvantages. For example, such a technique may reveal details about a final product such as, depending on the industry, a recipe (e.g., single ingredients or amounts of ingredients) or details about the complete supply chain within a production chain. That is, this form of publicly verifiable mass balancing does not preserve any privacy and could adversely impact a company's competitive advantage. Furthermore, this type of non-privacy-preserving storage of data in a distributed ledger might conflict with legal regulations, such as the General Data Protection Regulations (“GDPR”) of the European Union.

A certain level of privacy for the data stored in the distributed ledger can be achieved by hiding the identities of the parties and transferred materials/products. However, this requires private communication channels between the involved parties (e.g., supplier—customer) to exchange data privately that must not appear in the distributed ledger in a transparent way, such as the aforementioned identities and details on the transferred material/product.

Hence, an object of the present invention is to provide an improved mass balancing method which can be performed in an efficient and automated manner and ensures the necessary privacy of the data stored in the distributed ledger while avoiding the use of private communication channels.

### SUMMARY OF THE INVENTION

These and other objects, which become apparent upon reading the following description, are solved by the subject matters of the independent claims. The dependent claims refer to preferred embodiments of the invention.

In one aspect, a computer-implemented method for tracking at least one transfer associated with a material and at least one product containing said material in a decentral network is disclosed. The decentral network comprises a distributed ledger that includes multiple member nodes and said distributed ledger includes material transfer transactions containing material data associated with the material and product transfer transactions containing product data associated with the at least one product containing the material. The method includes the steps of:
receiving at least one data set, each data set including data of at least one material transfer transaction containing the material data and/or data of at least one product transfer transaction containing the product data associated with the product(s) containing the material,
retrieving the material data and the product data based on the received data set(s),
tracking at least one transfer by determining a transfer balance associated with the material and the at least one product based on the retrieved material data and the retrieved product data, and
providing the at least one tracked transfer.

In another aspect, an apparatus for tracking at least one transfer associated with a material and at least one product containing the material in a decentral network is disclosed. The decentral network comprises a distributed ledger that includes multiple member nodes and said distributed ledger includes material transfer transactions containing material data associated with the material and product transfer transactions containing product data associated with the at least one product containing the material. The apparatus comprises one or more computing nodes and one or more computer-readable media having thereon computer-executable instructions that are structured such that, when executed by the one or more computing nodes, cause the apparatus, particularly one or more of the computing nodes, to perform the following steps:
receiving at least one data set, each data set including data of at least one material transfer transaction containing the material data and/or data of at least one product transfer transaction containing the product data associated with the product(s) containing the material,
retrieving the material data and the product data based on the received data set(s),
tracking at least one transfer by determining a transfer balance associated with the material and the at least one product based on the retrieved material data and the retrieved product data, and
providing the at least one tracked transfer.

The present disclosure may also provide, in yet another aspect, a data processing system, particularly a distributed data processing system comprising a plurality of computing nodes, the data processing system, in particular one or more of the plurality of computing nodes, being configured to carry out the method of the present disclosure, particularly, in a distributed manner.

A further aspect of the present invention relates to the use of a transfer balance generated according to the method of the present disclosure for using the apparatuses and data processing systems of the present disclosure to validate material transfers associated with a material and product(s) containing the material.

In yet another aspect, a computer element with instructions, which when executed on one or more computing node(s) is configured to carry out the steps of the method of the present disclosure or configured to be carried out by the apparatus of the present disclosure.

The present disclosure may also provide, in yet another aspect, a computer program product comprising instructions which, when the program is executed by a data processing system, cause the data processing system to carry out the method of the present disclosure. The data processing system may be a distributed data processing system comprising a plurality of computing nodes.

The present disclosure may also provide, in yet another aspect, a computer-readable medium comprising instructions which, when the program is executed by a data processing system, cause the data processing system to carry out the method of the present disclosure. The data processing system may be a distributed data processing system comprising a plurality of computing nodes.

Any disclosure and embodiments described herein relate to the methods, the apparatuses, the computer element lined out above or below and vice versa. The benefits provided by any of the embodiments and examples equally apply to all other embodiments and examples and vice versa.

As used herein “determining”also includes “initiating or causing to determine”, “generating”also includes “initiating and/or causing to generate” and “providing” also includes “initiating or causing to determine, generate, select, send and/or receive”. “Initiating or causing to perform an action” includes any processing signal that triggers a computing node or device to perform the respective action.

The methods, apparatuses and computer elements disclosed herein provide an efficient way to determine the mass balance across a distributed system of diverse legal entities, for a single company or on a product-level using a consensus mechanism implemented on a distributed ledger as well as the “need-to-know” principle. This “need-to-know” principle is implemented by anonymizing the involved parties as well as the involved material or product being transferred but leaving the transferred mass de-anonymized. For example, the use of cryptographic credentials, e.g., signatures and public/private keys, as well as pointers to the respective material/product data, is advantageous to this end. Anonymizing the involved parties as well as the involved material/product allows public access to the data stored in the distributed ledger, because the stored data is sufficiently de-anonymized and does not allow to reconstruct the involved parties as well as the exact material/product associated with the stored transactions. Leaving the transferred mass de-anonymized allows to verifiably tracking system wide key performance indicators (KPIs), such as the recycling quota of a circular distributed system, the GHG emissions of the distributed system, the throughput or flow rate in the material loop within a circular distributed system, the consumption of virgin material in comparison to throughput within a circular distributed system, the rate of irretrievable loss of material within a circular distributed system, etc., of the overall distributed system by the public and/or regulators alike in a transparent way.

For example, specific “addresses” or “destinations” can be assigned to KPIs, such as GHG emissions or waste produced by the distributed system and said addresses can be made available to the public. The total amount transferred to these addresses can then be accessed by the public or/or auditors and either directly represents certain KPIs or can be used to determine or calculate further KPIs.

The key benefit to the public is precisely the ability of the distributed ledger to provide a verifiable foundation for performance reporting while keeping market competition intact. The benefit to each participant lies in the verifiable material foundation of every claim made towards consumer or investor. These claims no longer run the risk of being invalidated by manipulating data (e.g., fraudulent recycling claims, material origin claims, etc.). Likewise, no participant can make falsely exaggerated sustainability claims. Verification of claims by auditors or regulators is ensured because each transaction stored in the distributed ledger can be de-anonymized under the “need-to-know” principle, that is, each transaction is identified and signed by a public/private key pair that can be traced back to its owner. This requirement also ensures that existing “know your customer” and “anti-money laundering” requirements are implemented consistently by participants of the distributed system making use of the inventive methods and apparatuses.

The implemented “need-to-know” principle renders it necessary to exchange or share details on the transferred material/product between the involved parties via a separate communication channel. Instead of using private communication channels between the involved parties, a secure and efficient standardized data exchange platform is used for transferring data sets containing said details via said platform. The data sets combine data of the material or product with a decentral identifier and optionally one or more authentication mechanisms and allow a more reliable and secure data sharing and exchange over a single platform while the data contained in said data sets remains in the ownership of the party providing the data set. By further including one or more authorization mechanisms, the data sharing or exchange can be conducted in a more flexible manner with multiple data consuming services from different participants of the chemical supply chain accessing the data sets.

The present method thus combines (i) a platform allowing exchange of data sets which-on its own—is unsuitable to establish an overall closed and verifiable mass balance but allows for efficient and secure data exchange between all parties of a distributed system with (ii) a decentral network comprising a distributed ledger which is used to immutably and verifiably store information necessary to perform mass balancing on the material flow(s) of said distributed system. Combination of these two systems allows for a significant degree of anonymization of the data stored within the distributed ledger and used for monitoring mass flows while ensuring an efficient and secure data exchange between all parties of the distributed system via a single platform to allow sharing of details on the transferred material/product(s) and involved parties.

### EMBODIMENTS

The inventive method and apparatus is concerned with tracking material transfers by determining a transfer balance associated with a material and at least one product containing the material using a distributed ledger, said distributed ledger containing material transfer transactions associated with the material and product transfer transactions associated with product(s) containing said material. The distributed ledger may be seen as a shared, replicated, and synchronized database among member nodes of the decentralized network, such as a P2P network. In general, the distributed ledger records transactions between participants of the network and thus provides an immutable history of said transactions. Updates of the distributed ledger, e.g. storage of further material transfer transactions and/or product transfer transactions, may be performed based on a consensus algorithm. When an update occurs, all member nodes of the distributed are updated with the current version of the ledger. Blockchain applications are a specific example of a distributed ledger application. The nature of the distributed ledger is that there is no centralized authority, e.g., a clearing house.

The Material and Product Transfer Transactions Each Contain Material Data and Product Data, respectively.

In one embodiment, the material data includes material transaction meta data and the amount of the material, e.g. the amount of material transferred in the course of the transfer of the material. The material transaction meta data may be used, for example, to retrieve from a database, e.g., a MongoDB database, data being indicative of the material that is associated with said transaction. Such data being indicative of the material that is associated with said transaction may, for example, be a pointer, such as a hash pointer, or a link to access a data set associated with said material, or an access point to a data set.

Material transaction meta data may be seen as data representative of the transferred material. Material transaction meta data may include one or more of a material identifier, at least one material classification, and material production data.

As an example, the material production data may comprise one or more of a time stamp, a production site, a country of production, and a batch ID. This allows for efficient information access and retrieval, e.g. in a database holding information of the transferred material, and may also allow for the participants of the transfer, but not necessarily any other parties, to access more information than is stored in the actual transaction, for example by using said material production data in combination with the material identifier described in the following. It is, thus, possible, to keep exact track of a specific unit of material over the course of multiple transfer steps, processing steps, and the like, without having to pass on all of the previous history within each transaction. Thus, the transactions remain manageable in size, do not require particular means for protecting sensitive data, and can still provide reliable tracking.

According to the present disclosure, the material identifier may include a digital representation pointing to a data set, e.g., a material passport or a material data set, or parts thereof. Said pointer, such as a hash pointer, may be used to retrieve details on the transferred material, such as its properties, compositions etc., using a single data exchange platform. For example, the transaction itself may, according to the present disclosure, not comprise any specific details on the material associated with the material transfer. This may ensure, for example, that the transaction may be made public while keeping details on the material being transferred and the involved parties private. As a more specific example, a transaction may comprise transaction meta data comprising the digital representation pointing to the data set or parts thereof.

The term “digital representation(s) pointing to a data set or parts thereof” is to be understood broadly in the present case and may comprise at least one interface to a data providing service. It may further include at least one interface to a data consuming service. It may include an endpoint for data exchange or sharing (resource endpoint) or an endpoint for service interaction (service Endpoint), that is uniquely identified via a communication protocol.

The amount of material is used for the purposes of determining the transfer balance, e.g., performing mass balancing, as described later on. This information may be less sensitive than information related to the transferred material as well as the identity of the involved parties, such that for transparency purposes, e.g., mass balancing, it may be advantageous to not anonymize the amount of transferred material contained in the transaction. Anonymization of data related to the transferred material as well as the involved parties but ensuring that said information can be retrieved, if necessary, for example from a database, allows for improved access control and privacy. Particularly, this allows for sensitive data to be managed by a trusted party, e.g., that is deemed reliable and/or may be subject to audits, and also ensures reliable and continuous access to the information. Moreover, this allows to use a public distributed ledger because sensitive information, like material data and the identity of the involved parties, cannot be derived from the transaction data. However, knowing the identity of the involved parties allows trusted parties to monitor material flows, such as waste material flows.

In one embodiment, the product data includes product transaction meta data and the amount of the product containing the material. The transaction meta data may be used, for example, to retrieve from a database, e.g., a MongoDB database, data being indicative of the product containing the material that is associated with said transaction. Such data being indicative of the product containing the material that is associated with said transaction may, for example, be a pointer, such as a hash pointer, or a link to access a data set associated with said product, or an access point to a data set.

Product transaction meta data may be seen as data representative of the transferred product containing the material. Product transaction meta data may include one or more of a product identifier, at least one product classification and product production data. As an example, the product production data may comprise one or more of a time stamp, a production site, a country of production, and a batch ID. This allows for efficient information access and retrieval, e.g. in a data base holding information of the transferred product containing the material, and may also allow for the participants of the transfer, but not necessarily any other parties, to access more information than is stored in the actual transaction, for example by using said product production data in combination with the product identifier as described previously in relation to the material identifier.

The product identifier may include a digital representation pointing to a data set, e.g., a product passport or product data set, or parts thereof. Said pointer, such as a hash pointer, may be used to retrieve details on the transferred product containing the material, such as its properties, compositions etc. as previously described.

The amount of product containing the material is used for the purposes of determining the transfer balance, e.g., performing mass balancing, as described later on. This information may be less sensitive than information related to the transferred product containing the material as well as the identity of the involved parties as previously described.

Apart from said material data and product data, said transactions may further contain at least one transaction ID, for example the transaction ID associated with said transaction and optionally a transaction ID of a previous transaction associated with a previous material transfer or product transfer transaction, the cryptographic credential(s) of the involved parties, or a combination thereof. Cryptographic credentials may comprise data establishing the identity of a party of a communication. Cryptographic credentials may take the form of machine-readable cryptographic keys, for example public keys and/or private keys and/or cryptographic signatures and/or passwords and/or passphrases. Cryptographic credentials may be self-issued, or issued by a trusted third party. A cryptographic credential may be configured so as to establish an unambiguous association of the cryptographic credential with a specific, real individual or other entity. Cryptographic credentials may optionally be configured to expire after a certain period of time, although this is not mandatory. An X.509 public key certificate is an example of a cryptographic credential. With particular preference, each transaction contains the public keys of the involved parties and is signed with the private key of the party generating the transaction and sending the transaction to a member node for commitment to the distributed ledger.

The term “product containing the material” is to be understood broadly herein and refers to product(s) produced using the material, i.e. said material is used in production of product(s) or is used in at least one production step of a sequence of production steps necessary to produce the product(s). Likewise, components (e.g. chemical material) resulting from reuse or recycling of said product(s) are also referred herein as “product containing the material”. Thus, the product containing said material may not necessarily contain the material in its original form (e.g. its original chemical composition or its original physical appearance), for example if the product is produced by reacting material(s) or if the product is produced by changing the appearance of the material.

If the inventive method is used to determine the overall transfer balance of a distributed system comprising multiple parties, the term “material” corresponds to the starting materials used in each first production step performed within said distributed system, while the term “material” corresponds to all purchased materials if the company-wide mass balance is to be determined according to the inventive method. Likewise, the term “material” corresponds to all starting materials used to prepare a specific product if a transfer balance is to be determined on a product-level according to the inventive method. If a transfer balance of a specific production process comprising several production steps is to be determined, the term “material” encompasses all starting materials, e.g. raw materials used within the production process. However, if a transfer balance of a specific production step within a production process comprising several production steps is to be determined, the term “material” encompasses the intermediate used as starting material to produce to product resulting from said production step for which the transfer balance is to be determined.

In the present disclosure, the at least one transfer associated with (a) material and product(s) containing said material may refer to transfer(s) of the material and product(s) containing said material between one or more first parties to one or more second parties, in particular from the one or more first parties to the one or more second parties. A transfer may refer to an already performed as well as a projected or planned transfer from one or more first parties to the one or more second parties. In one example, a transfer of may comprise a material or product(s) containing said material being transferred between exactly one first party and exactly one second party. The one or more first parties and the one or more second parties may each comprise at least one of a legal person, e.g. a company, a natural person, and a collective of legal and/or natural persons. The one or more first parties and one or more second parties are collectively referred to herein as parties involved with the transfer.

In case of virgin materials, the one or more first parties may be termed “material owner” and the one or more second parties receiving said virgin material (i.e. being involved in the transfer to said virgin material) may be termed “material recipient”. The material recipient may use the virgin materials to produce a first product and may transfer said first product to further parties. In this case, the further parties are termed “product recipient xᵢ”. If said first product produced by the material recipient needs to be further processed (e.g. if the first product is an intermediate product), the product recipients may use the received first product and may produce a second product containing said first product and said virgin material. Said second product may be transferred to further parties. Said further parties may be term “consumer” in case the second product is the final product or may be termed “product recipient Xᵢ₊₁” in case the second product needs to be processed further. Likewise, all further recipients of the product containing said material, such as consumers, parties performing recycling or reuse process step(s), etc., may be termed product recipient Xᵢ₊ₙ. If such a recipient performs the last step within the recycling or reuse process and said recycled or reused component resulting from said last step is transferred to another party as chemical material, then the other party may be termed “material recipient” as stated above. A material owner may be a party having ownership of a material, particularly physical control over a material and/or economic ownership of a material. The material owner being party to a transfer of material is also referred to in the present disclosure as material owner associated with the transfer of material or vice versa. A material recipient or product recipient may be a party receiving ownership of a material or a product containing the material, particularly physical control over a material a product containing the material and/or economic ownership of a material a product containing the material. The material recipient or product recipient being party to a transfer of material or a product containing the material is also referred to in the present disclosure as material recipient or product recipient associated with the transfer of material or vice versa.

A transfer may comprise a transfer of ownership from the material owner to the material recipient or from the material recipient to the product recipient xᵢ, and may include at least one of a transfer of physical control over the material or the product(s) containing the material, also referred to in short as physical transfer of the material or the product(s) containing the material, and an economic ownership of the material or the product(s) containing the material.

A material, in the present disclosure, is to be understood broadly as referring to one or more physical entities. In one embodiment, the material may be a discrete or indiscrete material, e.g., may be a continuous volume of solid or liquid material in case of an indiscrete material or comprise a plurality of pieces, e.g., parts or components, in case of discrete material.

In one embodiment, the material may a chemical raw material or a chemical material. A chemical raw material, in the present disclosure, may comprise a material that is used as an educt or starting material in a production process. It may be a virgin material or a reused material, e.g., a material having already gone through a production and use cycle. A virgin material, according to the present disclosure, may comprise newly extracted raw material, in particular, material that has not undergone a previous production-and-use cycle, in particular, has not been processed and/or used. A reused material, according to the present disclosure, may be a material that has already undergone a production-and-use cycle. For example, a reused material may be a material that has undergone, after use of the material, a treatment to prepare it for reuse. This may entail a processing step, e.g., recycling and/or other treatment steps, e.g., cleaning or the like. A recycled material is an example of a reused material. It may be a material having undergone, after use of the material, one or more processing steps. The processing steps may be such steps that enable the material to be introduced into a production step as a raw material.

A chemical material may be a chemically processed material, such as a raw material having undergone at least one chemical reaction, for example an intermediate material used in a further production step.

For the sake of clarity, depending on what transfer balance is to be determined, the term “material” may refer to an intermediate “product” used within the production process, for example if a transfer balance of a specific production step within several production steps resulting in final product X is to be determined. In this case, the term “product containing said material” refers to the product (e.g. a further intermediate product or the final product X) resulting from the use of said intermediate “product”. Thus, the term “material” and the term “product containing said material” are not equal to each other, even though the material may be regarded as the intermediate “product” of a previous production step.

### First Step

Within the first step of the inventive method, at least one data set is received, for example via a member node connected to a further decentral network such as a single decentral platform and allowing secure and efficient data exchange between all parties of a distributed system as mentioned previously. The term “data set” is to be understood broadly in the present case and may comprise data related to a property of the material or product and/or data related to the use of the material or product. Such a property may be a static or a dynamic property. A static property may be a property constant over time e.g. melting point, boiling point, density, hardness, flammability or the like. A dynamic property may be a property that changes over time e.g. shelf life, pH value, color, reactivity. A property may include performance properties, chemical properties, such as flammability, toxicity, acidity, reactivity, heat of combustion and/or physical properties such as density, color, hardness, melting and boiling points, electrical conductivity or the like. Data related to the use of the material or product may include data related to further processing of the material or product, for example by using the material as reactant in further chemical reaction(s) and/or data related to the use of the material or product, for example data related to the use of the material or product in a treatment process and/or within a manufacturing process. The data set may include chemicals data, emission data, recyclate content, bio-based content and/or production data.

Each received data set includes data of at least one material transfer transaction containing the material data and/or data of at least one product transfer transaction containing the product data associated with the product(s) containing the material. The term “including data of at least one material transfer transaction” and “including data of at least one product transfer transaction” is to be understood broadly in the present case and may encompass that said data is included directly in the data set or is included via a digital representation pointing to said data. Apart from the material data, said transaction(s) may comprise one or more of: the type of transaction, e.g., create or transfer transaction, one or more public keys, such as the public key of the first party and the second party/parties, a URI (in particular a URI generated from the private and public key of one of the two parties involved in the transaction) and a transaction ID. The transaction may be signed by one party of the transfer using its private key. A validation of the signature, for example by each member node upon performing the consensus algorithm, may then be performed, e.g., using URI content. The term “transaction” is to be understood as a digital representation, particularly a unique digital representation, of a transfer of material and product(s) containing said material from a first party to one or more second parties, particularly from exactly one first party to exactly one second party stored in the distributed ledger.

The distributed ledger, more specifically, the transactions stored therein, represent material and product flows in a distributed system like a production or supply chain, e.g., introducing of material into a distributed system or transfer of material and product(s) within the distributed system. The distributed ledger may allow for searching transactions, which in turn may enable lookup across multiple intermediate steps associated with the material or product assigned to the transaction that was retrieved. This ensures traceability of material and product flow and accountability of each party of the distributed system.

### Data Set

Each data set may comprise
a decentral identifier and
data related to the material or the data related to the product containing the material.

The term “decentral identifier” is to be understood broadly in the present case and comprises any unique identifier uniquely associated with the data owner and chemical product data. The decentral identifier may include a Universally Unique IDentifier (UUID) or a Digital IDentifier (DID). The decentral identifier may be issued by a central or decentral identity issuer. The decentral identifier may include authentication information. Via the decentral identifier and its unique association with the data owner and chemical product data access to the chemical product data may be controlled by the data owner. This contrasts with central authority schemes, where identifiers are provided by such central authority and access to data is controlled by such central authority. Decentral in this context refers to the usage of the identifier in implementation as controlled by the data owner.

Each data set may be generated by collecting data associated with the material or the product containing the material (such as material or product property data listed later on), wherein the material or product comprises a physical identifier. Said physical identifier is then assigned to the decentral identifier and the decentral identifier as well as the collected data is used to generate each data set. The decentral identifier may be provided by one central node or by one or more decentral nodes. The decentral identifier as generated by one central node or by one or more decentral nodes may be provided to a node generating the data set and to at least one authentication data registry node, preferably accessible by a data providing service and/or a data consuming service. This enables customized data sharing or exchange with respect to the material and product between the involved parties of the distributed system. In particular, the data providing service and/or the data consuming service may customize data sharing or exchange protocols based on the anchoring of the decentral identifier to data related to the material or the data related product.

The authentication data registry node may be a central registry node such as a central file system, a centrally managed distributed database, and/or a centrally managed peer-to-peer network. The central configuration allows for more control and standardization via a central node. The authentication data registry node may be a decentral registry such as a distributed ledger, a decentralized file system, a distributed database, and/or a peer-to-peer network. The decentral configuration allows for more efficient use of computing resources and strengthens control by the data owner. In addition, the decentral configuration is independent from centrally managed nodes and increases reliability and flexibility of the system.

In one embodiment, the generation of the data set includes providing the decentral identifier associated with a physical entity of a material or a product containing said material. In this context the physical entity may relate to a physical material or product that is associated with the decentral identifier. The term “physical entity” is to be understood broadly in the present case and relates to the physical embodiment of a material or product containing the material.

The physical entity may be any material or product in the chemical supply chain. The physical entity may be a raw material, a reused or recycled material, a chemical product, a chemical formulation, a chemical mixture, a component, a component assembly, an end product or a combination thereof.

The decentral identifier may be associated with the physical entity the material property data or product property data is associated with. The decentral identifier may be associated with the material the material property data is associated with or with the product the product property data is associated with. For instance, the decentral identifier may be associated with the physical entity of the basic substance, the raw material, the chemical material, the chemical mixture, the chemical formulation or the like. The decentral identifier may be associated with the physical entity the material or product will be supplied for and the material property data or product property data is associated with. For instance, the decentral identifier may be associated with the physical entity of the component, the component assembly, the end product or the like. The decentral identifier may be associated with more than one physical entity the material or product will be supplied for and the material property data or product property data is associated with. For instance, the decentral identifier may be associated with the physical entity of the component, the component assembly and the end product. Associating the decentral identifier with different physical entity stages in the chemical supply chain allows for virtually tracking the supplied material and product(s) containing said material in the supply chain. This way the material and product(s) containing said material with its associated data may be tracked e.g. up to the end of life of the end product.

In one embodiment, the decentral identifier is or is assigned to a physical identifier connected to the material or product. The connection of the physical identifier with the material or product may be provided by means of physical connection to the physical product or physical entity. For instance, the physical identifier may be connected with the physical entity of the material or product. The physical entity may be a material or a product containing the material. The physical identifier may have one-to-one correspondence to a virtual identity or to a physical identity by means of a physical connection to the physical entity. In an embodiment, the physical identifier is physically attached to the material or product via an identifier element.

The “physical identifier” or “physical identifier element” may refer to any virtual or physical arrangement that associates the decentral identifier with the material or product. The physical identifier may be any identifier for the material or product, such as a batch number or a part number. The physical identifier element may comprise a passive or active element, e.g. QR-code, RFID-tag, but is not limited thereto. The physical identifier element may be a physical identifier physically connected to the material or product. The identifier element may include markers embedded in materials, a bar code, a QR-Code, a tag like a RFID tag or similar physical arrangement that allows to digitally identify the chemical product.

In one embodiment, an identifier element containing the physical identifier is physically attached to the material or product. The physical identifier may be provided from a sensor reading a physical identifier element, wherein the physical identifier element is physically connected to the material or product. The identification element may be physically connected to the material or product, uniquely identifying said material or product. The identification element may be physically connected to any component of the material or product, e.g., the packaging of the material or product, uniquely identifying said material or product.

In one embodiment, each data set includes one or more authentication mechanisms associated with the decentral identifier and the data related to the material or the data related to the product containing the material. The authentication mechanism may include a token, such as private and public key infrastructure, a certificate mechanism or a biometric mechanism, such as fingerprints, face recognition or voice recognition or the like. One common public key certificate is for instance the X.509 certificate. Through the authentication mechanism data access by a data consuming service can be controlled in a secure manner and integrity of the data providing service can be ensured. This allows for more reliable, controlled and secure data exchange or sharing.

The one or more authentication mechanisms associated with the decentral identifier as generated by one central node or by one or more decentral nodes may be provided to a node generating each data set and to at least one decentral authentication data registry, preferably accessible by the data providing service and/or the data consuming service. The authentication data registry may be a central registry such as a central file system, a centrally managed distributed database, and/or a centrally managed peer-to-peer network. The central configuration allows for higher control and standardization via a central node. The authentication data registry may be a decentral registry such as a distributed ledger, a decentralized file system, a distributed database, and/or a peer-to-peer network. The decentral configuration allows for more efficient use of computing resources and strengthens control by the data owner.

In another embodiment, each data set is related to one or more authorization mechanisms associated with the decentral identifier and the data related to the material or the data related to the product containing the material. The authorization mechanisms may include authorization rule(s) including data transaction instructions or data transaction protocols, such as data usage policies, smart data contracts or more complex data processing instructions associated with data providing and/or data consuming services. Through the authorization mechanism data access and data usage by a data consuming service can be controlled in a secure manner.

The one or more authorization mechanisms associated with the decentral identifier as generated by one central node or by one or more decentral nodes may be provided to a node for generating or processing each data set or for accessing the data related to the material or the data related to the product containing the material. Additionally, or alternatively, the one or more authorization mechanisms may be provided to at least one central or decentral authorization data registry, preferably accessible by the data providing service and/or the data consuming service. In one embodiment, the one or more authorization mechanisms associated with the decentral identifier as generated by one or more decentral nodes may be provided to a node generating or processing each data set and to at least one a central file system, a centrally managed distributed database, a centrally managed peer-to-peer network, a distributed ledger, a decentralized file system, a distributed database, and/or a peer-to-peer network, preferably accessible by the data providing service and/or the data consuming service. In one example, the data related to the material includes one or more digital representation(s) pointing to material property data or parts thereof. The material property data may comprise the material name, the material ID, the material composition, chemical and/or physical properties of the material, emission data of the material, recyclate content of the material, bio-based content of the material, further material production data, material declaration data, chemical material safety data, certificate of analysis data associated with the material, transaction ID(s) of material transfer transactions associated with the material, or a combination thereof. The term “recyclate content data and/or bio-based content data” is to be understood broadly in the present case and comprises any data related to the recyclate content or the bio-based content used for providing or manufacturing a physical entity at any stage in the chemical supply chain such as a raw material or basic substance, chemical product or chemical material, component, component assembly or end product.

The term “emission data” is to be understood broadly in the present case and comprises any data related to environmental footprint. The environmental footprint may refer to an entity and its associated environmental footprint. The environmental footprint may be entity specific. For instance, the environmental footprint may relate to a product, a company, a process such as a manufacturing process, a raw material or basic substance, a chemical product or material, a component, a component assembly, an end product, combinations thereof or additional entity-specific relations. Emission data may include data relating to carbon footprint of a chemical product. Emission data may include data relating to greenhouse gas emissions e.g. released in production of the chemical product. Emission data may include data related to greenhouse gas emissions. Greenhouse gas emissions may include emissions such as carbon dioxide (CO₂) emission, methane (CH₄) emission, nitrous oxide (N₂O) emission, hydrofluorocarbons (HFCs) emission, perfluorocarbons (PFCs) emission, sulphurhexafluoride (SF₆) emission, nitrogen trifluoride (NF₃) emission, combinations thereof and additional emissions.

Emission data may include data related to greenhouse gas emissions of an entities or companies own operations (production, power plants and waste incineration). Scope 2 comprise emissions from energy production which is sourced externally. Scope 3 comprise all other emissions along the value chain. Specifically, this includes the greenhouse gas emissions of raw materials obtained from suppliers. Product Carbon Footprint (PCF) sum up greenhouse gas emissions and removals from the consecutive and interlinked process steps related to a particular product. Cradle-to-gate PCF sum up greenhouse gas emissions based on selected process steps: from the extraction of resources up to the factory gate where the product leaves the company. Such PCFs are called partial PCFs. In order to achieve such summation, each company providing any products must be able to provide the scope 1 and scope 2 contributions to the PCF for each of its products as accurately as possible, and obtain reliable and consistent data for the PCFs of purchased energy (scope 2) and their raw materials (scope 3).

In one example, the data related to the product containing the material includes one or more digital representation(s) pointing to product property data or parts thereof. The product property data may comprise the product name, the product ID, the material composition of the product, chemical and/or physical properties of the product, emission data of the product, recyclate content of the product, bio-based content of the product, further product production data, material declaration data, chemical material safety data, certificate of analysis data associated with the product, transaction ID(s) of material transfer transactions associated with the material and/or transaction ID(s) of product transfer transactions associated with product(s) containing the material, or a combination thereof.

In one embodiment, each data set is received from a data providing service. Specifically, the data providing service may ensure that each data set has the proper configuration and content, and may, in particular, reliably ensure storage and/or secure access to the data set(s). The term “data providing service” is to be understood broadly in the present case and comprises computer-executable instructions for providing and/or processing data, such as material property data, associated with the data owner for accessing and/or processing by a data consuming service. The data set(s) may be received using the digital representation(s) pointing to said data set(s). Said digital representation(s) may be received from the data owner and may be used to retrieve the respective material or product property data from the data providing service using a data consuming service. The term “data consuming service” is to be understood broadly in the present case and comprises computer-executable instructions for accessing and/or processing data, such as data set(s), associated with the data owner.

In one embodiment, the material and the at least one product containing the material are either transferred in a linear process or in a circular process. Both the linear as well as the circular process may comprise a production step in which the product(s) containing the material are produced from at least one raw material or at least one chemical material. The production step may comprise one or more sub steps, the number of sub steps necessary to produce the product containing the materials being dependent on the raw materials and/or chemical materials as well as the specific product(s) containing said materials. Both the linear as well as the circular process may further comprise a use step, i.e. the use of the product(s) containing the material and being produced in the production step by the end consumers.

The linear process preferably only comprises the production step, the use step, and a disposal step. In particular, it does involve a reuse of the product(s) containing the material, particularly, may not involve any recycling and/or other treatment steps that prepare the product(s) containing the material for reuse. In other words, raw material used within the processing step of the linear process does not include chemical material produced from products containing the material, e.g., recycled or otherwise reintroduced chemical material.

The circular process, according to the present disclosure, is a process that comprises, in addition to the production step and the use step, a reuse step. Accordingly, it also comprises treating the product(s) containing the material for reuse. It may optionally comprise a disposal step for components/parts of the product(s) containing the material which cannot be reused and need to be disposed. Moreover, different cycles of the circular process may comprise different subsets of the above steps.

In the course of the circular process, material or product(s) containing the material may be split up and/or merged with other material and/or product(s) containing the material. The merging with other material and/or product(s) containing the material may be seen as processing the material and as processing the involved material(s) and/or product(s) containing the material.

The circular process, may, in particular, be implemented as a closed material loop. A closed material loop, according to the present disclosure, may be a circular process, more specifically, a circular material flow, raw material in the form of virgin material is only fed into the circular process to replace unusable material, e.g., disposed material, and diffusive or accidental material losses to the environment, like attrition, abrasion, or irretrievable loss. Otherwise, no virgin materials are being fed/introduced into the closed material loop. The stream of virgin material fed into the circular process to replace disposed material and/or diffusive or accidental material losses may be referred to as a make-up stream of virgin material.

### Data of the at Least One Material Transfer Transaction

In one embodiment of the present invention, data of the at least one material transfer transaction includes the transaction ID of the at least one material transfer transaction containing the material data, the credential(s) associated with the material transfer transaction, or a combination thereof. Credential(s) associated with the material transfer transaction(s) may include the public key(s) of the parties involved in the transaction as well as the signature of the party generating the transaction and sending the transaction to a member node for commitment to the distributed ledger.

The transaction ID is preferably generated upon generating the material transfer transaction, upon sending the generated transaction to the member node for commitment to the distributed ledger, or upon validating the material transfer transaction prior to commitment to the distributed ledger. Committing a transaction to the distributed ledger may entail validating the signature of the transaction and further predefined crypto-conditions, such as whether the input amount listed in the transaction has already been consumed by another transaction, whether the input amount equals the output amount, whether a transfer transaction contains addresses of all parties involved, etc. by a member node receiving said transaction. An error message may be sent from said member node to the sender or a party of the transaction (in case the sender is not equal to a party involved in the transaction) if the transaction received by the member node cannot be successfully validated by said node. This allows the aforementioned party to check the transaction data and to modify the transaction data prior to resending said transaction. After the transaction is validated, it may be stored in a database (e.g. the database layer of the distributed ledger). A member node participating in the consensus algorithm may generate a block from the stored list of validated transactions in said database and may propose said block as new block to be added to the distributed ledger. If the majority of member nodes participating in the consensus algorithm vote for said proposed block to be added, this block is appended as new block to the distributed ledger. The transaction meta data as well as the addresses of the involved parties may be retrieved from transactions contained in said newly appended block and may be stored in a separate database (e.g. the database layer of the distributed ledger).

Said separate database may be used to search for transactions based on the transaction meta data and/or addresses, thus allowing to quickly and efficiently search for transactions stored on the distributed ledger without having to search within the distributed ledger. After successful commitment of the transaction(s) to the distributed ledger, either the party involved in the transfer or the party generating the transaction may receive confirmation of commitment of the transaction to the distributed ledger from the member node receiving the transaction. Likewise, an error message may be sent from said member node to the aforementioned party if the received transaction was not committed to the distributed ledger. This allows to resend the transaction after receiving the error message.

### Data of the at Least One Product Transfer Transaction

In one embodiment of the present invention, data of the at least one product transfer transaction includes the transaction ID of the at least one product transfer transaction containing the product data, the credential(s) associated with the product transfer transaction, or a combination thereof. Credential(s) associated with the product transfer transaction(s) may include the public key(s) of the parties involved in the transaction as well as the signature of the party generating the transaction and sending the transaction to a member node for commitment to the distributed ledger.

### Second Step

Within the second step of the inventive method, the material data and the product data is each retrieved based on the received data set(s).

In one embodiment of the inventive method, retrieving material data based on the received data set(s) includes determining the identity of at least one material transfer transaction based on the data of the material transfer transaction(s) contained in the received data set(s) and retrieving the material data associated with the determined at least one identity of the material transfer transaction(s). For this purpose, the transaction IDs of the material transfer transaction(s) contained in the received data set(s) may be retrieved and the associated material transfer transaction(s) may be retrieved from the distributed ledger via a member node using the retrieved transaction IDs. Afterwards, the material data, in particular the amount of transferred material, may be determined from said retrieved material transfer transactions.

In one embodiment of the inventive method, retrieving material data based on the received data set(s) includes determining at least one material transfer transaction associated with the product(s) containing the material based on the data of the product transfer transaction(s) contained in the received data set(s) and retrieving the material data of the determined material transfer transaction(s). The material transfer transaction(s) may be determined, for example, by determining the identity of the product transfer transaction(s) associated with the material transfer transaction(s) contained in the received data set(s). For this purpose, the transaction IDs of the product transfer transactions contained in the received data set(s) may be retrieved and used to determine the identity/identities of the associated material transfer transactions.

The identity/identities can be determined because all transactions for a material and all transactions for product(s) containing said material are chained together via their transaction IDs. For example, the transaction ID associated with generation of the material within the distributed ledger (i.e. committing a transaction associated with material not already stored in the distributed ledger to the distributed ledger) is chained to the transaction transferring at least part of said material from the material owner to at least one material recipient. If the material recipient uses said material to produce a product containing said material, the transaction ID associated with a transaction indicating a transfer of said product to a product recipient is likewise chained to the transaction ID associated with the transfer of the material from the material owner to the material recipient. Chaining of transactions associated with the transfer of the material with transactions associated with each product containing said material allows to not only track the production stage of a product, the use stage of said product as well as the reuse stage of said product but moreover allows to determine the transfer balance associated with said transfers by using the chaining to determine all transactions and the respective amount contained in said transactions necessary to determine said transfer balance.

In one embodiment of the inventive method, retrieving product data based on the received data set(s) includes determining the identity of at least one product transfer transaction based on the data of the product transfer transaction(s) contained in the received data set(s) and retrieving the product data associated with the determined at least one identity of the product transfer transaction(s). The identity of the at least one product transfer transaction as well as retrieval of product data can be performed as described previously in relation to retrieving material data from material transfer transaction(s) based on the determined identities.

In one embodiment of the inventive method, retrieving product data based on the received data set(s) includes determining at least one product transfer transaction associated with the material based on the data of the material transfer transaction(s) contained in the received data set(s) and retrieving the product data of the determined product transfer transaction(s). The product transfer transactions can be determined by determining the identity/identities using the transaction IDs of the material transfer transaction(s) contained in the received data set(s) as previously described.

### Third Step

Within the third step of the inventive method, at least one transfer is tracked by determining a transfer balance associated with the material and the at least one product containing said material based on the material data and the product data retrieved in the second step.

In one embodiment of the present invention, determining the transfer balance includes
determining the total amount of material from the retrieved material data and determining the total amount of product(s) containing the material from the retrieved product data, and
comparing the determined total amount of material with the determined total amount of product(s).

Determining the total amount of material may include retrieving the amount of material contained in the material data of each retrieved material transfer transaction and adding the retrieved amounts of material. Likewise, the total amount of product may be determined by retrieving the amount of product contained in the product data of each retrieved product transfer transaction and adding the retrieved amounts of product(s). As the amount of material and product is not anonymized, for example by adding a random number to said amount such that the real amount cannot be directly derived from the transaction data stored in the distributed ledger, the addition of the retrieved amounts can be done without any further decryption methods. This allows to monitor certain mass flows by the public or authorities without providing them with any special decryption algorithm to determine the transfer balance.

For example, the overall mass balance of a circular system can be monitored by the public and/or by auditors by balancing the amount listed in all transactions associated with generation of material in the distributed ledger (i.e. transactions associated with storing virgin material for the first time in the distributed ledger) with the amount of product(s) listed in all transactions associated with transferring unrecycled product(s) to an address associated with a landfill or dump. If the circular system is a closed material loop, the amount listed in all transactions associated with generation of material in the distributed ledger should be equal to the amount listed in all transactions associated with transferring unrecycled product(s) to an address associated with a landfill or dump. The material/product classification may be used to determine the mass balance for a certain type of material/product, for example for all materials/products with the classification “polymer”. However, as the identity of the parties as well as details on the material are anonymized, the involved parties as well as the involved material cannot be readily identified from the data available on the distributed ledger. This allows to provide a transparent transfer balancing without unduly disclosing the parties and materials/products involved in said transfers, thus ensuring sufficient data protection and avoiding negative influences on the competitiveness of each party within the distributed system.

In another example, the mass balance of one company can be determined, for example by auditors, using all transactions associated with said company, for example by receiving data set(s) of said company listing all transaction IDs and using the listed transaction IDs to retrieve the amounts of material and product(s) containing said material.

In one example, determining the total amount of material may further include retrieving the stoichiometry associated with the material based on the received data set(s) and determining the total amount of material based on the retrieved stoichiometry. This may be preferred if the transfer balance is to be determined for a specific production stage within the production step of a certain product or a certain distributed system, because this requires knowledge of the stoichiometry to determine the correct transfer balance. The data set may be used to retrieve the product property data using the digital representation pointing to the product property data including data on the stoichiometry. Use of the stoichiometry allows to determine, for example, the amount of product(s) produced from sustainable materials if said product(s) are transferred to a specific “address” (i.e. using a specific public key for the recipient “address”) associated with a certain company. The validity of said sustainability claims can be easily verified by determining the mass balance using the stoichiometry as well as the amounts of material and product(s) transferred to said specific address.

In one example, determining the total amount of product(s) containing the material includes retrieving the stoichiometry associated with the product based on the received data set(s) and determining the total amount of product(s) containing the material based on the retrieved stoichiometry. This may be preferred if the transfer balance is to be determined for a specific production stage within the production step of a certain product or a certain distributed system, because this requires knowledge of the stoichiometry to determine the correct transfer balance. The product identifier may be used to retrieve the product data set as previously described In one embodiment of the present invention, the transfer balance is a material mass balance. The term “material mass balance” may, depending on the material and product transfer transactions used to determine said material mass balance, either refer to the overall mass balance of the distributed system, the mass balance of one company being part of the distributed system or the mass balance of a specific product.

Further embodiments or aspects are set forth in the following numbered clauses:
1. A computer-implemented method for tracking at least one transfer associated with a material and at least one product containing said material in a decentral network comprising a distributed ledger that includes multiple member nodes, the distributed ledger including material transfer transactions containing material data associated with the material and product transfer transactions containing product data associated with the at least one product containing the material, the method including the steps of:
   receiving at least one data set, each data set including data of at least one material transfer transaction containing the material data and/or data of at least one product transfer transaction containing the product data associated with the product(s) containing the material,
   retrieving the material data and the product data based on the received data set(s),
   tracking at least one transfer by determining a transfer balance associated with the material and the at least one product based on the received or retrieved material data and the received or retrieved product data, and
   providing the at least one tracked transfer.
2. The method of embodiment 1, wherein the material is a discrete or indiscrete material.
3. The method of embodiment 1 or 2, wherein the material is a chemical raw material or chemical material.
4. The method according to any one of the preceding embodiments, wherein the material transfer transaction(s) and the product transfer transaction(s) each further include data being indicative of at least one transaction identity, the public keys of the parties associated with the transfer of the material and the at least one product, data being indicative of the transaction type, or a combination thereof.
5. The method according to any one of the preceding embodiments, wherein the material data includes material transaction meta data and the amount of the material.
6. The method according to embodiment 5, wherein material transaction meta data includes a material identifier, at least one material classification, material production data or a combination thereof.
7. The method according to embodiment 6, wherein the material identifier includes a digital representation pointing to a data set or parts thereof.
8. The method according to any one of the preceding embodiments, wherein the product data includes product transaction meta data and the amount of the product containing the material.
9. The method according to embodiment 8, wherein product transaction meta data includes a product identifier, at least one product classification, product production data or a combination thereof.
10. The method according to embodiment 9, wherein the product identifier includes a digital representation pointing to a data set or parts thereof.
11. The method according to any one of the preceding embodiments, wherein each data set includes a decentral identifier, and data related to the material or data related to the product containing the material.
12. A method according to embodiment 11, wherein each data set further includes one or more authentication mechanisms associated with the decentral identifier.
13. The method according to embodiment 11, wherein each data set is related to one or more authorization mechanisms associated with the decentral identifier.
14. The method according to any one of embodiments 11 to 13, wherein data related to the material includes one or more digital representation(s) pointing to material property data or parts thereof.
15. The method according to embodiment 14, wherein the material property data comprises the material name, the material ID, the material composition, chemical and/or physical properties of the material, emission data of the material, recyclate content of the material, bio-based content of the material, further material production data, material declaration data, chemical material safety data, certificate of analysis data associated with the material, or a combination thereof.
16. The method according to any one of embodiments 11 to 15, wherein data related to the product includes one or more digital representation(s) pointing to product property data or parts thereof.
17. The method according to embodiment 16, wherein the product property data comprises the product name, the product ID, the material composition of the product, chemical and/or physical properties of the product, emission data of the product, recyclate content of the product, bio-based content of the product, further product production data, material declaration data, chemical material safety data, certificate of analysis data associated with the material, or a combination thereof.
18. The method according to any one of the preceding embodiments, wherein each data set is received from a data providing service.
19. The method according to any one of the preceding embodiments, wherein the material and the at least one product containing the material are transferred in a linear production process or in a circular process.
20. The method according to any one of the preceding embodiments, wherein data of the at least one material transfer transaction includes the transaction ID of the at least one material transfer transaction containing the material data, the credential(s) associated with the material transfer transaction, or a combination thereof.
21. The method according to any one of the preceding embodiments, wherein data of the at least one product transfer transaction includes the transaction ID of the at least one product transfer transaction containing the product data, the credential(s) associated with the product transfer transaction, or a combination thereof.
22. A method according to any one of the preceding embodiments, wherein retrieving material data based on the received data set(s) includes determining the identity of at least one material transfer transaction based on the data of the material transfer transaction(s) contained in the received data set(s) and retrieving the material data associated with the determined at least one identity of the material transfer transaction(s).
23. The method according to any one of the preceding embodiments, wherein retrieving material data based on the received data set(s) includes determining at least one material transfer transaction associated with the product(s) containing the material based on the data of the product transfer transaction(s) contained in the received data set(s) and retrieving the material data associated with the determined material transfer transaction(s).
24. A method according to any one of the preceding embodiments, wherein retrieving product data based on the received data set(s) includes determining the identity of at least one product transfer transaction based on the data of the product transfer transaction(s) contained in the received data set(s) and retrieving the product data associated with the determined at least one identity of the product transfer transaction(s).
25. The method according to any one of the preceding embodiments, wherein retrieving product data based on the received data set(s) includes determining at least one product transfer transaction associated with the material based on the data of the material transfer transaction(s) contained in the received data set(s) and retrieving the product data of the determined product transfer transaction(s).
26. A method according to any one of the preceding embodiments, wherein determining the transfer balance includes
   determining the total amount of material from the retrieved material data and determining the total amount of product(s) containing the material from the retrieved product data, and
   comparing the determined total amount of material with the determined total amount of product(s).
27. The method according to embodiment 26, wherein determining the total amount of material includes retrieving the amount of material contained the material data of each determined material transfer transaction and adding the retrieved amounts of material.
28. The method according to embodiment 27, wherein determining the total amount of material further includes retrieving the stoichiometry associated with the material based on the received data set(s) and determining the total amount of material based on the retrieved stoichiometry.
29. The method according to any one of embodiments 26 to 28, wherein determining the total amount of product(s) containing the material includes retrieving the amount of product(s) contained the product data of each received product transfer transaction and adding the retrieved amounts of product(s).
30. The method according to embodiment 29, wherein determining the total amount of product(s) containing the material further includes retrieving the stoichiometry associated with the product based on the received data set(s) and determining the total amount of product(s) containing the material based on the retrieved stoichiometry.
31. The method according to any one of the preceding embodiments, wherein the material transfer balance is a material mass balance.
32. An apparatus for tracking at least one transfer associated with a material and at least one product containing said material in a decentral material network comprising a distributed ledger that includes multiple member nodes, the distributed ledger including transfer transactions containing material data associated with the material and transfer transactions containing product data associated with the at least one product containing the material, the apparatus comprising: one or more computing nodes; and one or more computer-readable media having thereon computer-executable instructions that are structured such that, when executed by the one or more computing nodes, cause the apparatus to perform the method as claimed in any one of embodiments 1 to 31.
33. Use of the material transfer balance as generated according to the method of any one of embodiments 1 to 31 or by the apparatus of embodiment 32 to validate material transfers associated with a material and product(s) containing the material.
34. A computer element with instructions, which when executed on one or more computing node(s) is configured to carry out the steps of the method of any of embodiments 1 to 31 or configured to be carried out by the apparatus of embodiment 32.

### BRIEF DESCRIPTION OF THE DRAWINGS

In the following, the present disclosure is further described with reference to the enclosed figures:

FIGS. 1A-1C illustrate example embodiments of a centralized computing environment (FIG. 1A), a decentralized computing environment (FIG. 1B) and a distributed computing environment (FIG. 1C).

FIG. 2 shows an example of a decentralized system comprising a distributed ledger used within the methods and systems according to the present disclosure.

FIG. 3 shows a sequence diagram for committing a transaction to the distributed ledger via a member node of FIG. 2.

FIG. 4 shows an example of a chemical product passport including DID owner data, DID document data and decentral identity infrastructure.

FIG. 5 shows an example of a chemical product passport including ID-based data, passport data and decentral identity infrastructure.

FIGS. 6A,6B show examples of authentication protocols.

FIGS. 7A-7C show different example configurations for product passports anchored by digital identifiers.

FIG. 8 is a flow chart illustrating an example embodiment of the method according to the present disclosure.

FIG. 9A is a flow chart illustrating an example embodiment of block 804 of FIG. 8.

FIG. 9B is a flow chart illustrating an example embodiment of block 806 of FIG. 8.

FIG. 10A is a block diagram illustrating the transfer of materials and a product containing the materials to several parties of a distributed system.

FIG. 10B is a block diagram illustrating the transactions associated with the transfers of

FIG. 10A which are committed by several member nodes to the distributed ledger.

FIG. 10C is a block diagram illustrating generating a data set for a product containing a material, said data set containing environmental data and the transaction ID of the associated product transfer transaction committed to the distributed ledger.

FIG. 10D is a block diagram illustrating receiving data set(s) from a data consuming service and using the data contained in said set(s) to retrieve the material data and product data stored within transactions committed to the distributed ledger.

FIG. 11 is a block diagram illustrating determination of the transfer balance of a linear distributed system comprising several parties involved in supplying raw materials and producing product(s) containing said raw materials.

FIG. 12A is a block diagram illustrating determination of the transfer balance of product within a circular distributed system comprising several parties involved in supplying raw materials and producing product(s) containing said raw materials.

FIG. 12B is a block diagram illustrating determination of the transfer balance of a circular system comprising several parties involved in supplying raw materials and virgin materials, producing product(s) containing said raw materials/virgin materials and recycling at least part of the produced products.

FIG. 13A is a block diagram illustrating determination of the transfer balance of a single company of a distributed system.

FIG. 13B illustrates an embodiment of a system used to determine the transfer balance and to generate data set(s) of FIG. 13A.

FIG. 14 is a block diagram illustrating determination of the transfer balance for a specific product produced from different raw materials using a defined stoichiometry.

FIG. 15 shows an example of a distributed ledger.

FIGS. 16A, 16B illustrate an example embodiment of the present disclosure.

FIG. 17 is a flow chart illustrating an example embodiment of the method according to the present disclosure.

FIG. 18A-18E illustrate potential applications of the method of the present disclosure.

FIG. 19 illustrates an example of a production facility producing a chemical product associated with a material data set.

FIG. 20 illustrates another example of a production facility producing a chemical product associated with a material data set.

FIG. 21 illustrates an example of a production system producing a chemical product associated with one or more material data set(s).

FIG. 22 is a flow chart illustrating an example embodiment of the method according to the present disclosure.

FIG. 23A is a flow chart illustrating an example embodiment of block 2402 of FIG. 22.

FIG. 23B is a flow chart illustrating an example embodiment of block 2404 of FIG. 22.

FIGS. 23C,23 Dare flow charts illustrating an example embodiment of block 2406 of FIG. 22.

### DETAILED DESCRIPTION OF EMBODIMENTS

The following embodiments are mere examples for implementing the method, the system or application device disclosed herein and shall not be considered limiting.

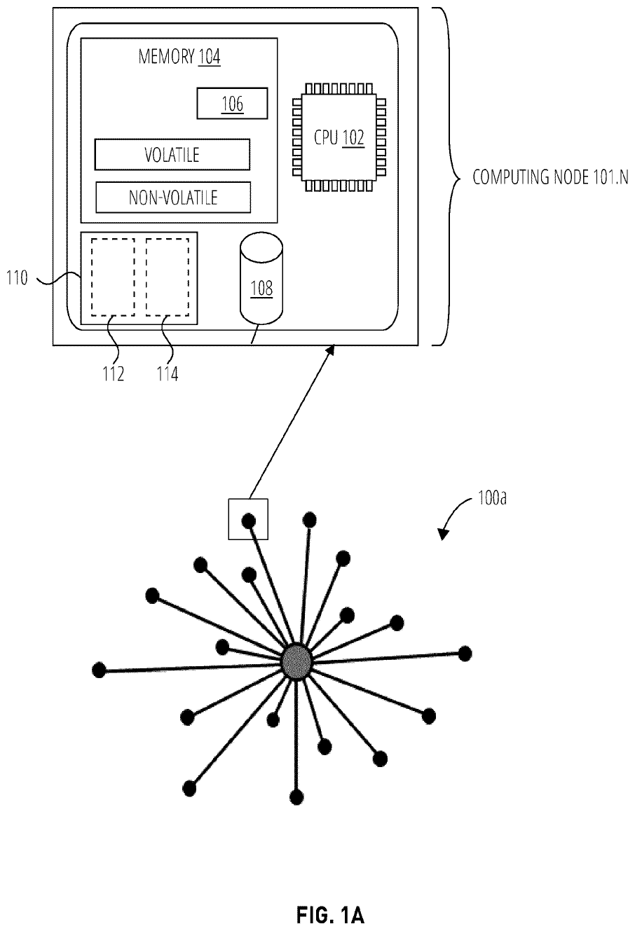

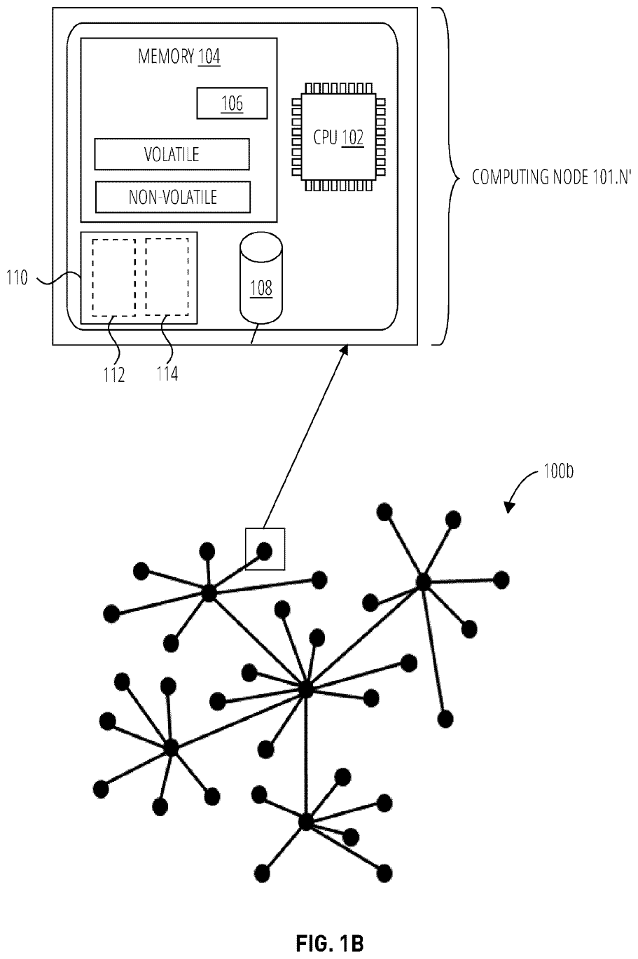

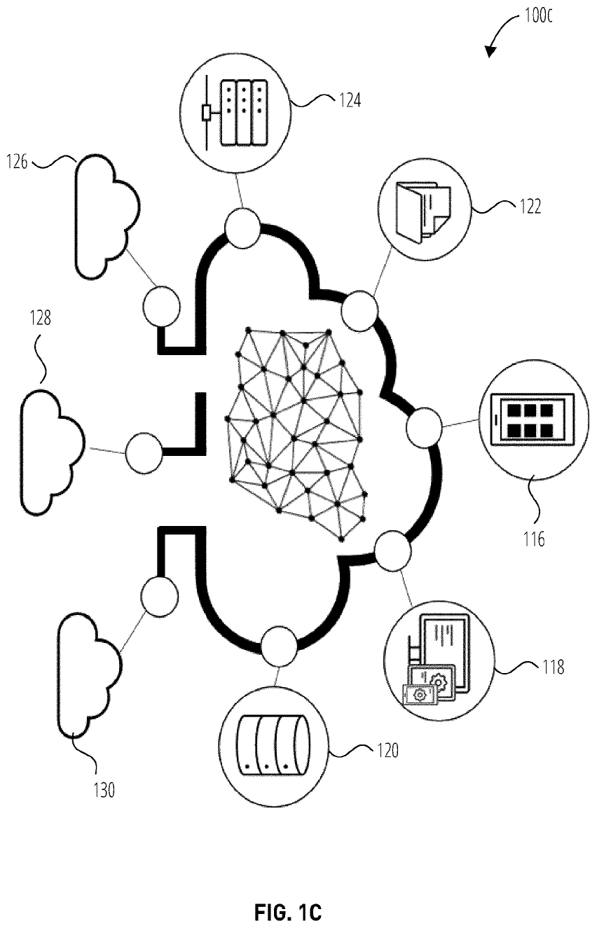

In order to provide context for the method and apparatus according to the present disclosure, different computing environments, central, decentral and distributed, are illustrated in FIGS. 1A to 1C and described herein below.

The methods, apparatuses, computer elements of this disclosure are implemented in decentral or at least partially decentral computing environments, specifically, a decentral network, which may reflect the decentral nature of material transfers between multiple independent parties.

FIG. 1A illustrates an example embodiment of a centralized computing system 100a comprising a central computing node (filled circle in the middle) and several peripheral computing nodes 101.1 to 101.N (denoted as filled circles in the periphery).

The term “computing system” is defined herein broadly as including one or more computing nodes, a system of nodes or combinations thereof. The term “computing node” is defined herein broadly and may refer to any device or system that includes at least one physical and tangible processor, and a physical and tangible memory capable of having thereon computer-executable instructions that are executed by a processor. Computing nodes are now increasingly taking a wide variety of forms. Computing nodes may, for example, be handheld devices, production facilities, sensors, monitoring systems, control systems, appliances, laptop computers, desktop computers, mainframes, data centers, or even devices that have not conventionally been considered a computing node, such as wearables (e.g., glasses, watches or the like). The memory may take any form and depends on the nature and form of the computing node.

In this example, the peripheral computing nodes 101.1 to 101.N may be connected to one central computing system (or server). In another example, the peripheral computing nodes 101.1 to 101.N may be attached to the central computing node via e.g. a terminal server (not shown). The majority of functions may be carried out by, or obtained from the central computing node (also called remote centralized location). One peripheral computing node 101.N has been expanded to provide an overview of the components present in the peripheral computing nodes 101.1 to 101.N. The central computing node may comprise the same components as described in relation to the peripheral computing node 101.N.

Each computing node of the centralized computing system 100a may include at least one hardware processor 102 and memory 104. The term “processor” may refer to an arbitrary logic circuitry configured to perform basic operations of a computer or system, and/or, generally, to a device which is configured for performing calculations or logic operations. In particular, the processor, or computer processor may be configured for processing basic instructions that drive the computer or system. It may be a semiconductor-based processor, a quantum processor, or any other type of processor configures for processing instructions. As an example, the processor may comprise at least one arithmetic logic unit (“ALU”), at least one floating-point unit (“FPU)”, such as a math coprocessor or a numeric coprocessor, a plurality of registers, specifically registers configured for supplying operands to the ALU and storing results of operations, and a memory, such as an L1 and L2 cache memory. In particular, the processor may be a multicore processor. Specifically, the processor may be or may comprise a Central Processing Unit (“CPU”). The processor may be a (“GPU”) graphics processing unit, (“TPU”) tensor processing unit, (“CISC”) Complex Instruction Set Computing microprocessor, Reduced Instruction Set Computing (“RISC”) microprocessor, Very Long Instruction Word (“VLIW”) microprocessor, or a processor implementing other instruction sets or processors implementing a combination of instruction sets. The processing means may also be one or more special-purpose processing devices such as an Application-Specific Integrated Circuit (“ASIC”), a Field Programmable Gate Array (“FPGA”), a Complex Programmable Logic Device (“CPLD”), a Digital Signal Processor (“DSP”), a network processor, or the like. The methods, systems and devices described herein may be implemented as software in a DSP, in a micro-controller, or in any other side-processor or as hardware circuit within an ASIC, CPLD, or FPGA. It is to be understood that the term processor may also refer to one or more processing devices, such as a distributed system of processing devices located across multiple computer systems (e.g., cloud computing), and is not limited to a single device unless otherwise specified.

The memory 104 may refer to a physical system memory, which may be volatile, non-volatile, or a combination thereof. The memory may include non-volatile mass storage such as physical storage media. The memory may be a computer-readable storage media such as RAM, ROM, EEPROM, CD-ROM, or other optical disk storage, magnetic disk storage, or other magnetic storage devices, or any other physical and tangible storage medium which can be used to store desired program code means in the form of computer-executable instructions or data structures and which can be accessed by the computing system. Moreover, the memory may be a computer-readable media that carries computer-executable instructions (also called transmission media). Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that storage media can be included in computing components that also (or even primarily) utilize transmission media.

The computing nodes may include multiple structures 106 often referred to as an “executable component or computer-executable instructions”. For instance, memory 104 of the computing nodes may be illustrated as including executable component 106. The term “executable component” may be the name for a structure that is well understood to one of ordinary skill in the art in the field of computing as being a structure that can be software, hardware, or a combination thereof or which can be implemented in software, hardware, or a combination. For instance, when implemented in software, one of ordinary skill in the art would understand that the structure of an executable component includes software objects, routines, methods, and so forth, that is executed on the computing nodes, whether such an executable component exists in the heap of a computing node, or whether the executable component exists on computer-readable storage media. In such a case, one of ordinary skill in the art will recognize that the structure of the executable component exists on a computer-readable medium such that, when interpreted by one or more processors of a computing node (e.g., by a processor thread), the computing node is caused to perform a function. Such a structure may be computer-readable directly by the processors (as is the case if the executable component were binary).

Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”. Examples of executable components implemented in hardware include hardcoded or hard-wired logic gates, that are implemented exclusively or near-exclusively in hardware, such as within a field-programmable gate array (FPGA), an application-specific integrated circuit (ASIC), or any other specialized circuit. In this description, the terms “component”, “agent”, “manager”, “service”, “engine”, “module”, “virtual machine” or the like are used synonymous with the term “executable component.

The processor 102 of each computing node directs the operation of each computing node in response to having executed computer-executable instructions that constitute an executable component. For example, such computer-executable instructions may be embodied on one or more computer-readable media that form a computer program product. The computer-executable instructions may be stored in the memory 104 of each computing node. Computer-executable instructions comprise, for example, instructions and data which, when executed at a processor 102, cause a general purpose computing node, special purpose computing node, or special purpose processing device to perform a certain function or group of functions. Alternatively or in addition, the computer-executable instructions may configure the computing node to perform a certain function or group of functions. The computer executable instructions may be, for example, binaries or even instructions that undergo some translation (such as compilation) before direct execution by the processors, such as intermediate format instructions such as assembly language, or even source code.

Each computing node may contain communication channels 108 that allow each computing node to communicate with the central computing node, for example, a network (depicted as solid line between peripheral computing nodes and the central computing node in FIG. 1a). A “network” may be defined as one or more data links that enable the transport of electronic data between computing nodes and/or modules and/or other electronic devices. When information is transferred or provided over a network or another communications connection (either hardwired, wireless, or a combination of hardwired or wireless) to a computing node, the computing node properly views the connection as a transmission medium. Transmission media can include a network and/or data links which can be used to carry desired program code means in the form of computer-executable instructions or data structures and which can be accessed by a general-purpose or special-purpose computing nodes. Combinations of the above may also be included within the scope of computer-readable media.

The computing node(s) may further comprise a user interface system 110 for use in interfacing with a user. The user interface system 110 may include output mechanisms 110A as well as input mechanisms 110B. The principles described herein are not limited to the precise output mechanisms 110A or input mechanisms 110B as such will depend on the nature of the device. However, output mechanisms 110A might include, for instance, displays, speakers, displays, tactile output, holograms and so forth. Examples of input mechanisms 110B might include, for instance, microphones, touchscreens, holograms, cameras, keyboards, mouse or other pointer input, sensors of any type, and so forth.

FIG. 1B illustrates an example embodiment of a decentralized computing environment 100b with several computing nodes 101.1′ to 101.N′ denoted as filled circles. In contrast to the centralized computing environment 100a illustrated in FIG. 1A, the computing nodes 101.1′ to 101.N′ of the decentralized computing environment are not connected to a central computing node and are thus not under control of a central computing node. Instead, resources, both hardware and software, may be allocated to each individual computing node 101.1′ . . . 101.N′ (local or remote computing system) and data may be distributed among various computing nodes 101.1′ . . . 101.N′ to perform the tasks. Thus, in a decentral system environment, program modules may be located in both local and remote memory storage devices. One computing node 101.N′ has been expanded to provide an overview of the components present in each computing node of the decentralized computing environment 100b. In this example, the computing node 101.N′ comprises the same components as described in relation to FIG. 1A. FIG. 1C illustrates an example embodiment of a distributed computing environment 100c. In this description, “distributed computing” may refer to any computing that utilizes multiple computing resources. Such use may be realized through virtualization of physical computing resources. One example of distributed computing is cloud computing. “Cloud computing” may refer a model for enabling on-demand network access to a shared pool of configurable computing resources (e.g., networks, servers, storage, applications, and services). When distributed, cloud computing environments may be distributed internationally within an organization and/or across multiple organizations. In this example, the distributed cloud computing environment 100c may contain the following computing resources: mobile device(s) 116, applications 118, databases 120, data storage 122 and server(s) 124. The cloud computing environment 100c may be deployed as public cloud 126, private cloud 128 or hybrid cloud 130. A private cloud 128 may be owned by an organization and only the members of the organization with proper access can use the private cloud 128, rendering the data in the private cloud at least confidential. In contrast, data stored in a public cloud 126 may be open to anyone over the internet. The hybrid cloud 130 may be a combination of both private and public clouds 126, 128 and may allow to keep some of the data confidential while other data may be publicly available.

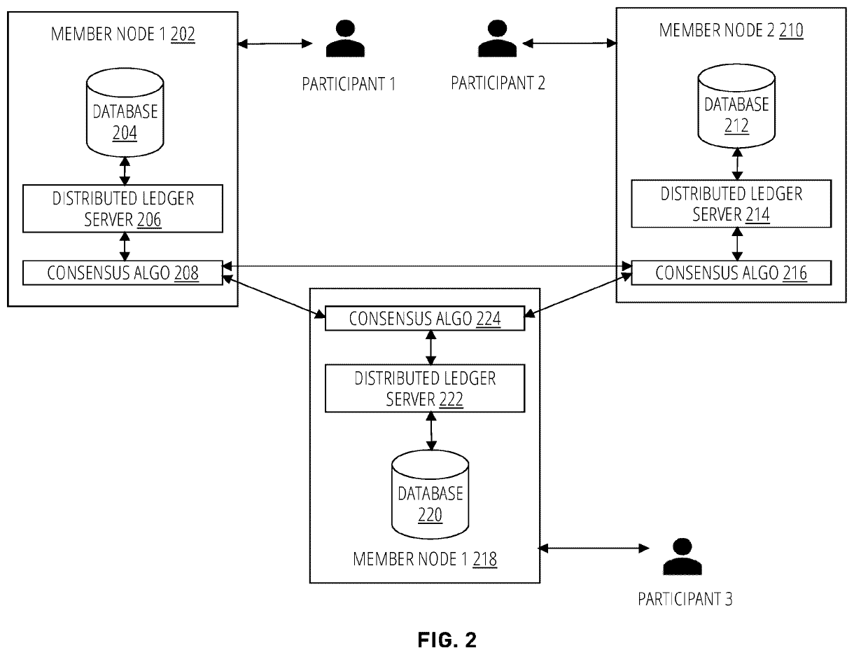

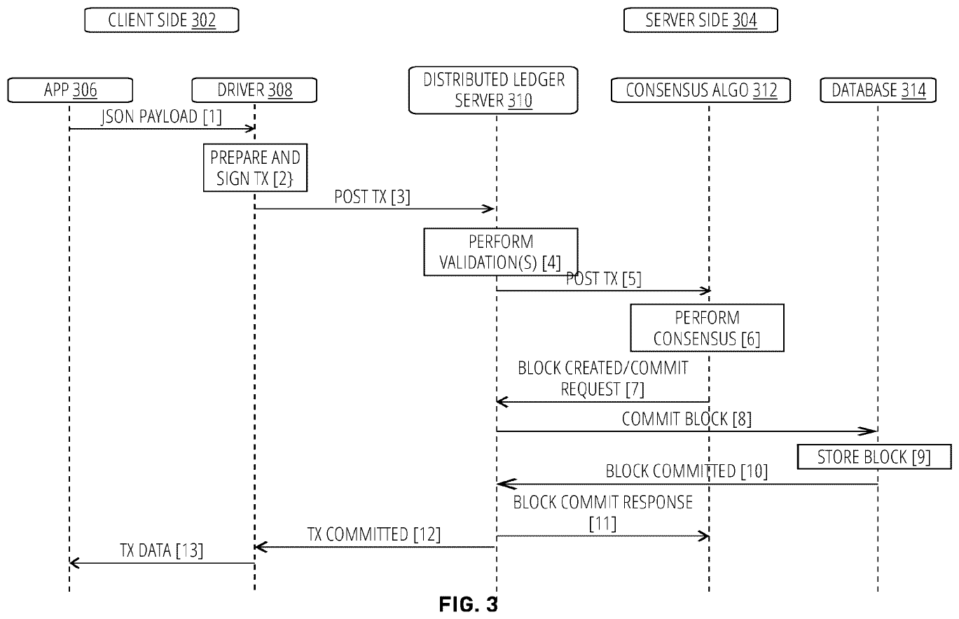

As explained in detail above, the method and apparatus of the present disclosure may make use of a decentral network comprising a distributed ledger. An exemplary decentralized network comprising a distributed ledger with member nodes is shown in FIG. 2. In this example, the distributed ledger comprises three member nodes. In another example, the distributed ledger may comprise more or less member nodes.

A distributed ledger is a shared, replicated, and synchronized database among member node 1 202, member node 2 210 and member node 3 214 of the decentralized network 200, such as a P2P network. In general, a distributed ledger may record transactions between participants, such as participants 1 to 3 associated with member nodes 1 to 3, of the distributed system and may, thus, provide an immutable history of transactions. Updates of the distributed ledger are performed based on a consensus algorithm 208, 216, 224 running on at least part of the member nodes. When an update occurs, i.e. a new block with transaction(s) is appended to the distributed ledger, all member nodes update themselves with the proper updated copy of the ledger. Blockchain applications are a specific example of a distributed ledger application. The nature of the distributed ledger is that there is no centralized authority, e.g., a clearing house.

A distributed ledger, more specifically, the transactions thereof, may represent material flows in a distributed network like a supply chain, e.g., introducing material into a material network or transfer of product(s) containing said material within the distributed network. The data stored in the distributed ledger allows to determine the transfer balance, in particular the mass balance, associated with transfer(s) of a material and product(s) containing said material.

In FIG. 2, as a specific example, each member node 1 to 3 (202, 210, 218) is shown as having a database layer (i.e. database 204, 212, 220), also referred to as Database API, a distributed ledger control layer, which includes the distributed consensus algorithm 208, 216, 224 and serves as a distributed ledger anchoring, e.g., blockchain anchoring. In this example, the consensus algorithm is a byzantine fault tolerant proof of stake consensus algorithm. In another example, the consensus algorithm is a proof of work consensus algorithm. The consensus algorithm of each member node is connected to the consensus algorithms of other member nodes to allow reaching a consensus on whether to append a new block to the distributed ledger or not. Each consensus algorithm 208, 216, 224 is connected to the respective distributed ledger server layer 206, 214, 222 to allow exchange of information between the algorithm and the server, for example on whether a consensus was reached on a proposed new block or not. The database layer stores the new block and information on the transaction(s) contained in said block, after a consensus was reached on appending the new block to the distributed ledger.

Providing separate layers may be advantageous, as database functions are geared at high throughput, e.g., for data loading and retrieval, access and querying, whereas distributed ledger functions usually provide lower throughput, yet ensure data immutability, tamper resistance, evidence, decentralized consensus over state, and replication of state across diverse nodes. However, a separation into separate layers is optional.

A distributed ledger as illustrated in FIG. 2, may be configured such that the database access and query commands on each member node are implemented as part of the database layer and only few essential database commands may be implemented by the control layer.

As an example, when it comes to material flow being represented by the distributed ledger, the control layer may implement a transaction to generate material for the first time in the distributed ledger, i.e. to feed or introduce material into the distributed system (also referred to as CREATE transaction hereinafter) and a transaction associated with the transfer of material or product(s) containing the material (also referred to as TRANSFER transaction hereinafter).

The CREATE transaction may, for example, generate an asset object for a certain amount of a certain material in the distributed ledger and the TRANSFER transaction may, for example, implement “append-only” write operations to the distributed ledger that have to reference one or more input transactions (CREATE or TRANSFER transaction(s)), one or more outputs (destination addresses) and the transferred amount. Referencing the input allows to perform mass balancing within a transaction because the input amount can be compared to the output amount and allows to implement rules that the input amount must equal the output amount.

Performing automatic mass balancing within each transaction ensures that the material flows are accounted for at any time and avoids ““losing”” material/products containing the material within the supply chain. Accordingly, with only two transaction types, mass balancing for a distributed system, for a single company within the distributed system or mass balancing for a specific product containing specific material(s) may be performed in distributed consensus.

FIG. 3 illustrates a sequence diagram for committing a transaction to the distributed ledger via a member node, such as any one of member nodes 202, 210, 218 of FIG. 2. The numbering in square backets indicates the sequence of steps performed by the respective components of the decentralized system comprising the distributed ledger.

The sequence diagram contains a client side 302 and a server side 304, the server side representing a respective member node of FIG. 2. The client side 302 comprises an application 306 and a driver 308 in communication with application 306. The server side 304 comprises a distributed ledger server 310, a consensus algorithm 312 in communication with the server 310 and a database 314, and the database 314 in communication with the consensus algorithm 312 and the server 310. In a first step, application 306 is used to generate a JSON payload containing the necessary data for the transaction, such as the amount of material/product, the address of the current owner, the destination address (i.e. the address the material/product is transferred to) and further transaction meta data, such as the material transaction meta data or the product transaction meta data previously described. Said meta data may be used to obtain details on the material or product associated with said transaction as previously described.

“Hiding” the identity of the parties involved in the transaction as well as the details of the material or product associated with said transaction allows—as previously described—to perform mass balancing using the readily available mass listed in the transactions and thus guarantees the anonymity necessary to comply with data regulations and to avoid a negative influence on the competitive advantage of participants of the distributed system, for example by allowing to determine the complete supply chain for a certain product. However, the involved parties as well as the involved material/product can be readily determined by accessing—for example, at least one database comprising the public key(s) associated with an involved party as well as the identity of said party and/or using the data contained in the transaction meta data to determine the identity of the material or product(s). The JSON payload generated by application 306 is then sent—along with the singing key-pair—to driver 308.

In the second step shown in the sequence diagram, driver 308 prepares a transaction (hereinafter denoted as TX) from the JSON payload received from application 306 by encapsulating the received JSON data. In one example, driver 308 is included in application 306 as library or module. In another example, driver 308 is included in a further application.

Afterwards, driver 308 signs the encapsulated JSON data using the private key from the signing key-pair received from application 306.

In the third step (step [3] in the sequence diagram), driver 308 POSTs the signed transaction to distributed ledger server 310, for example by using an HPPT API provided by said server 310.

After receiving the signed transaction from driver 308, distributed ledger server 310 performs validation(s) on the received signed transaction. Such validation may include, for example, whether the signature is valid, whether the input amount equals the output amount (in case the transaction is associated with the transfer of a material/product), whether the transaction does not consume an already spend input amount (so called double-spending), whether the public key associated with the owner in the transaction is not on a blacklist or is in a whitelist (to allow control of generating of material and/or product(s) in the distributed ledger), or whether the transaction ID(s) referenced by said transaction is/are not on a blacklist (to avoid transferring material which was, for example, confiscated) etc..

After server 310 has successfully validated the received transaction, its then POSTs the validated transaction to the consensus algorithm component 312 (step [5]), for example by using an HTTP API provided by said component 312. In this example, the consensus protocol is performed upon receiving the validated transaction (step [6]). In another example, the validated transaction is received in the memory pool of the consensus algorithm component 312 and said component 312 waits for the server component 310 to perform some additional validations (not shown). After all validations are done, component 312 performs the consensus protocol on all fully validated transactions pooled in the memory pool of component 312. As part of this consensus process, all validated transactions in the memory pool are packaged into a block and at least part of the member nodes of the distributed ledger vote on the validity of the generated block.

Once consensus is reached among all components 312, component 312 of each member node sends a request to server 310 to commit the block, i.e. to append the block as new block to the existing blockchain (step [7]).

In response to the request received from component 312, the server component 310 commits the block of transaction(s) in database 314 (step [8]) and database 314 stores the block (step [9]). Afterwards, database 314 sends a response back to server component 310 indicating commitment of the block (step [10]).

After server component 310 receives the response indicating commitment of the block, it sends a response to component 312 indicating completion of block commit (step [11]). The server component 310 then sends a response back to application 304 via driver 308 (steps [12] and [13]) that the transaction has been committed in a block and provides data on the transaction, such as the transaction ID, the public keys of the parties associated with the transaction, the transaction meta data or a combination thereof.

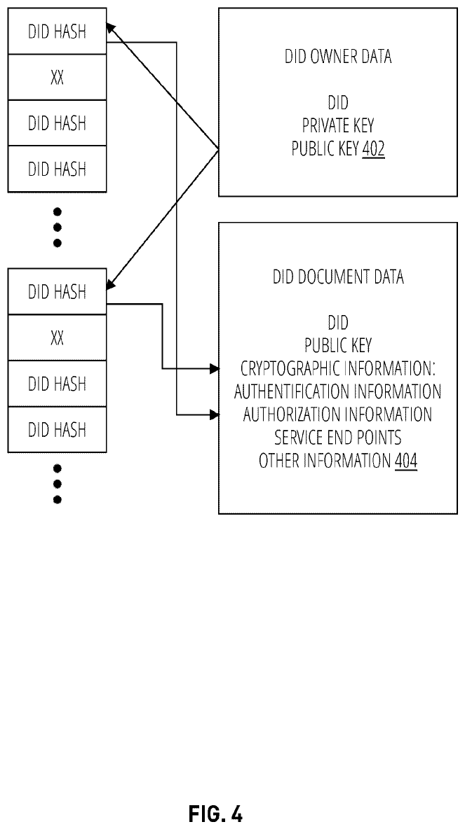

FIG. 4 shows an example of ID-based owner data 402, ID-based data related to the material or data related to the product, and a decentralized identity manager.

The ID may be a decentralized ID (DID). The ID-based data related to the material or data related to the product may be a DID document associated with the DID. The ID-based owner data may include an ID associated with a subject such as related to the material or data related to the product and may include authentication mechanisms. The ID-based owner data may include owner data that is electronically owned and controlled by the DID owner. In this context electronically owned may refer to data that is stored in an owner repository or wallet. Such data may be securely stored and/or managed on an organizational server or client device. The ID-based owner data may include a DID, a private key and a public key. The ID-based owner may own and control the DID that represents an identity associated with the DID subject, a private key and public key pair that are associated with the DID. DID may be understood as an identifier and authentication information associated with or uniquely linked to the identifier.

The DID subject may be a material or a product containing said material, such as a raw material, a chemical product, an intermediate product, a component, a component assembly or an end product. The DID subject may be a machine, a system, or a device used for producing the material or the product containing the material, or a collection of such machine(s), device(s) and/or system(s). The DID owner may be a supply chain participant or a manufacturer such as a chemical manufacturer producing chemicals. The DID owner may be an upstream participant in the supply chain of the chemical manufacturer such as a supplier that supplies raw chemical products or precursors to produce chemicals. The DID owner may be a downstream participant in the supply chain of the chemical manufacturer such as a customer that consumes chemicals to produce the intermediate product, the component, the component assembly or the end product. The DID owner may be any participant of the supply chain including raw chemical product supplier, intermediate chemical products manufacturer, intermediate part manufacturer, component manufacturer, component assembly manufacturer or end product manufacturer.

The DID may be any identifier that is associated with the did subject and/or the DID owner.

Preferably, the identifier is unique to the DID subject and/or DID owner. The identifier may be unique at least within the scope in which the DID is anticipated to be in use. The identifier may be a locally or globally unique identifier for material or the product(s) containing the material or a collection thereof; the machine, the system, or the device used for producing the material or the product(s) containing the material, or the collection of such machine(s), device(s) and/or system(s); the chemical manufacturer producing chemicals, the upstream participant in the supply chain of the chemical manufacturer, the downstream participant in the supply chain of the chemical manufacturer or a collection thereof; any participant of the supply chain including raw chemical product supplier, intermediate chemical products manufacturer, intermediate part manufacturer, component manufacturer, component assembly manufacturer or end product manufacturer or a collection thereof.

The DID may be a Uniform Resource Identifier (URI) such as a Uniform Resource Locator (URL). The DID may be an Internationalized Resource Identifier (IRI). The DID may be a random string of numbers and letters for increased security. In one embodiment, the DID may be a string of 128 letters and numbers e.g. according to the scheme did: method name: method specific-did such as did:example:ebfeb1f712ebc6f1c276e12ec21. The DID may be decentralized independent of a centralized, third party management system and under the control of the DID owner.

The data set as DID document may be associated with the DID. Accordingly, the data set may include a reference to the DID, which is associated with the DID subject that is described by the DID document. The DID document may also an authentication information such as the public key. The public key may be used by third-party entities that are given permission by the DID owner/subject to access information and data owned by the DID owner/subject. The public key may also be used for verifying that the DID owner, in fact, owns or controls the DID. The DID document may include authentication information, authorization information e.g. to authorize third party entities to read the DID document or some part of the DID document e.g. without giving the third party the right to prove ownership of the DID.

The data set may include the transaction ID(s) of material transfer transactions associated with the material and/or product transfer transactions associated with the product(s) containing the material. The data set may include one or more representations (e.g. data related to the material or data related to the product) that digitally link to the material property data or product property data, e.g. by way of service endpoints. A service endpoint may include a network address at which a service operates on behalf of the DID owner. In particular, the service endpoints may refer to services of the DID owner that give access to material property data or product property data. Such services may include services to read or analyze material property data or product property data. Material or product property data may include the transaction ID(s) of material transfer transactions associated with the material and/or transaction ID(s) of product transfer transactions associated with product(s) containing the material, chemical product declaration data, chemical product safety data, certificate of analysis data, emission data, product carbon footprint data, product environmental footprint data, product specification data, product information, technical application data, production data or combinations thereof.

The data set may include various other information such metadata specifying when the data set was created, when it was last modified and/or when it expires.

The DID and the data set may be associated with a data registry node such as a centralized data service system or a decentralized data service system, e.g. a distributed ledger or blockchain. Possible blockchain systems include Quorum and Hyperledger Fabric. The distributed ledger or blockchain may be used to store a representation of the DID that points to the data set. A representation of the DID may be stored on distributed computing nodes of the distributed ledger or blockchain. For example, DID hash may be stored on multiple computing nodes of the distributed ledger and point to the location of the data set. In some embodiments, the data set may be stored on the distributed ledger. Alternatively, in other embodiments the DID document may be stored in a data storage (not illustrated) that is associated with the distributed ledger or blockchain.

The distributed ledger or blockchain may be any decentralized, distributed network that includes various computing nodes that are in communication with each other. For example, the distributed ledger may include a first distributed computing node, a second distributed computing node, a third distributed computing node, and any number of additional distributed computing node. The distributed ledger or blockchain may operate according to any known standards or methods for distributed ledgers. Examples of conventional distributed ledgers that correspond to the distributed ledger or blockchain include, but are not limited to, Bitcoin [BTC], Ethereum, and Litecoin.

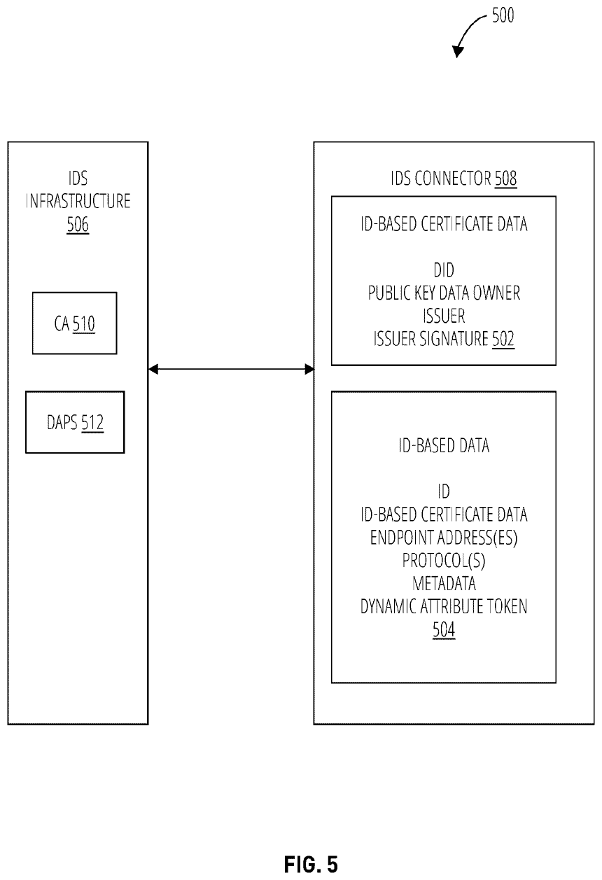

FIG. 5 shows an example 500 of ID-based certificate data, ID-based data related to the material or data related to the product, and an identity manager.

In contrast to the example of FIG. 4, the example of FIG. 5 is certificate based. ID-based certificate data may include authentication data of the certificate owner and the certificate issuer. For example, a cryptographic signature from the issuer may bind the public key of the data owner to the ID. The ID may be a unique ID (such as UID) as described in relation to the DID of FIG. 2. The certificate may be a X.509 certificate such as X509v3. The ID-based data related to the material or data related to the product may be associated with the data source of the data owner. The ID-based data may include an ID, authentication data, transaction ID(s) of material transfer transaction(s) associated with the material and/or product transfer transaction(s) associated with the product(s) containing the material, and endpoints associated with material property data or product property data. Such endpoints may include any digital representation connecting to the data source. The data source may provide the material property data or product property data.

In this certificate-based example, the ID-based data related to the material or data related to the product includes one or more certificate(s) associated with the data owner. The certificates may be associated with an identity manager including e.g. a certificate issuing service and/or a dynamic provisioning service providing dynamic attribute tokens (e.g. OAuth Access Tokens).

The information required to verify the certificates are provided via an authentication registry associated with the certificate issuing service and/or a dynamic provisioning service. For instance, in the IDSA Reference Architecture Model, Version 3.0 of April 2019, a connector associated with the data owner, a Certification Authority (CA), a Dynamic Attribute Provisioning Service (DAPS) and a connector associated with the data consumer service are used to verify the identity prior to performing a data exchange (not shown). For this purpose, such connectors include one or more certificate(s) such as X.509 certificate(s). This way the connector possesses a unique identifier embedded in a X.509 certificate that identifies the connector instance.

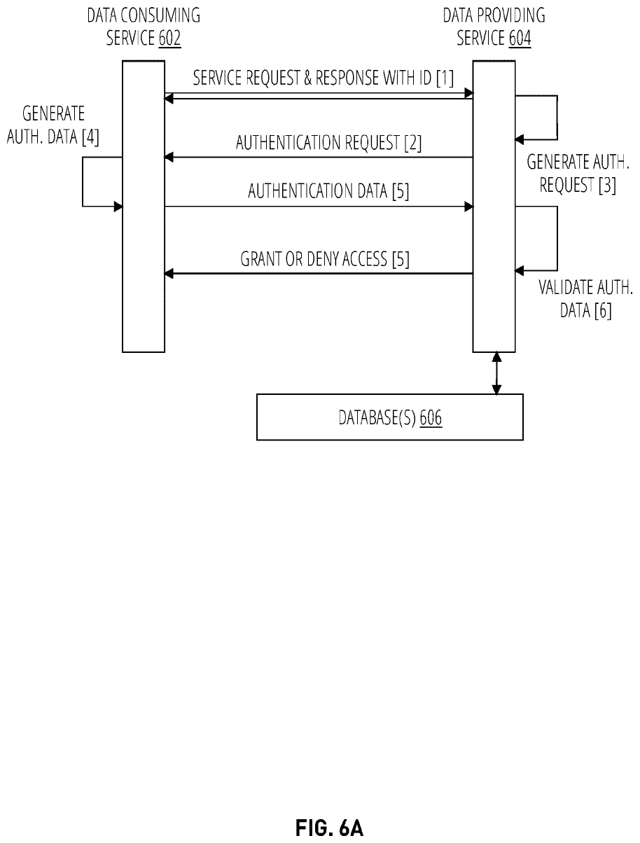

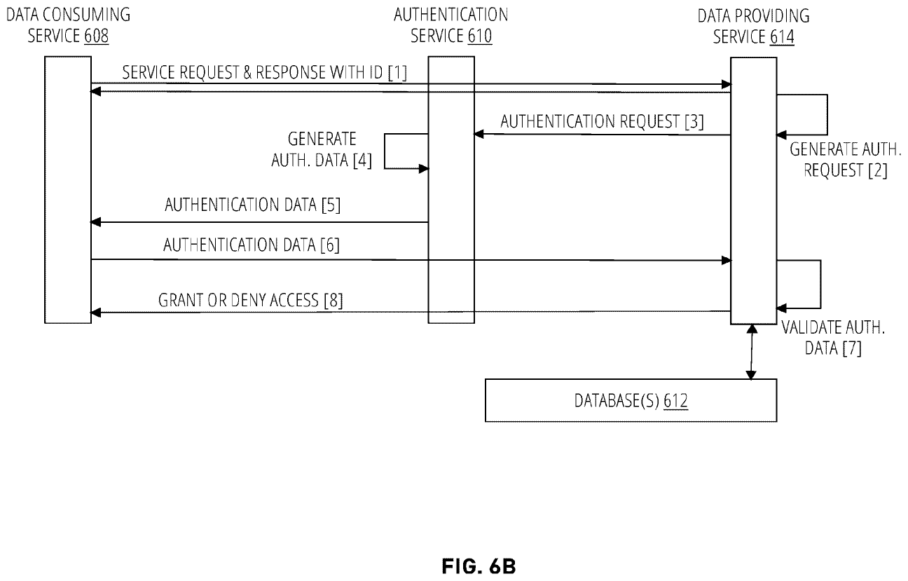

FIGS. 6A and 6B each show an example method for authentication to access a data set containing data of at least one material transfer transaction and/or data of at least one product transfer transaction.

In the process of authentication, various communication patterns may be implemented to verify identities. FIG. 6A illustrates one example communication pattern that may occur between a data providing service and a data consuming service. In this case, the data providing service may act as verifying entity and no separate service may be used for authentication.

The data consuming service may request a service from the data providing service. The request may include the decentral identifier, such as a DID, of the data consuming service.

In response to the request, the data providing service may access a registry such as a central or decentral authentication registry to retrieve data related to the authentication mechanism(s) associated with the decentral identifier. For instance, the central authentication registry may provide data related to authentication mechanism via an authentication service issuing access token. Further for instance, the decentral authentication registry may provide data related to authentication mechanism by generating a request token. Data related to authentication mechanism may include a public key of the data consuming service.

Based on the retrieved data related to the authentication mechanism(s), the data providing service may generate an authentication request (corresponding for example to authentication request tokens or dynamic attribute tokens). The authentication request may be generated based on a public key of the data consuming service and/or the private key of the data provider service. The generated authentication request may be sent to the data consuming service.

Based on the received authentication request, the data consuming service may generate authentication data for responding to the authentication request. The generated authentication data may be sent back to the data providing service.

Receiving the response including the authentication data from data consuming service, the data providing service may then validate the authentication data. In response to the validation, the data providing service may grant or deny the service request of the data consuming service. In case access is granted, the data consuming service may provide a decentral identifier associated with the respective data set to be retrieved and the data providing service may validate the provided decentral identifier and—upon validation—may provide the data associated with the decentral identifier, such as the material property data or the product property data associated with the data related with the material or the data related with the product.

FIG. 6B illustrates another example communication pattern that may occur between a data providing service, a data consuming service and an authentication service.

First, the data consuming service may request a service or initiates a communication with the data providing service. The request may include the decentral identifier, such as a DID, of the data consuming service.

Receiving the request, the data providing service may access a distributed ledger to retrieve one or more authentication mechanism(s) associated with the decentral identifier. Based on the retrieved authentication mechanisms(s), the service provider may generate an authentication request.

Here, the at least one of the retrieved authentication mechanism(s) may be provided via the authentication service. As such, in some embodiments, the generated authentication request may be sent to the authentication service directly. Receiving the authentication request from the data provider service, the authentication service may generate the authentication data.

The authentication data generated by the authentication service may be sent to the data consuming service.

Data consuming service then, in turn, may pass on the authentication data to the data providing service. Receiving the authentication data, the data providing service may then validate the authentication data. In response to the validation, the data providing service may grant or deny the service request of the data consuming service. In case access is granted, the data consuming service may provide a decentral identifier associated with the respective data set to be retrieved and the data providing service may validate the provided decentral identifier and upon validation—may provide the data associated with the decentral identifier, such as the material property data or the product property data.

Alternatively, in some embodiments, after the data providing service may generate an authentication request, the data providing service may send the authentication requests to data consuming service. The data consuming service may pass on the authentication request to the authentication service.

Further, after the authentication service may generate the authentication data, in some embodiments, the authentication service merely contacts the data consumer service to notify the receipt of the authentication request and to obtain consent. When the data consumer service receives the notification, the data consumer service consents and sends the consent back to the authentication service. Receiving the consent, the authentication service then sends the authentication data directly to the data providing service.

Finally, in many transactions, the authentication may be mutually performed by both parties. In such a mutual authentication situation, each involved party is both a subject entity and a verifying entity. Data consuming service and data providing service have control over their decentral identities. At the beginning, services exchange their decentral identities. Next, each of the services accesses a distributed ledger to obtain each other's authentication mechanism(s). Each service then generates its own authentication request based on the other ID's authentication method(s). The generated authentication data is then sent to the other service. Receiving each other's authentication data, each service validates the received authentication data. Based on the validation results, the services may then perform additional communications, e.g. one service may grant or deny the service request of the other service.

FIGS. 6A and 6B only show examples of authentication protocols. Also, although the communication arrows were discussed in a certain order or illustrated in a sequence of communications, no particular ordering is required unless specifically state, or required because a communication is dependent on another communication being completed prior to the communication being transmitted.

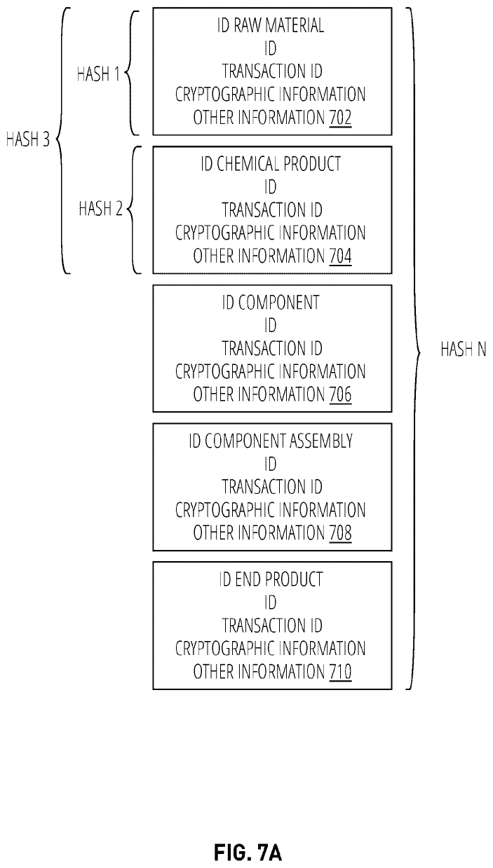

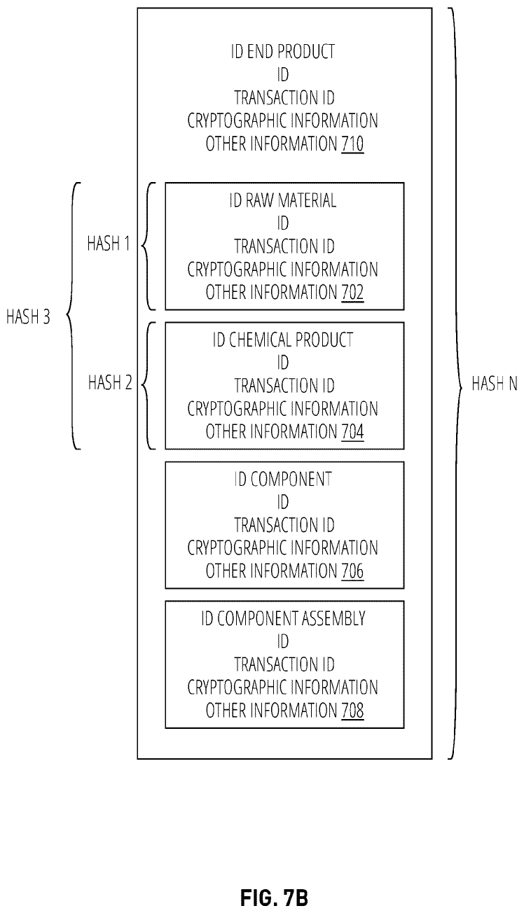

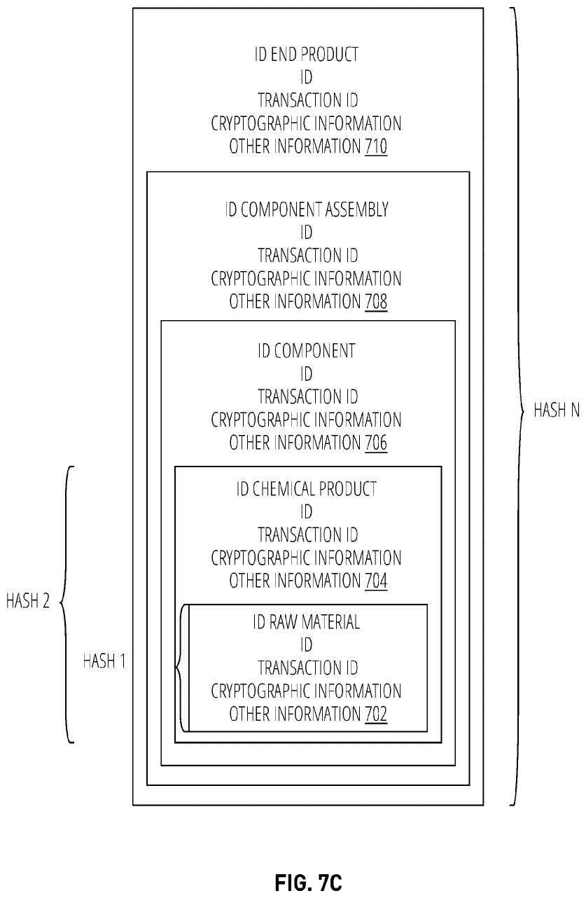

FIG. 7A illustrates an individual configuration for data sets generated in the chemical value chain. For multiple product stages in the chemical value chain individual data sets may be generated. The data set may include the providing of a decentral identifier and an authentication mechanism for each of the multiple product stages. The data sets for the multiple product stages may be based on crypto signatures. For instance, the data sets for the multiple product stages may be concatenated through hash values based on different data sets. As shown in FIG. 7A hash 1 may be based on data of the raw material data set, hash 2 may be based on data of the chemical product data set and hash 3 may be based on data of the raw material data set plus data of the chemical product data set. Further concatenation may be done for other combinations of data sets up to hash N, which concatenates data sets up to the end product data set. Concatenation via hashes of the crypto signature is only one example concatenation. Other examples include permission aggregations with different scope of data that may be embedded in child data sets, public key aggregations with different crypto signatures or service endpoint aggregation with different links. Each data set includes a transaction ID of at least one material transfer transaction and/or a transaction ID of at least one product transfer transaction(s). The material transfer transaction and/or the product transfer transaction is associated with the transfer of the material associated with the material data set and/or the product containing the material associated with the product data set.

FIG. 7B illustrates an anchored configuration for different data sets generated in the chemical value chain. For the end product an end data set is generated. For multiple product stages of the end product individual data sets may be generated and embedded in or linked with the end data set. The data set generation may include the providing of a decentral identifier and an authentication mechanism for each of the multiple product stages. The data sets for the multiple product stages may be based on crypto signatures. For instance, the data sets for the multiple further product stages may be concatenated through hash values based on different data sets.

As shown in FIG. 7B hash 1 may be based on data of the raw material data set, hash 2 may be based on data of the chemical product data set and hash 3 may be based on data of the raw material data set plus data of the chemical product data set. Further concatenation may be done for other combinations of data sets up to hash N, which concatenates data sets up to the end product data set. Concatenation via hashes of the crypto signature is only one example concatenation. Other examples include permission aggregations with different scope of data that may be embedded in child passports, public key aggregations with different crypto signatures or service endpoint aggregation with different links. Each data set includes a transaction ID of at least one material transfer transaction and/or a transaction ID of at last one product transfer transaction(s). The material transfer transaction and/or the product transfer transaction is associated with the transfer of the material associated with the material data set and/or the product containing the material associated with the product data set.

FIG. 7C illustrates a fully embedded configuration for different data sets generated in the chemical value chain. For multiple product stages in the chemical value chain individual data sets may be generated. The data set generation may include the providing of a decentral identifier and an authentication mechanism for each of the multiple product stages. The data sets for the multiple product stages may be based on crypto signatures. For instance, the data sets for the multiple product stages may be concatenated through hash values. As shown in FIG. 7C hash 1 may be based on data of the raw material data set. Hash 2 may be based on data of the raw material data set and the chemical product data set. Further concatenation may be done for other combinations of data sets up to hash N, which concatenates data sets up to the end product data set. Concatenation via hashes of the crypto signature is only one example concatenation. Other examples include permission aggregations with different scope of data that may be embedded in child passports, public key aggregations with different crypto signatures or service endpoint aggregation with different links. Each data set includes a transaction ID of at least one material transfer transaction and/or a transaction ID of at last one product transfer transaction(s). The material transfer transaction and/or the product transfer transaction is associated with the transfer of the material associated with the material data set and/or the product containing the material associated with the product data set.

FIGS. 7A to 7C show different example configurations for data sets anchored by digital identifiers. The configurations include different parent, child, grandchild and so on relationships for data sets generated in the chemical value chain up to an end product. Similarly, data sets generated in the recycling chain from an end product to recyclate(s) may be concatenated.

Further similarly, the data sets generated in the chemical value chain up to an end product and in the recycling chain from the end product to recyclate(s) may be concatenated. This way the circularity of material flows may be virtually represented and tracked.

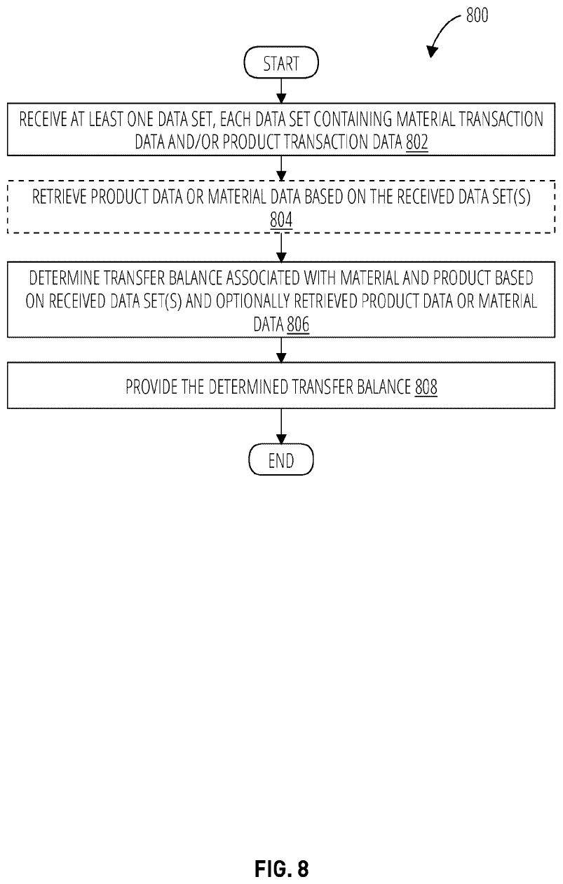

FIG. 8 shows a block diagrams illustrating a method 800 for tracking at least one transfer, in particular for determining a mass balance, of a material and at least one product containing the material in a decentral network comprising a distributed ledger (for example the decentral network of FIG. 2) according to the present disclosure.

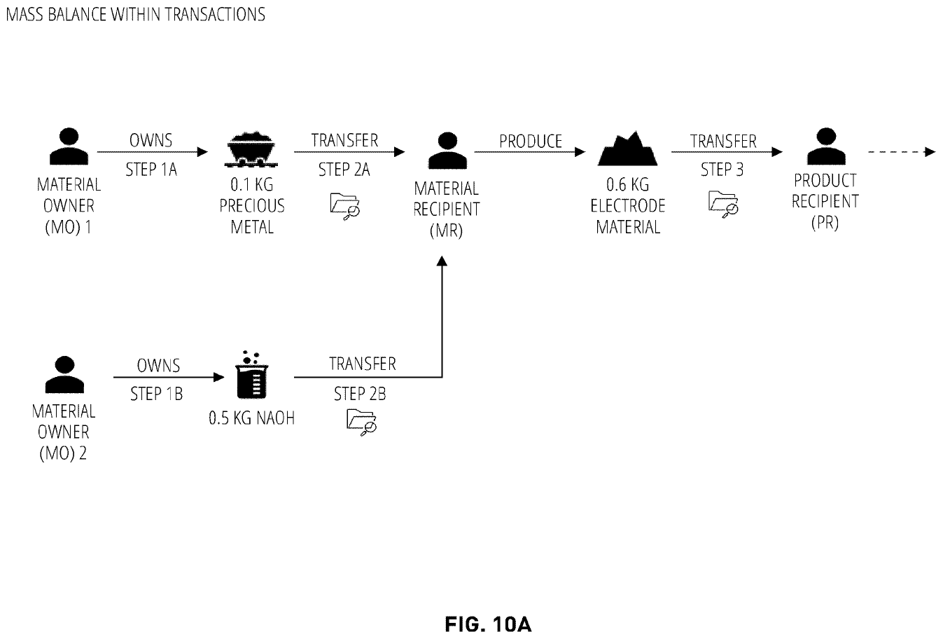

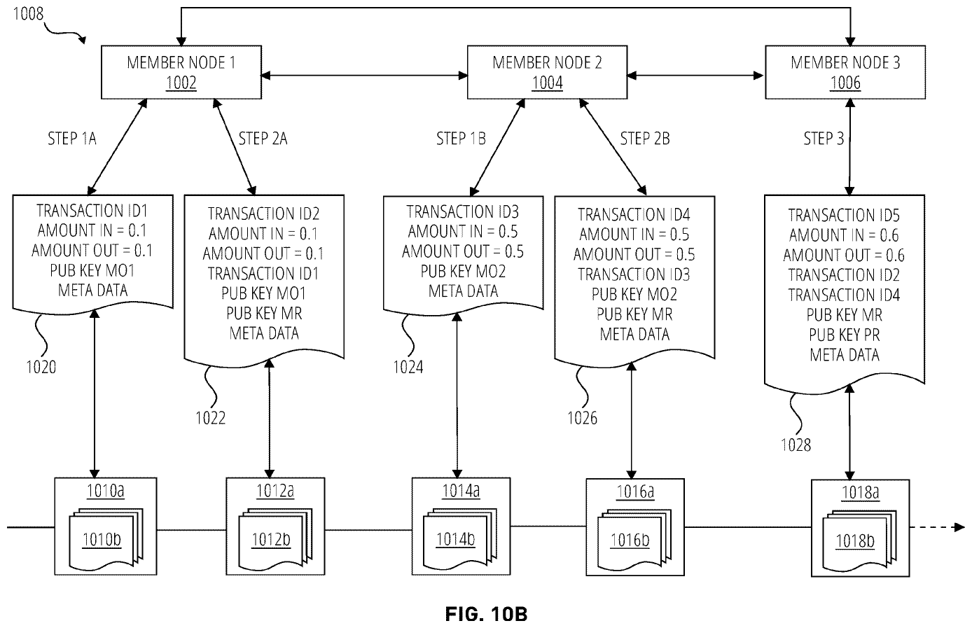

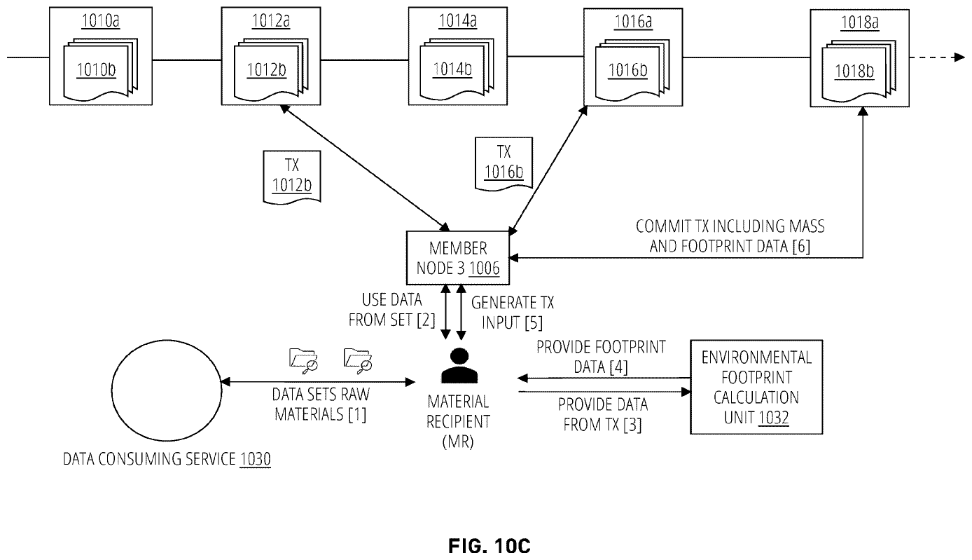

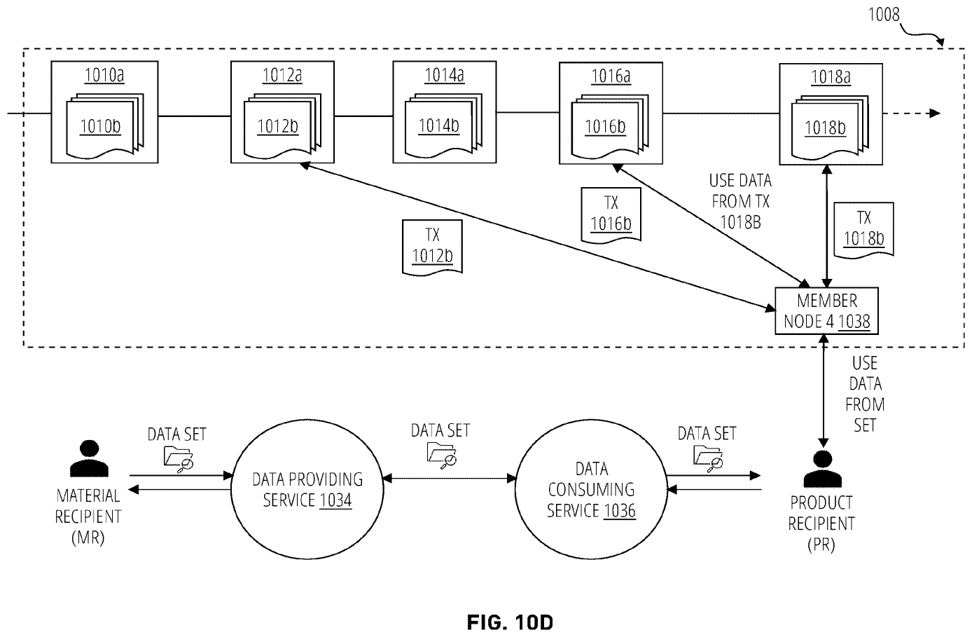

In step 802 of method 800, at least one data set is received. Each received data set contains material transfer transaction data and/or product transfer transaction data. In this example, each data set further includes a digital representation pointing to material property data or product property data mentioned previously and can be generated, for example, as described in relation to FIG. 10C below. The data set(s) are preferably received from a data providing service, for example as described in more detail in relation to FIG. 10D below. In this example, material transfer transaction data may include the transaction ID(s), the credentials, such as public keys, associated with the material transfer transaction(s), or a combination thereof. The transaction ID(s) may be used to retrieve the respective material transfer transaction(s) from the distributed ledger via a member node. The retrieved material transfer transaction(s) include material data.

In this example, the material data includes the amount of material (either the amount of new material, i.e. material associated for the first time with a transaction committed to the distributed ledger, or the amount of transferred material, i.e. in case the transferred material is associated with a transaction already existing within the distributed ledger) and material transaction meta data, such as a material identifier and/or a material classification and/or material production data. Use of data sets independently of the information written in the distributed ledger allows to immutably store certain information, like the amount as well as the digital representation pointing to the data set and thus associating the respective material/product(s) with said transaction within a distributed ledger while allowing to provide detailed information on the material via a separate harmonized data exchange route. This allows to reduce the data contained within each transaction to a minimum, thus reducing the amount of data that needs to be stored within the distributed ledger, and also guarantees the necessary privacy of the sensitive details on the material/product(s) associated with the respective transaction(s).

The amount of data received in block 802 depends on the type of transfer balance, in particular mass balance, that is going to be determined in block 806. For example, if the overall mass balance of a distributed system is to be determined, the data sets received in block 802 corresponds to all data sets associated with the total mass in-flow into the distributed system, i.e. the total amount of raw material and/or virgin material. If a mass balance for a single company within a distributed system is to be determined, the data sets received in block 802 corresponds to all data sets associated with the total mass-in flow into said company. Likewise, if a mass balance for a certain product produced from at least one material is to be determined, the data sets received in block 802 corresponds to the data sets associated with the total mass-inflow of material used to produce said product.

In block 804 of method 800, the material data and the product data is retrieved based on the data set(s) received in block 802. If the data set(s) received in block 802 contain data of material transfer transaction(s) as well as data of product transfer transaction(s), said data can be used to retrieve the respective material and product transfer transaction(s) containing the material data and the product data, respectively, from the distributed ledger via a member node.

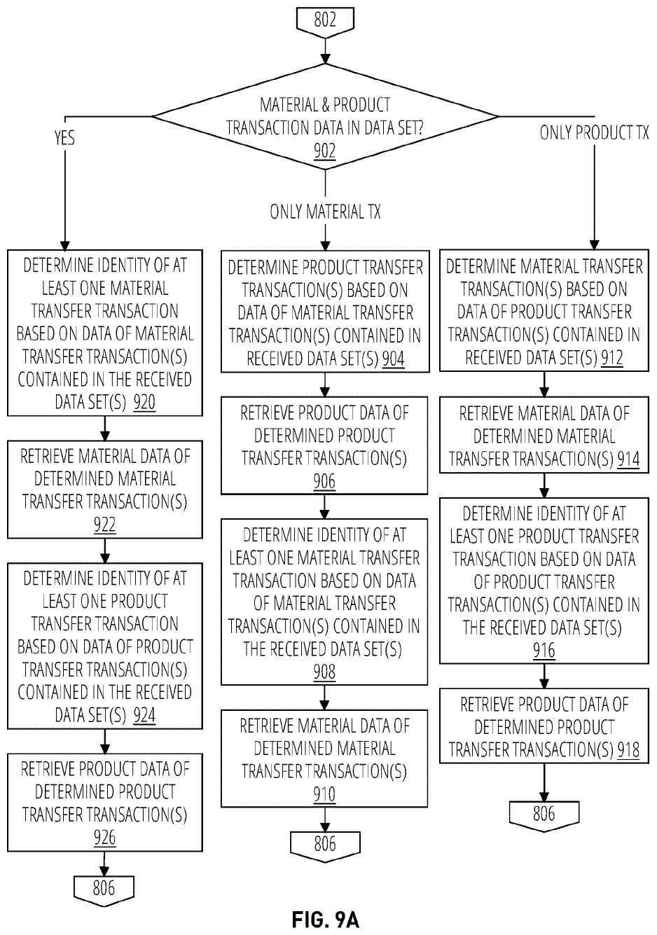

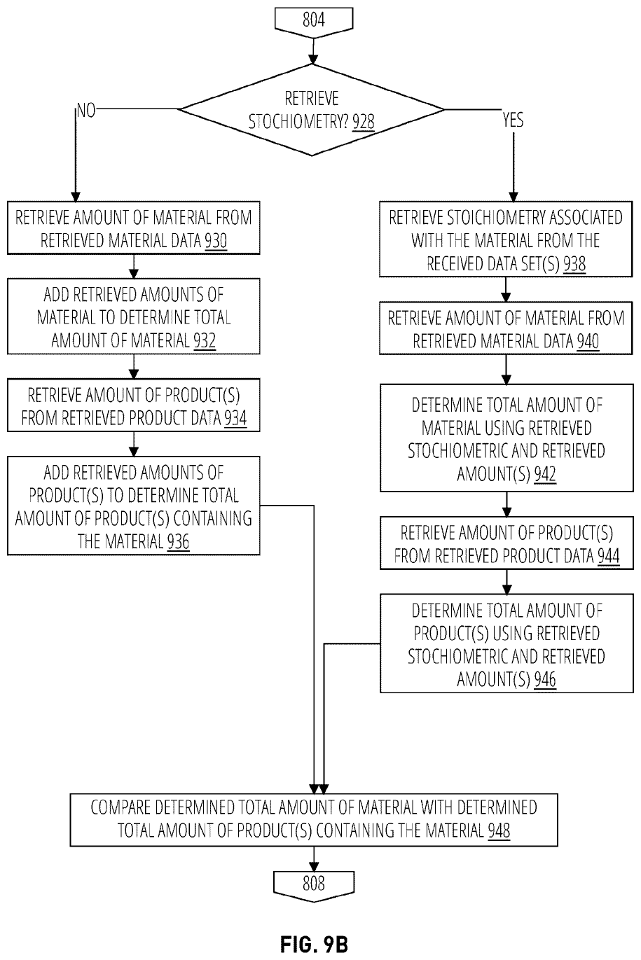

The material data and product data can then be retrieved from the retrieved transactions. If the data set(s) received in block 802 either only contain data of material transfer transaction(s) or data of product transfer transaction(s), then the corresponding transfer transactions have to be retrieved based on the contained data. In one example, this is performed as described in relation to FIG. 9A below.

In block 806 of method 800, the transfer balance associated with the material and the product(s) containing the material is determined based on the material data and the product data retrieved in block 804. In this example, the transfer balance, in particular the mass balance, is determined as described in relation to FIG. 9B later on.

In block 808 of method 800, the transfer balance determined in block 806 is provided, for example via a communication interface. In one example, the transfer balance is determined using application 306 of FIG. 3 and is also provided via said application, for example by displaying the result of the determination performed in block 806 within a graphical user interface.

FIG. 9A illustrates a block diagram of one embodiment of block 804 of FIG. 8. In this embodiment, block 802 comprises several sub blocks, depending on the amount of data contained in the data set(s) received in block 802.

In block 902, it is determined whether the data set(s) received in block 802 contain data of material transfer transaction(s) as well as data of product transfer transaction(s), such as the transaction ID and optionally the credentials, in particular the public keys of involved parties, associated with the respective transactions. If the received data set(s) only contain data of material transfer transaction(s), blocks 904 to 910 are performed to retrieve-apart from the material data associated with said transaction data-also the product data. If the received data set(s) only contain data of product transfer transaction(s), blocks 912 to 918 are performed to retrieve-apart from the product data associated with said transaction data-also the material data. If the received data set(s) contain data of material transfer transaction(s) as well as data of product transfer transaction(s), blocks 920 to 926 are performed to retrieve the material data and the product data associated with said transaction data.

In block 904, product transfer transaction(s) are determined based on the data of material transfer transaction(s) contained in the received data set(s). In this example, determination of the product transfer transactions associated with the material based on the data of the material transfer transaction(s) contained in the received data set(s) includes retrieving the data of material transfer transaction(s), in particular the transaction IDs, from the received data set(s) and using the retrieved data, in particular the retrieved transaction IDs, to determine the product transfer transactions associated with said retrieved data, in particular with the retrieved transaction IDs. As previously described and as shown in FIG. 10B described later on, material transfer transactions associated with a material and product transfer transactions associated with product(s) containing said material are chained to each other, thus allowing to determine the product transfer transactions associated with the material transfer transactions using the transaction IDs of the material transfer transaction(s). The product transfer transactions may be determined by providing the transaction IDs of the material transfer transaction(s) to a member node and querying the database layer of the distributed ledger (see for example FIG. 2) for the respective transaction IDs of the product transfer transactions.

In block 906, the product data contained in the product transfer transaction(s) determined in block 904 is retrieved. This may, for example, be performed via a member node by querying the database layer of the distributed ledger for the product data using the transaction IDs determined in block 904.

In block 908, the identity of at least one material transfer transaction is determined based on the data of material transfer transactions contained in the received data set(s). The identity may include the transaction ID(s), the credential(s), such as the public keys of the parties involved in the transaction, or a combination thereof. In this example, the identity includes the transaction IDs. In this example, the receive data set(s) contain transaction IDs of material transfer transaction(s) associated with the material and said transaction IDs are retrieved from the receive data set(s) in block 908.

In block 910, the material data is retrieved from the material transfer transaction(s) determined in block 908. This may be performed as described in relation to block 906 by accessing the database layer of the distributed ledger via a member node and using the transaction IDs determined in block 908 to retrieve the associated material data.

In block 912, material transfer transaction(s) are determined based on the data of product transfer transaction(s) contained in the received data set(s). In this example, determination of the material transfer transactions associated with the product(s) containing the material based on the data of the product transfer transaction(s) contained in the received data set(s) includes retrieving the data of product transfer transaction(s), in particular the transaction IDs, from the received data set(s) and using the retrieved data, in particular the retrieved transaction IDs, to determine the material transfer transactions associated with said retrieved data, in particular with the retrieved transaction IDs. As previously described and as shown in FIG. 10B described later on, material transfer transactions associated with a material and product transfer transactions associated with product(s) containing said material are chained to each other, thus allowing to determine the material transfer transactions associated with the product transfer transactions using the transaction IDs of the product transfer transaction(s). The material transfer transactions may be determined by providing the transaction IDs of the product transfer transaction(s) to a member node and querying the database layer of the distributed ledger (see for example FIG. 2) for the respective transaction IDs of the material transfer transactions. In block 914, the material data contained in the material transfer transaction(s) determined in block 912 is retrieved. This may, for example, be performed via a member node by querying the database layer of the distributed ledger for the material data using the transaction IDs determined in block 912.

In block 916, the identity of at least one product transfer transaction is determined based on the data of product transfer transactions contained in the received data set(s). The identity may include the transaction ID(s), the credential(s), such as the public keys of the parties involved in the transaction, or a combination thereof. In this example, the identity includes the transaction IDs. In this example, the receive data set(s) contain transaction IDs of product transfer transaction(s) associated with the product(s) containing the material and said transaction IDs are retrieved from the received data set(s) in block 916.

In block 918, the product data is retrieved from the product transfer transaction(s) determined in block 916. This may be performed as described in relation to block 906 by accessing the database layer of the distributed ledger via a member node and using the transaction IDs determined in block 916 to retrieve the associated product data.

In block 920, the identity of at least one material transfer transaction is determined based on the data of material transfer transactions contained in the received data set(s) as described in relation to block 908 above.

In block 922, the material data contained in the material transfer transaction(s) determined in block 920 is retrieved as described previously in relation to block 910.

In block 924, the identity of at least one product transfer transaction is determined based on the data of product transfer transactions contained in the received data set(s) as described in relation to block 916 above.

In block 926, the product data is retrieved from the product transfer transaction(s) determined in block 924 is retrieved as described previously in relation to block 918.

FIG. 9B illustrates a flow diagram of one embodiment to determine the transfer balance as described in relation to block 806 of FIG. 8.

In block 928, it is determined whether to retrieve the stoichiometry. This determination may be made, for example, depending on the type of transfer balance, in particular mass balance, that is going to be determined. For example, if the overall mass balance of the distributed system or the mass balance of one company being part of a distributed system is to be determined, the stoichiometry is not necessary, and the total amount of material is determined as described in blocks 930 and 932. However, if the transfer balance for a specific product is to be determined, the stoichiometry is required and needs to be retrieved as described in relation to block 938 later on. If it is determined in block 928 that the stoichiometry is not required, the method proceeds to block 930, otherwise it proceeds to block 938 described later on.

In block 930, the amount of material is retrieved from the material data retrieved in block 804 of FIG. 8 or in block 910/914/922 of FIG. 9A.

The amounts retrieved in block 930 are then added in block 932 to obtain the total amount of material.

In block 934, the amount of product(s) containing the material is retrieved from the product data retrieved in block 804 of FIG. 8 or in block 906/918/926 of FIG. 9A.

The amounts retrieved in block 934 are then added in block 936 to obtain the total amount of product(s) containing the material.

In block 938, the stoichiometry associated with the material is retrieved from the received data set(s). For this purpose, the data related to the product, such the digital representation pointing to product property data, may be used to retrieve the stoichiometry. The data related to the product may be accessed via a data consuming service using the decentral identifier contained in the received data set as previously described (see also FIG. 10C).

In block 940, the amount of material is retrieved from the retrieved material data as described in relation to block 930.

In block 942, the total amount of material is determined using the stoichiometry retrieved in block 938 and the amount of material retrieved in block 940.

In block 944, the amount of product(s) containing the material is retrieved from the retrieved product data as described in relation to block 934.

In block 946, the total amount of product(s) is determined using the stoichiometry retrieved in block 938 and the amount of material retrieved in block 944.

In block 948, the transfer balance, in particular the mass balance, is determined using the total amount of material determined in block 932 or 942 as well as the total amount of product(s) containing the material determined in block 936 or 946 by comparing the total amount of material to the total amount of product(s). If said amounts are equal, the mass balance is valid, i.e. all material is used to produce the respective product(s). With respect to circular systems, the mass balance allows to detect unaccounted product losses, such as waste which is illegally disposed on landfills, because the amount of product(s) is not equal to the amount of material in case of illegally deposited waste.

FIG. 10A is a block diagram illustrating the transfer of materials and a product containing the materials to several parties of a distributed system. In this example, a first material owner (denoted MO1 in FIG. 10A) owns 0.1 kg of precious metal and a second material owner (denoted MO2 in FIG. 10A) owns 0.5 kg of sodium hydroxide (NaOH). The precious metal as well as the NaOH are regarded as material within the sense of the present invention. The number of parties as well as the exact materials and products may vary from the ones illustrated in FIG. 10A. For example, more or less material owners may be present and the type of material may differ from the ones illustrated in FIG. 10A. Likewise, more material recipients and/or more product recipients may be present..

In step 2A, the 0.1 kg precious metal owned by material owner MO1 are transferred from said material owner to a material recipient MR. Likewise, the 0.5 kg NaOH owned by material owner MO2 are transferred from said material owner to a material recipient MR in step 2B. The transfer of the precious metal as well as the NaOH is accompanied by the transfer of respective data set(s) (illustrated by folder icon in FIG. 10A). The material recipient (MR) can retrieve the data set(s) associated with the precious metal as well as the NaOH from respective data providing services using his data consuming service. The data set(s) may contain a decentral identifier, data related to the material as described previously as well as the transaction IDs associated with the respective material transfer transactions stored in the distributed ledger (see for example FIGS. 7A to 7C).

The material recipient uses the received materials, i.e. the received 0.1 kg precious metal and the 0.5 kg NaOH, to produce 0.6 kg electrode material. The produced 0.6 kg electrode material which is corresponding to the product containing the materials is then transferred in step 3 to a product recipient PR.

FIG. 10B is a block diagram illustrating the transactions associated with the material and product transfers previously discussed in relation to FIG. 10A. Said transactions have been committed by several member nodes to the distributed ledger, i.e. said transactions are stored within one or more blocks of the distributed ledger. In this example, a member node is each assigned to material owner MO1 (i.e. member node 1, 1002), to material owner MO2 (i.e. member node 2, 1004) and to material recipient MR (i.e. member node 3, 1006). In another example, more or less member nodes may be used, for example if one party of the distributed system is using a plurality of member nodes or if more than one party of the distributed system is sharing a member node.

In order to validate integrity of a chain of several transactions, the “asset type” of the chained transactions has to be identical. In other words, once a material flow chain starts by registering new material in the distributed ledger, the asset type associated with said material can no longer be changed. Therefore, the asset type has to be set for all transactions uniformly. In this example, the asset type is set to “asset: mass”, that is, asset is defined as generic transfer of an amount of mass (measured for example in 1/1000 kilogram).

In this example, each transaction associated either with registering new material in the distributed ledger (i.e. storing said material or the first time within a block of the distributed ledger) or with transferring material/product(s) containing the material, is stored within a different block 1010a, 1012a, 1014a, 1016a, 1018a of the distributed ledger. In another example, at least two of the transactions 1020, 1022, 1024, 1026, 1028 shown in FIG. 10B are stored within the same block of the distributed ledger. In this example, each block 1010a, 1012a, 1014a, 1016a, 1018a contains a plurality of transactions 1010b, 1012b, 1014b, 1016b, 1018b. In another example, each block 1010a, 1012a, 1014a, 1016a, 1018a only contains one transaction. The amount of transactions present within a block depends on whether the transactions received by a certain member node are pooled prior to generating a block, for example as described in relation to FIG. 3 above.

The transaction 1020 associated with step 1A corresponds to registering the 0.1 kg precious metal owned by material owner MO1 for the first time in the distributed ledger. The transaction contains a transaction ID (i.e. transaction ID1), the input amount (i.e. the 0.1 kg (of precious metal), an output amount which is corresponding to the input amount because said amount is registered for the first time in the distributed ledger, the public key of material owner MO1 and material transaction meta data, such as the material transaction meta data mentioned previously, which allows to retrieve details on the registered material by authorized parties, such as by material recipient MR or by auditors. The transaction 1020 has been committed by member node 602 within block 610a to the distributed ledger. To register the 0.1 kg precious metal within the distributed ledger, material owner MO1 may use an application, for example application 306 described in relation to FIG. 3. After entering the respective data (i.e. the amount to be registered, the public key of MO1, the private key of MO1 as well as the material transaction meta data), the application 306 sends a JSON payload to driver 308, which prepares a transaction form the received payload and signs the prepared transaction.

Afterwards, the driver 308 sends the signed transaction to the client side 304 (in this case member node 1, 1002), which validates the transaction, performs a consensus and commits the transaction within a new block if consensus is reached as described in FIG. 3 above. Since registering a material for the first time within the distributed ledger is a sensitive step, said registration may only be performed by certain parties to avoid registering material in the distributed ledger which is not existing in the real world because this would result in an invalid mass balance. Control of registering transactions may be performed, for example, by using a whitelist or blacklist of public keys which is retrieved by the distributed ledger server upon validation of the transaction. If using a whitelist, the transaction is valid if the public key contained in the transaction is matching a public key on said whitelist. If using a blacklist, the transaction is valid if the public key contained in the transaction is not matching said public keys on the blacklist.

Transaction 1022 is associated with the transfer of the 0.1 kg precious metal registered in step 1A to material recipient MR (corresponding to step 2A in FIG. 10A). Since this transaction maps a transfer from material owner MO1 to material recipient MR, said transaction contains additionally the transaction ID of the transaction associated with registering the 0.1 kg precious metal within the distributed ledger (i.e. transaction ID1) and the public key of the material recipient (to indicate which party is receiving the material). Use of the transaction ID1 allows the distributed ledger server 310 to validate whether the input amount has not already been spent to avoid double spending of an asset registered within the distributed ledger. The material recipient MR may use the material transaction meta data to retrieve details on the transferred material, such as the material property data, as previously described. The transaction 1022 has been committed by member node 1002 within block 1012a to the distributed ledger. To transfer the 0.1 kg precious metal to the material recipient, material owner MO1 may use an application, for example application 306 described in relation to FIG. 3 to enter the necessary data and to generate a transaction which is then validated and stored within a new block of the distributed ledger as described in FIG. 3 above.

Transaction 1024 associated with step 1B corresponds to registering the 0.5 kg NaOH owned by material owner MO2 for the first time in the distributed ledger. The transaction contains a transaction ID (i.e. transaction ID3), the input amount (i.e. the 0.5 kg (of NaOH), an output amount which is corresponding to the input amount because said amount is registered for the first time in the distributed ledger, the public key of material owner MO2 and material transaction meta data, such as the material transaction meta data mentioned previously. The transaction 1024 has been committed by member node 1004 within block 1014a to the distributed ledger.

To register the 0.5 kg NaOH, material owner MO2 may use an application, for example application 306 described in relation to FIG. 3 to enter the necessary data and to generate a transaction which is then validated and stored within a new block of the distributed ledger as described in FIG. 3 above.

Transaction 1026 is associated with the transfer of the 0.5 kg NaOH registered in step 1B to material recipient MR (corresponding to step 2B in FIG. 10A). Since this transaction maps a transfer from material owner MO2 to material recipient MR, said transaction additionally contains the transaction ID of the transaction associated with registering the 0.5 kg NaOH within the distributed ledger (i.e. transaction ID3) and the public key of the material recipient (to indicate which party is receiving the material). The transaction 1026 has been committed by member node 1004 within block 1016a to the distributed ledger. To transfer the 0.5 kg NaOH to the material recipient, material owner MO2 may use an application, for example application 306 described in relation to FIG. 3 to enter the necessary data and to generate a transaction which is then validated and stored within a new block of the distributed ledger as described in FIG. 3 above.

Transaction 1028 is associated with the transfer of the 0.6 kg electrode material produced by material recipient from the received 0.1 kg precious metal and the received 0.5 kg NaOH to product recipient PR (corresponding to step 3 in FIG. 10A). Since two materials are used to produce the electrode material, namely 0.1 kg precious metal and 0.5 kg NaOH, transaction 1028 references transaction 1022 (corresponding to the transfer of 0.1 kg precious metal) as well as transaction 1026 (corresponding to the transfer of 0.5 kg NaOH) using the respective transaction IDs. Referencing these transactions allows the distributed ledger server 310 to determine whether the input amounts have already been spent or not, thus avoiding double spending. The transaction 1028 has been committed by member node 606 within block 618a to the distributed ledger. To transfer the 0.6 kg electrode material to the product recipient, material recipient MR may use an application, for example application 306 described in relation to FIG. 3 to enter the necessary data and to generate a transaction which is then validated and stored within a new block of the distributed ledger as described in FIG. 3 above.

Referencing of each associated previous transaction (i.e. chaining all transactions associated with a material and product(s) containing said material together using the transaction IDs) allows to track which material is contained in the product(s), thus allowing product recipient PR to verify that the 0.6 kg electrode material received from material recipient MR have indeed been produced from the 0.1 kg precious metal and the 0.5 kg NaOH referenced in transaction 1028. Moreover, the product transaction meta data contained in transaction 1028 may be used by product recipient PR to retrieve details on the electrode material received from material recipient as previously described.

Referencing of each associated previous transaction moreover allows to perform automated mass balance checks because the input amount is defined by the amount listed in the referenced transactions and the output amount cannot be larger than the input amount. This avoids that a party transfers more materials in a transaction than possible and thus avoids invalid mass balancing due to incorrect data in the distributed ledger.

FIG. 10C is a block diagram illustrating generating a data set for a product containing a material, said data set containing environmental data and the transaction ID of the associated product transfer transaction committed to the distributed ledger. In this example, generation of a data set for the electrode material produced by material recipient MR (see FIG. 10A) is outlined.

However, said method may also be used to generate data sets for other materials and product(s) containing said materials.

In a first step, material recipient MR receives data set(s) of the raw materials, i.e. the precious metal and the NaOH, via his data consuming service 1030 from respective data providing services (not shown). For this purpose, the precious metal and NaOH may be registered with the production facility of material recipient MR. The registration may include providing the decentral identifier associated with the receive precious metal and NaOH. Providing the decentral identifier may include reading the physical identifier element physically connected to the precious metal and NaOH as described above. Providing the decentral identifier may include accessing a database with decentral identifiers and fetching the decentral identifier associated with the precious metal and the NaOH.

Based on the provided decentral identifier, material property data associated with such decentral identifier may be accessed. Access may be granted through authentication and authorization based on authentication and authorization information associated with the decentral identifier (see for example FIGS. 10A and 10B). Based on the decentral identifier, material property data such as chemical declaration data, material safety data, certificate of analysis data, emission data, product carbon footprint data, product environmental footprint data, material specification data, material information, technical application data, production data, performance data, quality data, material configuration data, recyclate content data or combinations thereof may be accessed through data consuming service 1030 requesting access to the material property data associated with each decentral identifier and controlled by material owner MO1 and material owner MO2. The data consuming service may include computer executable instructions operating in an at least partially decentral computing environment. Such computer executable instructions may be based on a Json Web Token (JWT) including authentication information, authorization information and/or a digital representation pointing to data related to the material or parts thereof. The digital representation may include an endpoint for data exchange or sharing (resource endpoint) or an endpoint for service interaction (service endpoint), that may be uniquely identified via a communication protocol. The digital representation(s) pointing to data related to the material or parts thereof may be uniquely associated with the decentral identifier.

He then produces the electrode material and associates the produced material with a physical identifier, such as a batch number or batch ID. The electrode material may be physically connected to a physical identifier element as described above. The physical identifier may be assigned to identifier information associated with the decentral identifier. For such assignment, the physical identifier element may be read or a data base with physical identifiers may be accessed. A request to provide a decentral identifier may be triggered to assign the physical identifier to the decentral identifier. This way, the decentral identifier may be assigned to the electrode material. Providing the decentral identifier may include accessing a database with decentral identifiers and associated information such as authentication information. Providing the decentral identifier may include accessing a decentral service to provide the decentral identifier and associated information such as authentication information. In response to the request, the data set including the decentral identifier and data related to the electrode material may be generated. The data related to the electrode material may include a representation such as a pointer or a link to the product property data of the electrode material. The decentral identifier may be associated to data related to the electrode material. The decentral identifier may further be related or assigned or linked to the decentral identifier of the precious metal and NaOH (i.e. the raw materials used to produce the electrode material). The data set may be provided to a decentral network for access by other participants or producers of the network. This way the chain of input to output material may be made traceable and usable in further manufacturing steps without exposing the chemical product data in an uncontrolled manner.

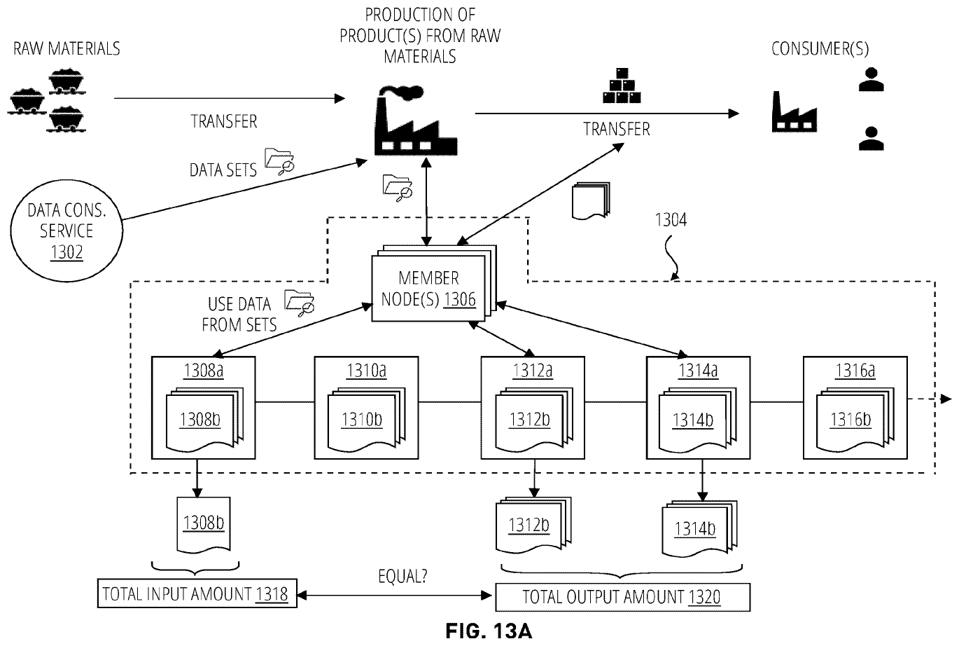

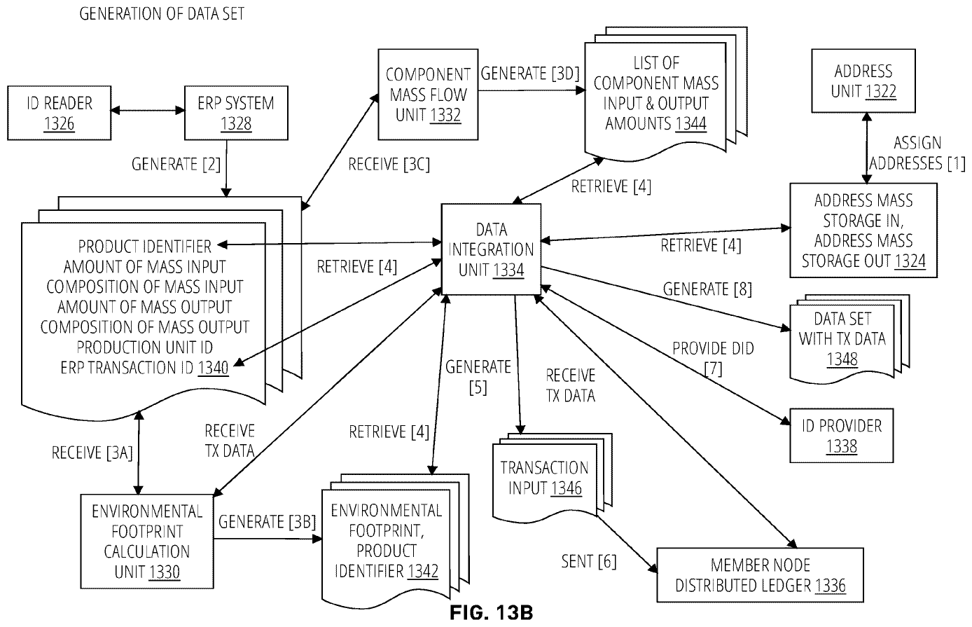

The process steps described above may be executed via an operating system of the production facility (such as implemented in the system described in FIG. 13B). In this embodiment, the operating system includes a collector (such as data integrating unit 1334 of FIG. 13B) configured to collect data of the electrode material and/or physical identifiers as described above. The collector may be configured to collect data associated with the electrode material or data associated with the production of the electrode material, wherein the electrode material is connected to or comprises the physical identifier. The operating system may in particular include an ID reader (such as ID reader 1326 of FIG. 13B) configured to provide the physical identity of the inputs (i.e. precious metal and NaOH) or output(s) (i.e. electrode material) as described above. The system may further include an assignor (such as data integration unit 1334 in FIG. 13B) configured to assign the decentral identifier and associated information to the electrode material as described above. Further the operating system may include an ID provider (such as ID provider 1338 of FIG. 13B) configured to provide the decentral identifier and associated information as described above.

After production of the electrode material, the material recipient MR may use the transaction IDs contained in the data set(s) received in the first step to retrieve material transfer transactions 1012b and 1016b associated with the transfer of the precious metal and the NaOH via member node 1006 from the distributed ledger 1008. The data contained in the retrieved transactions 1012b and 1016b, such as the batch ID contained in the material transaction meta data, may be used along with further production data collected during production of the electrode material by environmental footprint calculation unit 1032 of material recipient MR to calculate emission data and/or recyclate content and/or bio-based content. The emission data and/or recyclate content and/or bio-based content calculated by unit 1032 may then be used to generated transaction input (see step 5) as described in relation to application 306 and driver 308 of FIG. 3. The transaction input may be associated with transfer of the produced electrode material to product recipient PR (see FIG. 10A), i.e. the transaction input may be generated upon transfer of the electrode material to the product recipient. In this example, the transaction input contains the data calculated by unit 1032. In another example, said data is merged with the further property data of the electrode material acquired during or after its production and can be accessed via the digital representation contained in the generated data set. The prepared transaction input is received by member node 1006 (corresponding to client side 304 of FIG. 3) and is committed to the distributed ledger as transaction 1018b in block 1018a (see step 6). The transaction ID received from the member node 1006 upon commitment is used during generation of the data set as previously described.

FIG. 10D is a block diagram illustrating receiving data set(s) from a data consuming service and using the data contained in said set(s) to retrieve the material data and product data stored within transactions committed to the distributed ledger. In this example, the product recipient PR (see FIG. 10A) receives a data set associated with the received electrode material from material recipient MR. The data set can be generated as described in relation to FIG. 10c above. The data set is provided by the data providing service 1034 of the material recipient MR (who has produced the electrode material and owns the data associated with said produced electrode material) to the data consuming service 1036 of the product recipient PR. The product recipient PR may use the digital representation pointing to product property data to retrieve information on the received electrode material via the data consuming service 1036. Moreover, the product recipient PR may retrieve the transaction ID associated with the transfer of the electrode material from material recipient MR to himself, i.e. transaction ID5 of transaction 1028 (see FIG. 10B), from the received data set and may access the transaction data via member node 1038 stored in distributed ledger 1008. Since said transaction 1028 is chained to transactions associated with the materials used to produce the electrode material, namely transactions 1012b (transaction ID2) and 1016b (transaction ID 4), the product recipient can use the transaction IDs2 and 4 to retrieve transaction data, such as the amount as well as the material identifier, via member node 1038. The material identifier may be used by product recipient PR to retrieve data sets associated with the precious metal and the NaOH used to produce the electrode material via his data consuming service 1036 from respective data providing services of material owner MO1 and MO2 (not shown).

The amounts listed in transactions 1012b and 1016b (i.e. the total material amount) can be compared against the amount of product contained in transaction 1018b (i.e. the total product amount) to verify whether the mass balance associated with the production of the electrode material received by product recipient PR is closed. Moreover, the product recipient PR may use data of the electrode material, such as emission data, recyclate content, etc. to likewise calculate the emission data, recyclate content of electrodes produced by said product recipient PR. After production of electrodes from the received electrode material, the product recipient PR may generate data sets as described in relation to FIG. 10C above.

Peer to peer networks exchanging data of digital twins are unable to establish an overall closed mass balance and the complete history of an end product or a recycled product cannot be guaranteed in the absence of centralised oversight. On the other hand, distributed ledger systems implementing the “need to know” principle and storing only a minimum amount of data on chain, such as the transferred mass, the public keys of the parties involved in the transfer and transaction meta data, require private communication channels between the involved parties to exchange data privately that must not appear on the distributed in a transparent way, such as the identity associated with the public key(s), detailed data on the transferred material/product, etc. By combining a peer to peer network exchanging data of digital twins, i.e. exchanging data sets containing a decentral identifier and data related to the material or the product, with a distributed ledger allows to immutably store material transfers/product transfers and to verifiably establish a mass balance with minimum data stored in the distributed ledger. Mass Balance on-chain implies that yield information for each transaction cannot be completely hidden because some information can still be inferred from publicly available network structure (and despite the fact that user public keys are anonymized), for example transactions that branch into very short chains are most likely waste or transactions that don't lead into loops (i.e. into very long chains) are also most likely waste or fuel. This may, however, be tolerated because transparency on mass to waste dumps, recycling yield in mechanical recycling and chemical recycling is likely to be enforced by regulators, such as governmental regulations.

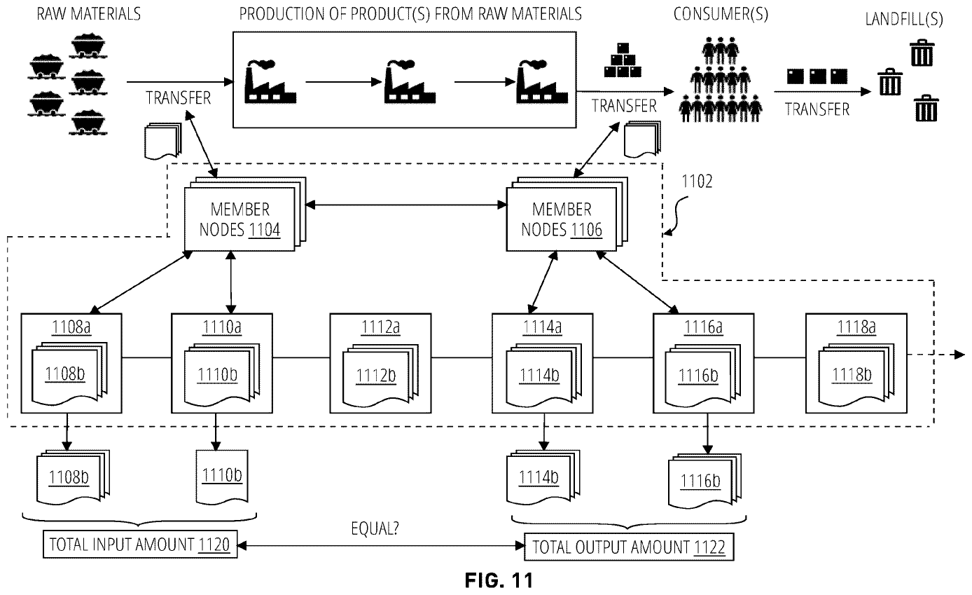

FIG. 11 is a block diagram illustrating determination of the transfer balance of a linear distributed system comprising several parties involved in supplying raw materials and producing product(s) containing said raw materials. In this example, the production of product(s) from the raw materials includes several parties. In another example, the production of product(s) from the raw materials only includes one party, for example if the product(s) can be obtained from the raw materials in a single step without the need to perform any further production/purification steps. In a linear distributed system where no recycling is taking place, it can be assumed that all product(s) transferred from the last party within the production step to the consumer(s) will finally be transferred to landfill(s). Thus, the total mass output of the linear distributed system corresponds to the amount of product(s) transferred to the landfill(s).

In this example, all raw material(s) transferred into the linear distributed system are registered by member nodes 1104 via transactions 1108b and 1110b in blocks 1108a and 1110a of the decentralized network 1102. All product(s) containing the raw materials and leaving the linear system are registered by member nodes 1106 via transactions 1114b and 1116b in blocks 1114a and 1116a of the decentralized network 1102.

To determine the transfer balance, in particular the mass balance, the total amount of raw materials as well as the total amount of product(s) containing said raw materials has to be calculated and compared.

The total amount of raw materials can be obtained by determining transaction associated with the transfer of raw materials, for example by retrieving all transactions which register raw material in the distributed ledger (create transactions) and determining the transactions 1108b, 1110b associated with the transfer of said registered raw materials (transfer transactions) by searching for all transactions referencing the IDs of said create transactions (to ensure that the transferred amount is used in the mass balance calculation). By summing the amount listed in each of the determined transfer transaction, the total input amount 1120 can be determined. The total amount of product(s) containing said raw materials can be obtained by searching for transactions where the public key of the recipient is corresponding to the public key assigned to landfill(s). By summing the amount listed in each of the determined transactions 1114b, 1116b, the total output amount 1122 can be determined.

In one example, the mass balance can be calculated by an application having access to the decentralized network, such as an application described in relation to FIG. 3. The determined mass balance may be displayed within a graphical user interface and any deviations may be highlighted to increase user comfort.

The mass balance of the linear system is closed if the total input amount 1120 equals the total output amount 1122, i.e. if every mass flow is accounted for at all times. The mass balance may not be closed, for example, at the start of committing the transactions to the distributed ledger because already produced product(s) containing the materials may still be in the possession of consumers and may not yet have been disposed, thus the total input amount may be larger than the total output amount.

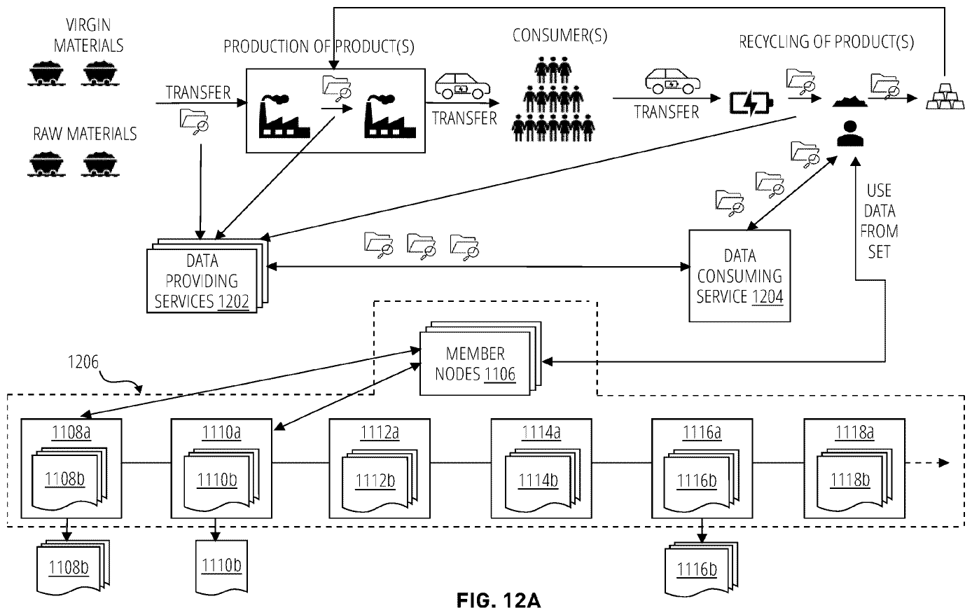

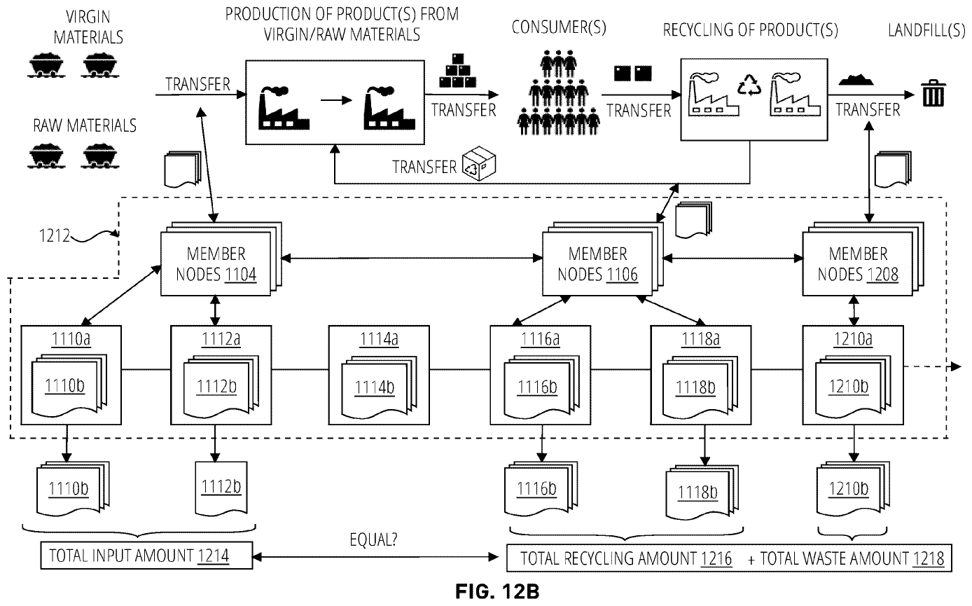

FIG. 12A is a block diagram illustrating determination of the transfer balance for product(s) recycled within a circular system comprising several parties involved in supplying raw materials and virgin materials, producing product(s) containing said raw materials/virgin materials and recycling at least part of the produced products after the products have been transferred from consumer(s) to the recycling process. The recycled material is then reintroduced into the production process. In this example, the produced product is an electric car and recycling includes recycling of the batteries contained in said electric car to obtain black mass material which may then be used to extract metals (last step) which can be reintroduced into the battery production process.

In this example, the production of product(s) from the raw materials includes several parties. In another example, the production of product(s) from the raw materials only includes one party, for example if the product(s) can be obtained from the raw materials in a single step without the need to perform any further production/purification steps.

In this example, all raw material(s) and virgin materials transferred into the circular distributed system are registered by member nodes (not shown) via transactions 1108b and 1110b in blocks 1108a and 1110a of the decentralized network 1206. The batteries removed from the cars are registered by member nodes (not shown) via transactions 1116b in block 1216a of the decentralized network 1206.

To determine the transfer balance, in particular the mass balance, associated with the batteries removed from electric cars and used to produce the black mass material, the total amount of virgin materials and/or raw materials use to produce the batteries has to be compared with the total amount of batteries used to produce the black mass.

The total amount of raw materials and virgin materials can be obtained by retrieving the data sets associated with the raw materials and virgin materials as well as of each further production stage of the battery from various data providing services 1202 via a data consuming service 1204 associated with a recycler, such as a company producing black mass from batteries. The recycler may obtain the respective data sets by recursive requests using the hashes contained in the data set of the end product, such as the car(s) containing the batteries (see FIGS. 7A to 7B). The hashes may allow to identify the respective data sets and to retrieve said data sets via the data consuming service 1204. Retrieval of said data sets moreover allows the recycler to access detailed data on the battery and the contained materials, thus allowing improved recycling. The data set associated with the transfer of the battery to the recycler contains a transaction ID associated with the transfer of the battery from a dismantler to the recycler (e.g. transaction 1116b). This transaction ID can be used to retrieve the transaction IDs associated with all previous transactions chained directly or indirectly to said transaction ID (see FIG. 10B) via member node 1106 of distributed ledger 1206 (e.g. transactions 11108b, 1110b). Thus, the transaction ID contained in the data set associated with the received battery allows to identify all transactions associated with the virgin and raw materials as well as all intermediate products used to produce the respective battery.

The mass balance for said particular battery is closed if the total input amount contained in transactions (1108b, 1110b) equals the total amount contained in transaction 1116b. Monitoring the mass balance within a circular system allows to prevent that waste material is deposited illegally because illegal disposal of waste material would result in an invalid mass balance (i.e. the total input amount of batteries received by the recycler does not equal the sum of the input materials used to produce the batteries).

FIG. 12B is a block diagram illustrating determination of the transfer balance of a closed loop circular system comprising several parties involved in supplying raw materials and virgin materials, producing product(s) containing said raw materials/virgin materials and recycling at least part of the produced products after the products have been transferred from consumer(s) to the recycling process. The recycled material is then reintroduced into the production process. In this example, the production of product(s) from the raw materials includes several parties. In another example, the production of product(s) from the raw materials only includes one party, for example if the product(s) can be obtained from the raw materials in a single step without the need to perform any further production/purification steps. In a circular system where recycling is taking place, it can be assumed that only the part(s) of product(s) which cannot be recycled are transferred to landfill(s). Thus, the total mass output of the circular distributed system corresponds to sum of recycled material and non-recycled material (i.e. part(s) of product(s) transferred to landfill(s)).

In this example, all raw material(s) and virgin materials transferred into the circular distributed system are registered by member nodes 1104 via transactions 1110b and 1112b in blocks 1110a and 1112a of the decentralized network 1212. The recycled material is registered by member nodes 1106 via transactions 1116b and 1118b in blocks 1116a and 1118a of the decentralized network 1212. The waste material is registered by member nodes 1208 via transactions 1120b in block 1120a of the decentralized network 1212.

To determine the transfer balance, in particular the mass balance, the total amount of virgin materials and/or raw materials, the amount of recycled material as well as the amount of material transferred to landfill(s) has to be calculated.

The total amount of raw materials and virgin materials can be obtained by determining transaction associated with the transfer of raw materials and virgin materials, for example by retrieving all transactions which register raw material virgin materials in the distributed ledger (create transactions) and determining the transactions 1110b, 1112b associated with the transfer of said registered raw materials and virgin materials (transfer transactions) by searching for all transactions referencing the IDs of said create transactions (to ensure that the transferred amount is used in the mass balance calculation). By summing the amount listed in each of the determined transfer transaction, the total input amount 1230 can be determined.

The total amount of waste can be determined by searching for transactions where the public key of the recipient is corresponding to the public key assigned to landfill(s). By summing the amount listed in each of the determined transactions 1120b, the total waste amount 1218 can be determined.

The total amount of recycled material can be determined, for example, by determining all transactions associated with the transfer of recycled material into the production process. For this purpose, the public key associated with companies performing the last step in the recycling process or the product transaction meta data may be used to search for respective transactions 1116b and 1118b. By summing the amount listed in each of the determined transactions 1116b and 1118b, the total recycling amount 1216 can be determined. The mass balance of the circular system is closed if the total input amount 1214 equals the sum of the total recycling amount 1216 and the total waste amount 1218. The total input amount 1214 and the total recycling amount 1216 may also be used to determine the recycling quota of the circular system, thus allowing to steer the circular system in case a predefined recycling quota is not met, for example by prohibiting introduction of new virgin material into the circular process. For this purpose, the distributed leger server 310 may calculate the recycling quota upon validation of the transaction registering new virgin material and may not validate the transaction (i.e. may reject said transaction) in case the introduction of said amount of virgin material listed in the transaction would reduce the recycling quota below a predefine threshold. Monitoring the mass balance of the circular system allows to prevent that waste material is deposited illegally because illegal disposal of waste material would result in an invalid mass balance (i.e. the total input amount 1214 does not equal the sum of the total recycling amount 1216 and the total waste amount 1218).

FIG. 13A is a block diagram illustrating determination of the transfer balance of a single company of a distributed system. The single company may be part of a linear distributed system, such as the system of FIG. 11 or a circular distributed system, such as the system of FIGS. 12A and 12B. In this example, the company receives raw materials. In another example, the company may receive-apart or instead of raw materials-intermediate products (i.e. material) and/or recycled material.

In this example, all raw material(s) transferred received by the company are registered in transactions 1308b in block of decentralized network 1304. All product(s) containing the raw materials and leaving the company, for example by selling said product(s) to consumer(s) or other companies for further processing, are registered by member node(s) 1306 via transactions 1314b and 1316b in blocks 1314a and 1316a of decentralized network 1304.

To determine the transfer balance, in particular the mass balance, the total amount of raw materials received by the company as well as the total amount of product(s) containing said raw materials and leaving the company has to be calculated and compared.

The total amount of raw materials received by the company can be obtained, for example, by retrieving all transactions 1308b using data of material transfer transactions contained in data sets associated with said raw materials. The data sets may be retrieved by the company via its data consuming service 1302 from the respective data providing services (not shown) of the raw material owners as previously described (see for example FIG. 10D). Each retrieved data set associated with a raw material contains data of material transfer transactions associated with said raw material, such as the transaction ID. The transaction ID can be used to retrieve transactions 1308b containing the amount of all raw materials processed by the company via member node 1306. By summing the amount listed in each of the determined material transfer transaction, the total input amount 1318 can be determined.

The total amount of product(s) containing said raw materials and leaving the company can be obtained, for example, by searching for transactions 1312b, 1314b where a specific public key associated with the warehouse system of the company is listed as recipient. By summing the amount listed in each of the determined transactions 1312b, 1314b, the total output amount 1320 can be determined.

In one example, the mass balance can be calculated by an application having access to the decentralized network, such as an application described in relation to FIG. 3. The determined mass balance may be displayed within a graphical user interface and any deviations may be highlighted to increase user comfort.

The mass balance for the company is closed if the total input amount 1318 equals the total output amount 1320, i.e. if every mass flow is accounted for at all times. The mass balance may be monitored, for example, by auditors to ensure that each company of the distributed system handles its materials flows correctly.

Determining the mass balance for a company, especially in circular and net zero economy, allows to perform bookkeeping of feedstocks that are being attributed to specific product flows leaving the production system. Determining the mass balance according to the inventive method using the data stored in the distributed ledger ensures that attribution of inflows to outflows are tamper evident over the reporting period, i.e. the period where closure of mass balance needs to be certified, because mass flows cannot be arbitrarily consolidated using other information than the one stored in the distributed ledger.

FIG. 13b illustrates an embodiment of a system used to determine the transfer balance of FIG. 13A. In this example, the system is implemented within a company being part of a linear or circular distributed system, for example the linear distributed system of FIG. 11 or the circular distributed system of FIGS. 12A and 12B.

The system comprises an address unit 1322 which assigns addresses, for example public keys of a private-public key pair, to mass storage associated with mass inflow(s) (mass storage in) and to mass storage associated with mass outflow(s) (mass storage out) (see step 1). The address(es) of the mass storage in may be used for all transactions associated with received material, i.e. the address(es(of mass storage in is/are used as recipient address for all transactions associated with the receipt of material by said company. Likewise, the address(es) of the mass storage out may be used for all transactions associated with product(s) produced from the received material(s), i.e. all product(s) containing said material. Mass balancing can be performed as described later on by comparing the total amount contained in all transactions associated with the mass inflow address(es) with the total amount contained in all transactions associated with the mass outflow address(es).

The system further comprises an ID reader 1326 configured to read IDs, such as physical identifiers of raw materials and product(s) produced from said raw materials (i.e. product(s) containing said raw materials. The physical identifier may be attached to the raw materials and the product(s) via a physical identifier element as described previously. The ID reader may provide the determined ID to a database (not shown) which may be accessible by the ERP system.

The system further comprises an ERP system 1328 (enterprise resource planning system). In this example, the ERP system 1328 generates transactions 1340 with ERP transaction IDs (see step 2). An ERP transaction 1340 has a product identifier as primary key, records a mass flow output and contains a metadata set. Said metadata set contains, for example the production recipe, in the form
amount and composition of mass input in mass percent
amount and composition of mass output in mass percent
production unit ID as reference

In this example, the system further comprises an environmental footprint calculation unit 1330. This unit 1330 receives the ERP transaction(s) 1340 from the ERP system 1328 (see step 3A in FIG. 13B) and calculates the environmental footprint associated with the product(s) containing the material(s) based on the data contained in the received ERP transaction 1340. Calculation of environmental footprint based on the data contained in the received ERP transaction 1340 may be performed, for example, based on the energy consumption and/or the product yield. In this example, said unit 1330 also receives transaction data, such as emission data, recyclate content, bio-based content, of material transaction(s) associated with the mass input (i.e. the raw materials used to produce the product) and performs calculation of the environmental footprint based on the data contained in the ERP transaction 1340 as well as the received transaction data. The calculated environmental footprint is correlated with the product identifier contained in the ERP transaction 1340 by using said product identifier as primary key 1342 (step 3B in FIG. 13B). To consider co-production of multiple products, secondary keys can be used within the calculated product data to associate each calculated product meta data with the respectively produced product. Use of said unit 1330 allows to automatically calculate the environmental footprint of the produced products which can then be stored and provided to customers of the company upon request without any additional effort.

The system further comprises a component mass flow unit 1332. Said unit 1332 receives the ERP transaction 1340 (see step 3C of FIG. 13B) and generates a list of component mass amounts 1344 by multiplying the composition vector with the mass output flow (see step 3D of FIG. 13B). The list 1344 may be generated from the mass input amount and composition of mass input in mass percent as well as the mass output amount and composition of mass output in mass percent contained in the received ERP transaction 1340. The list 1344 generated by this unit 1332 is used as input for the transaction data prepared by the data integration unit 1334 described in the following.

The data integration unit 1334 generates transaction input 1346 by retrieving and merging the following data into one data set (i.e. transaction input 1346) using the product identifier (i.e. the primary key):
ERP transaction ID from the ERP transaction 1340,
list of component mass input & output amounts 1344,
environmental footprint data 1342,
cryptographic addresses of mass storage in and mass storage out 1324 (steps 4 and 5 of FIG. 13b),
transaction type (i.e. transfer transaction or create transaction), and
optionally transaction ID of previous transaction.

The transaction input 1346 may vary depending on the production step used to produce the product(s) containing the material from said material. For example, the amount of produced product may be assigned to at least two different mass storage out addresses such that the total mass output amount for said product is split between the at least two different mass storage out addresses. In this case, unit 1334 assigns numerical values (i.e. list of split mass output amounts) to the respective mass storage out addresses. The numerical values may be obtained, for example, from the ERP transaction data 1340. For chemical reactions involving multiple reaction products, each reaction product may be assigned to a specific mass storage out address as previously described. In addition, unit 1334 may add a list of mass component fractions associated with each mass output address as transaction meta data to the transaction input 1346 to allow calculation of component-wise stock taking using the data stored in the distributed ledger.

The data integration unit 1334 may act as client 302 described in relation to FIG. 3 and may use an application 306 and a driver 308 to generate a signed transaction as described in relation to FIG. 3.

The transaction input 1346 generated by unit 1334 is received by the member node 1336 of a distributed ledger of a decentralized network. The received signed transaction is then validated by the distributed ledger server 310 and committed within a block to the distributed ledger after consensus is successfully performed, for example as described in relation to FIG. 3 above (see step 7 of FIG. 9B). The member node 1336 may provide a respective notification to unit 1334 indicating commitment of the transaction as described in relation to FIG. 3 above. The notification may include transaction data, such as the transaction ID, the public keys of the involved parties, the transaction meta data, or a combination thereof.

Apart from generating the transaction input 1346, the data integration unit 1334 may also take stock of the mass storage addresses 1324 by storing a sum of transaction inputs associated with the mass storage in and the mass storage out to allow determination of the mass balance using said unit 1334 as described in the following.

Prerequisite for balancing the storage accounts is the fact that ERP transactions and blockchain transactions are consistent. Consistency can be guaranteed by data integration unit 1334 by ensuring that the logical sequence of ERP transactions is the same as the sequence of transactions committed to the distributed ledger via member node 1336. For this purpose, unit 1334 may queue received ERP transactions 1340 until previously generated transaction input sent to member node 1336 was committed to the distributed ledger.

Once consistency is established for each storage address, the sum of transactions is balanced out by the data integration unit 1334. The result is the net stock in each storage address at the given time stamp:
mass inflows are represented by transactions committing a certain amount of material to the mass storage in address(es), and
mass outflows are represented by transactions committing a certain amount of product(s) containing the material to the mass storage out address(es).

In addition, component-wise stock taking can be executed by
retrieving a list of blockchain transactions associated with a specific mass storage out address and
sum over list of component mass output amounts 1344 generated by component mass flow unit 1332.

The determined mass balance may be stored in the data integration unit 1334 as data record associated with the respective mass storage address and corresponding mass storage name (for example as key value pair or document). For ongoing operation, a list of time stamps is created that represent the batch intervals of the production step as a uniform time grid However, if stock taking is required for a given mass storage address, said time stamps have to be placed manually in such a way that all production batches associated with this mass storage out address are completed in ERP at this timestamp (coinciding batch ends) or all stock keeping operations have to happen on a fixed (typically uniform) time grid. In the latter case, the uniform time grid represents de facto batch interval length which means that batch interval has to be the same for all production units. Yet, in general, batch sizes are not uniform across multiple production units and products in a company. Therefore, the Time Grid interval can be adjusted to greatest common divisor of all batch lengths occurring in the production system of said company.

Data integration unit 1334 is further connected to ID provider 1338. ID provider 1338 is configured to provide a decentral identifier, such as a DID, as previously described upon request of the data integration unit 1334 (see step 7 of FIG. 13B). The provided ID is used by data integration unit 1334 to generate-using the product identifier as primary key-a data set containing the transaction data received from member node 1336 as well as further product property data contained in the ERP transaction 1340 and/or calculated by the environmental footprint calculation unit 1330 and/or retrieved from a further database (not shown) connected to unit 1334 (see step 8 of FIG. 13B).

The system illustrated in FIG. 13B allows to perform mass balancing for a company by storing information on material flows, flows associated with product(s) containing the material(s) as well as stocks in a tamper evident way in the distributed ledger, thus allowing to keep track of material(s) and associated product(s) even if the products are not produced in real time continuous flows but often in campaigns where material that has been put into stock for some time is channeled towards such a production campaign.

Moreover, the system illustrated in FIG. 13B allows to generate a data set associated with a product produced from specific raw materials including transaction data, such as the transaction ID, and environmental footprint data.

Because of the mass balance paradigm, chemical products with identical chemical, physical, and mechanical properties can have very different history, provenance, and product environmental footprint. Therefore, the same material identifier has to matched to several different material data sets describing material sustainability factors and the same product identifier has to matched to several different product data sets describing product sustainability factors. This is achieved with the system described in relation to FIG. 13B by using the material identifier or product identifier within the transaction meta data in combination with the classification or production data mentioned previously. The material or product identifier points to the respective material data set or product data set and the further data allows to retrieve the material property data or product property data associated with the material or the produced product containing the material from said material data set or product data set, respectively.

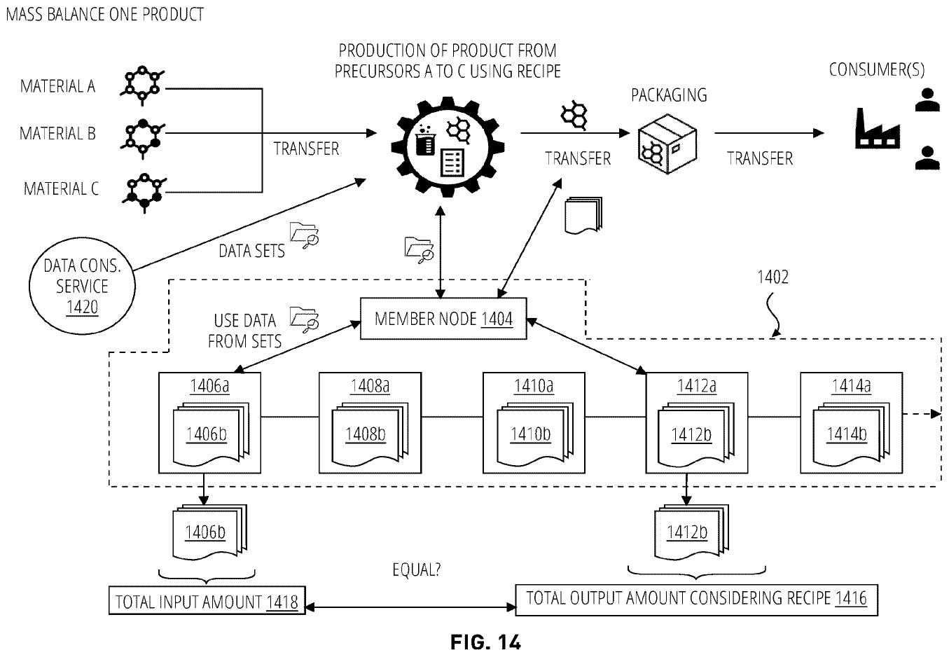

FIG. 14 is a block diagram illustrating determination of the transfer balance for a specific product produced from different raw materials using a defined stoichiometry. In this example, 3 different chemical compounds (materials A to C) are used to produce a specific chemical product using a defined production recipe. The produced product is then packaged and sold to consumer(s), such as end consumers or other upstream companies for further processing. In another example, more or less different chemical compounds may be used. In yet another example, the product may be produced by assembling different parts, for example if said product is part of an automotive, such as a battery or the like.

In this example, all material(s) transferred into the production process are registered by member node 1404 via transactions 1406b in block 1406a of the decentralized network 1402. All product(s) produced from said materials and being transferred to packaging or transport are registered by member node 1404 via transactions 1412b in block 1412a of the decentralized network 1402.

To determine the transfer balance, in particular the mass balance, the total amount of materials as well as the total amount of product(s) containing said materials has to be calculated and compared considering the stoichiometry which can be retrieved, for example, from the ERP transaction data 1340.

In one example, the total amount of materials can be obtained by determining transactions associated with the transfer of materials into the production process, for example by retrieving all transactions 1406b from the data integration unit 1334 which are associated with materials A to C. The transactions 1406b may be retrieved from the distributed ledger via member node 1404 using the transaction IDs contained in the data sets associated with materials A to C received via data consuming service 1420. By summing the amount listed in each of the retrieved transactions, the total input amount 1416 can be determined. In another example, the total amount of materials A to C can be calculated using the list 1344 generated by component mass flow unit 1332.

The total amount of product(s) containing materials A to C can be obtained by searching for a specific mass storage out address as described in relation to FIG. 13B. By summing the amount listed in each of the determined transactions 1412b, the total output amount 1418 can be determined.

In one example, the mass balance can be calculated by an application having access to the decentralized network, such as an application described in relation to FIG. 3. The determined mass balance may be displayed within a graphical user interface and any deviations may be highlighted to increase user comfort.

The mass balance for the product is closed if the total input amount 1416 equals the total output amount 1418 considering the stoichiometry, i.e. if every mass flow is accounted for at all times.

The stoichiometry can be retrieved, for example, from the ERP transaction data 1340.

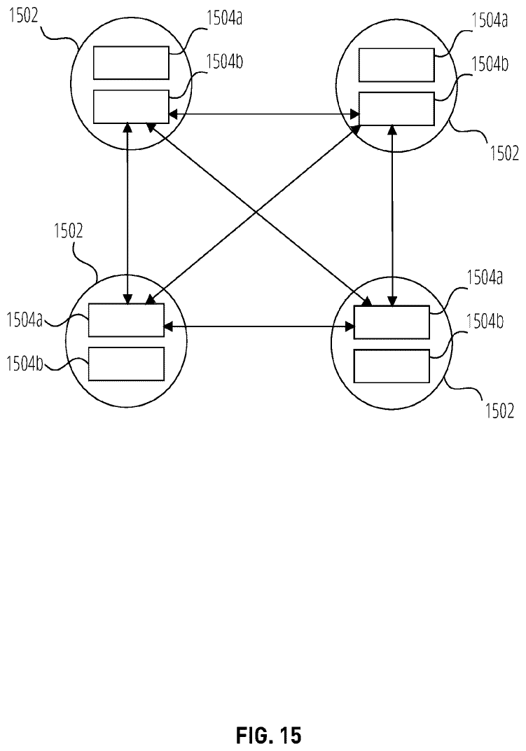

As explained in detail above, the method and apparatus of the present disclosure may make use of a distributed ledger. An exemplary distributed ledger 1500 is shown in FIG. 15.

A distributed ledger 1500 is a shared, replicated, and synchronized database among member nodes 1502 of a decentralized network, such as a P2P network. A distributed ledger application performs computing steps associated with the distributed ledger. In general, a distributed ledger may record transactions between participants of the network and may, thus, provide an immutable history of transactions. Updates of the distributed ledger are performed based on consensus algorithm. When an update occurs, all nodes update themselves with the proper updated copy of the ledger. Blockchain applications are a specific example of a distributed ledger application. The nature of the distributed ledger is that there is no centralized authority, e.g., a clearing house.

A distributed ledger, more specifically, the transactions thereof, may represent material flows in a material network like a supply chain, e.g., introducing of material into a material network or transfer of material within the material network. In that case, the distributed ledger may allow for searching transactions, which in turn may enable lookup across multiple intermediate steps in the material network, e.g., the supply chain, which may ensure traceability of material flow and accountability of each material owner and recipient.

In FIG. 15, as a specific example, each node is shown as having a database layer 1504a, also referred to as Database API, and a distributed ledger control layer 1504b, which includes the distributed consensus algorithm and serves as a distributed ledger anchoring, e.g., blockchain anchoring. Providing separate layers may be advantageous, as database functions are geared at high throughput, e.g., for data loading and retrieval, access and querying, whereas distributed ledger functions usually provide lower throughput, yet ensure data immutability, tamper resistance, evidence, decentralized consensus over state, and replication of state across diverse nodes. However, a separation into separate layers is optional.

A distributed ledger as illustrated in FIG. 15, may be configured such that the database access and query commands on each node are implemented as part of the database layer and only few essential database commands may be implemented by the control layer.

As an example, when it comes to material flow being represented by the distributed ledger, the control layer may implement a CREATE transaction and a TRANSFER transaction, the CREATE transaction representative of feeding or introducing material into a material network and a transfer transaction representative of material being transferred within the material network from a material owner to a material recipient.

The CREATE transaction may, for example, write an asset object to the ledger and add a pointer to corresponding metadata and the TRANSFER transaction may, for example, implement “append-only” write operations to the ledger that have to reference one or more input transactions (CREATE or TRANSFER) and one or more outputs (destination addresses).

Accordingly, with only two transaction types, even distributed tracking and documenting of material flow in the material network and, particularly, mass balancing of the material, may be performed in distributed consensus.

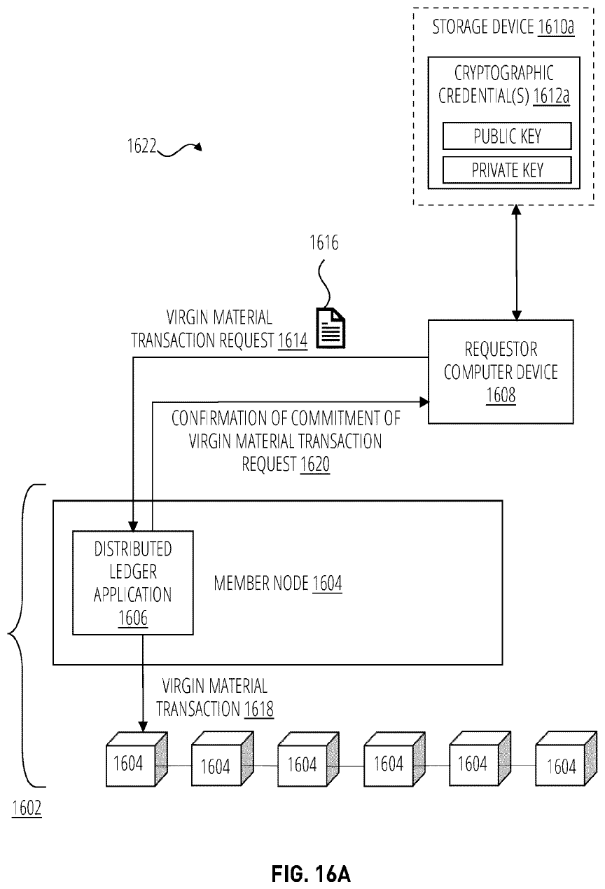

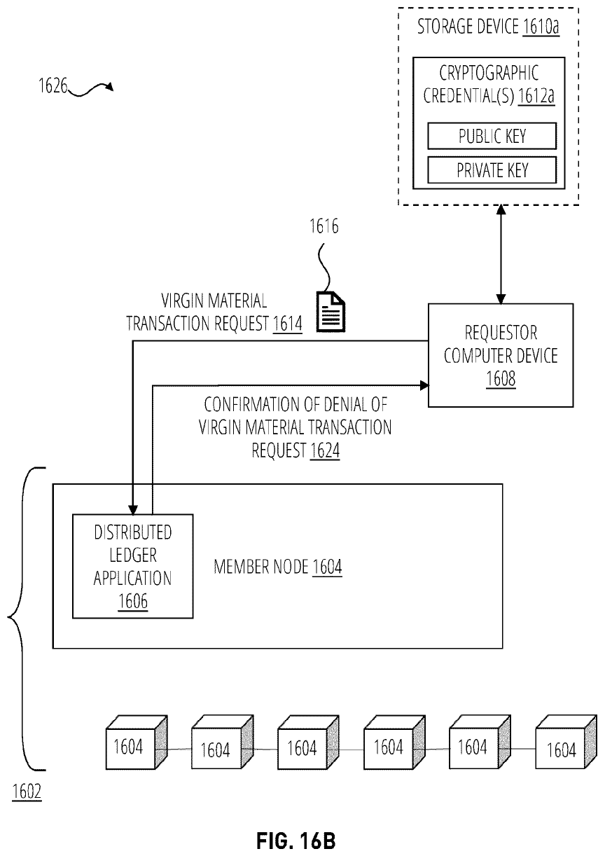

FIGS. 16A and 16B show block diagrams illustrating the method for controlling the feed of virgin material by a virgin material owner to a circular process in a decentral network comprising a distributed ledger 1602 that includes multiple member nodes 1604 and a distributed ledger application 1606 according to the present disclosure. Only one of the member nodes is shown in detail for the sake of simplicity.

The member node is in communication with a requestor computer device 1608, also referred to in short as requestor, e.g., via a data connection.

The requestor computer device may optionally be in communicative communication, e.g., via another data connection, with a storage device 1610a on which cryptographic credential(s) 1612a of the virgin material owner are stored. The requestor device may be configured to retrieve, from the storage device, the cryptographic credential(s) of the virgin material owner. The requestor computer device is configured to transmit a virgin material transaction request 1614 to the member node, specifically, to the distributed ledger application. The virgin material transaction request contains virgin material data associated with the virgin material, said data including at least the amount of virgin material being fed to the circular process, and optionally the cryptographic credential(s) 1612a of the virgin material owner.

The distributed ledger application is configured to receive the virgin material transaction request from the requestor computer device and to determine whether introduction of the amount of virgin material contained in the virgin material transaction request fulfills a predefined recycling quota range. Moreover, optionally the distributed ledger application may be configured to validate the cryptographic credential(s) contained in the virgin material transaction request.

FIG. 16A illustrates the scenario where the virgin material transaction is committed to and, optionally, stored in the distributed ledger. This is only the case if it is determined that the predefined recycling quota range is fulfilled and optionally, only if the cryptographic credential(s) are determined to be valid. Moreover, the member node, specifically the distributed ledger application, transmits a confirmation 1620 of commitment of the virgin transaction request as a virgin material transaction to the requestor computer device. In addition, in the same or a different step, success of storage of the virgin material transaction in the distributed ledger may also be transmitted to the requestor computer device.

FIG. 16B illustrates the same system as FIG. 16A. In FIG. 16B the scenario where commitment of the virgin material transaction request to the distributed ledger is denied. That is, the request is not committed to nor stored as a transaction in the distributed ledger. This is the case when it is determined that either the predefined recycling quota range is not fulfilled and/or if the (optionally performed) validation of the cryptographic credential(s) failed or both. Moreover, if this is the case, a denial 1622 of commitment of the virgin material transaction request as virgin material transaction is transmitted to the requestor computer device by the member node, specifically the distributed ledger application. The decentral network is designated with reference sign 1622 in FIGS. 16A and 16B.

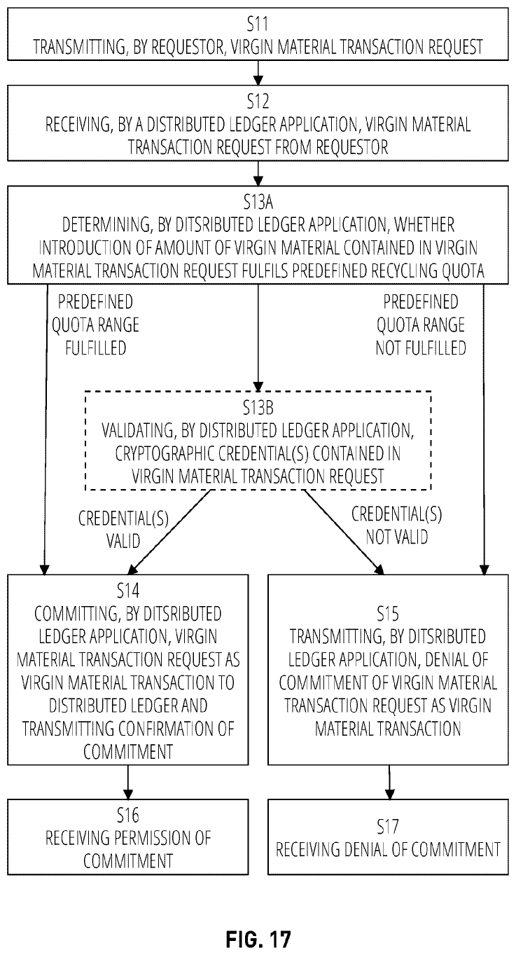

FIG. 17 is a flow chart illustrating the computer-implemented method of the present application. The method may be applied in a system as illustrated in FIGS. 16A and 16B.

In step S11, a virgin material transaction request is transmitted, by a requestor, to a distributed ledged application. The virgin material transaction request comprises virgin material data associated with the virgin material, said data including at least the amount of virgin material. It may also comprise cryptographic credential(s) of the virgin material owner.

In step S12, the virgin material transaction request is received by the distributed ledger application from the requestor.

In step S13A, the distributed ledger application determines whether introduction of the amount of virgin material contained in the virgin material transaction request fulfills a predefined recycling quota range.

In step S13B, the distributed ledger application validates the cryptographic credentials contained in the virgin material transaction request.

If the predefined recycling quota range is fulfilled and optionally, if the cryptographic credential(s) is/are valid, in step S14, the virgin material transaction request is committed as a virgin material transaction to the distributed ledger and confirmation of commitment of said virgin material transaction request is transmitted by the distributed ledger application.

If the predefined recycling quota range is not fulfilled and/or the optional validation of the cryptographic credential(s) failed, in step S15, a denial of commitment of the virgin material transaction request as a virgin material transaction is transmitted by the distributed ledger application.

In step S16, confirmation of commitment of the virgin material transaction request is received, for example by the requestor.

In step S17, denial of commitment of the virgin material transaction request is received, for example by the requestor.

Thus, a transaction is only stored in the distributed ledged if certain requirements are fulfilled, that is if the recycling quota is adhered to and optionally if the requestor is eligible to introduce virgin material into the process. Additional requirements may have to be met for confirming commitment, e.g., requirements concerning the origin of the material or material properties. According to the present disclosure, material transactions may comprise different types of transactions. For example, a material transfer transaction may be a create transaction. A create transaction may be a type of transaction that represent the introduction of a, e.g., raw or virgin, material into a production process. Thus, the virgin material transaction is an example of a create transaction. By means of the method of the present disclosure, limitations may be implemented as to which participant is a material owner eligible for a create transaction. Thus, it is possible to closely control any points of entry into the production process. For example, there may be whitelists or blacklists of parties eligible to have create transactions committed to the distributed ledger. It is noted that a create transaction will not have a preceding transaction within the chain of transactions. Accordingly, some checks, for example of mass balances or the like, that may be applied within the chain of transactions cannot be applied for a create transactions, which makes it all the more important to allow create transactions only for trustworthy parties.

Another type of transaction may be an in-process transfer transaction, which may be any transaction that does not introduce or dispose of material. These transactions will have preceding transactions. This may, for example, allow for performing mass balancing and ensuring that material does not simply appear or disappear.

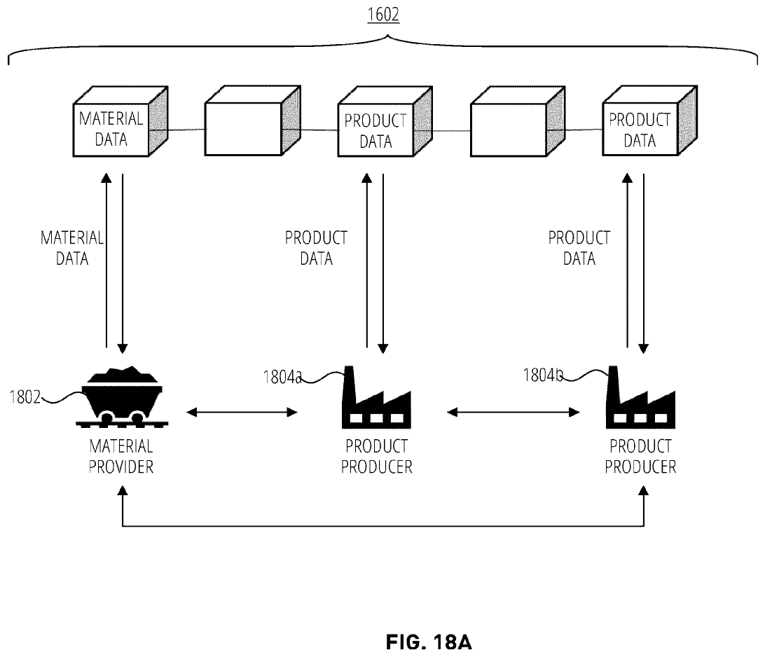

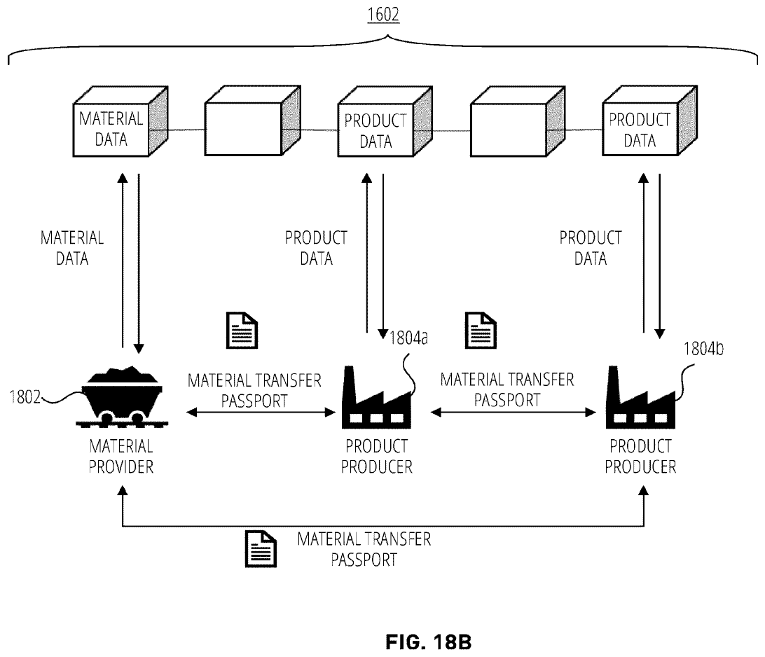

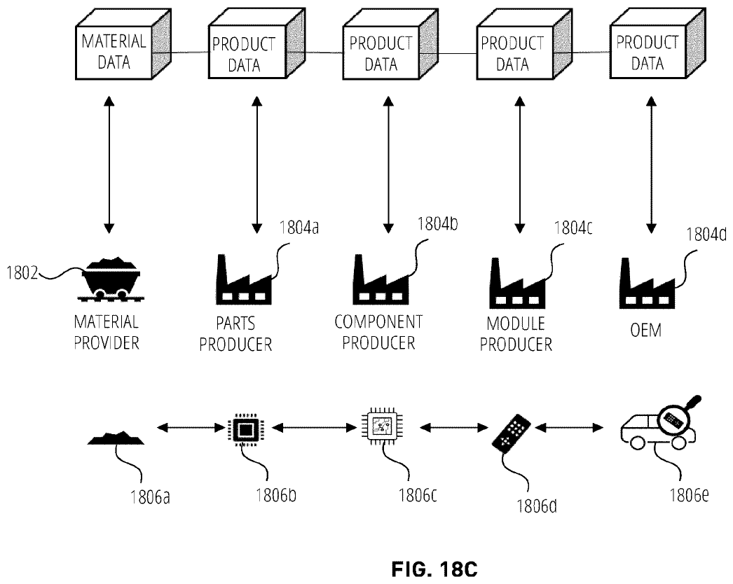

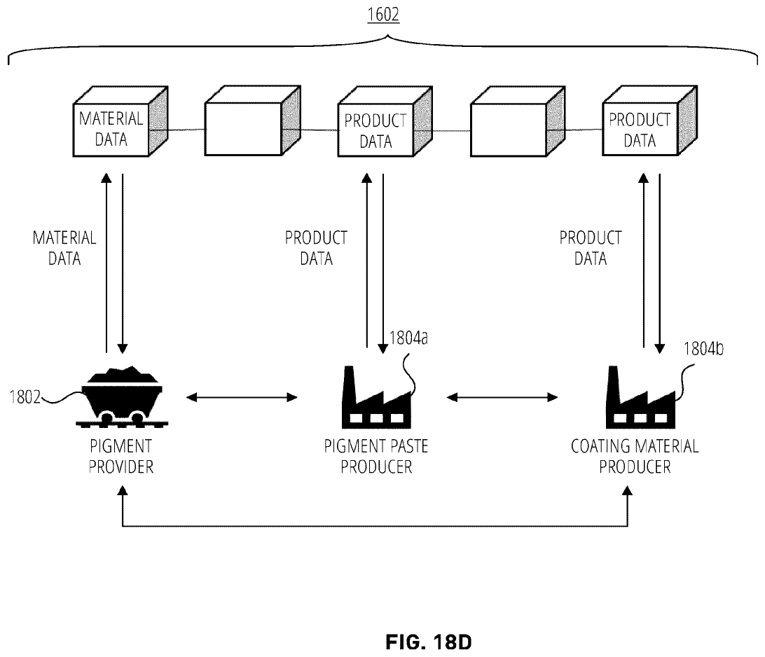

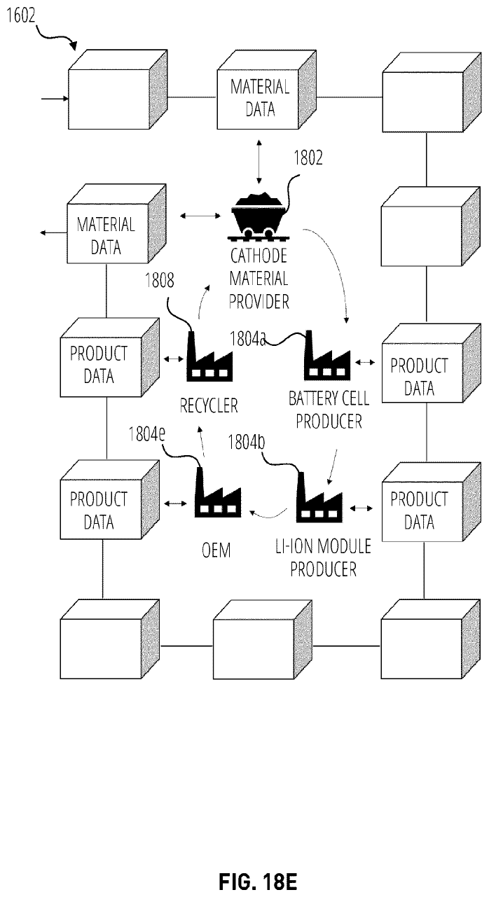

FIGS. 18A to 18E, different examples illustrating potential applications of the method of the present disclosure in a material network, e.g., a supply chain, are shown.

The participants in the examples may comprise one or more of a material providers 1802, one or more product producers 1804a, 1804b, for example a parts producer 1804a, a component producer 1804b, a module producer 1804c, or an original equipment manufacturer, OEM, 1804d, and one or more recyclers 1808.

FIG. 18A illustrates, in general, an information flow, e.g. of data labelled “material data” and data labelled “product data”, the product data being a specific type of material data relating to products which comprise the material, e.g., in processed or unprocessed form. Specifically, the material provider may provide material data to the distributed ledger and each product producer may provide product data to a distributed ledger 1602. Additionally, information may be retrieved, by each of the participants, from the distributed ledger and/or information may be exchanged between different participants.

FIG. 18B is similar to FIG. 18A and shows the specific case where information exchanged between participants may comprise transfer of a material data set.

FIG. 18C is also similar to FIG. 18A. In this specific case, the participants comprise a material provider, a parts producer, and a component producer, a module producer, and an OEM. The material flow of the material 1806a, part 1806b, component, 1806c, module 1806d, and original equipment 1806e are also illustrated in FIG. 18C. It is to be understood that at least a portion of the material 1806a is found in the part, component, module, and original equipment.

In the example shown in FIG. 18D, for example, the participants include a material provider, specifically a pigment provider, and two product producers, i.e., a pigment past producer and a coating material producer.

In the example shown in FIG. 18E, for example, the participants comprise a material provider, specifically a cathode material provider, two product producers, specifically a battery cell producer and a Li-Ion module producer, an OEM, and a recycler.

Although in FIGS. 18A to 18E each participant is shown as being able to perform a two-way exchange of data with the distributed ledger and the other participant, it is to be understood that this may not necessarily be the case. For example, data exchange may not be implemented for all possible data exchange routes or, by means of access control or the like, data exchange routes may be selectively closed for some participants.

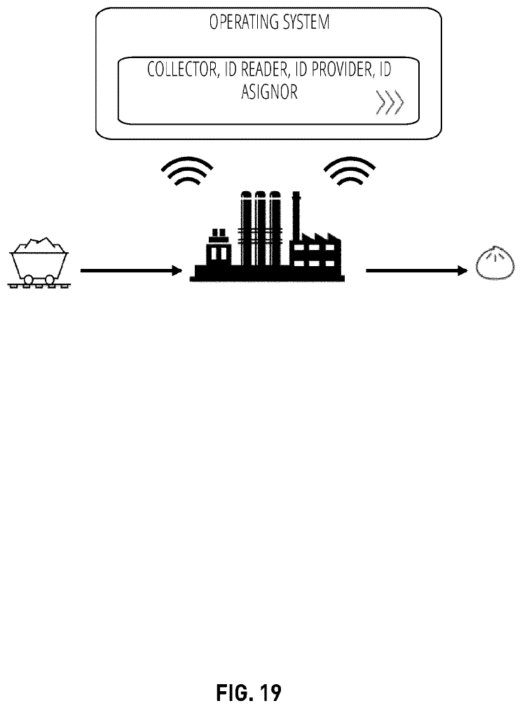

FIG. 19 illustrates one example of a production facility producing a chemical product associated with a material data set.

The production facility illustrated in FIG. 19 may manufacture the chemical product. The production facility may manufacture, e.g., an organic chemical product obtained by reacting organic chemical reactants. The production facility may include one or more production plants. For example, the production facility for manufacturing the chemical product may include at least one precursor/intermediate product production plant. The physical inputs to the production facility may include materials, such raw materials, intermediate materials or components to be assembled. Raw materials may be virgin or recycled raw materials.

The physical inputs may be associated with the decentral identifier as described above. The physical input(s) may be registered with the production facility. The registration may include providing the decentral identifier associated with the physical inputs. Providing the decentral identifier may include reading the physical identifier element physically connected to the physical input as described above. Providing the decentral identifier may include accessing a data base with decentral identifiers and fetching the decentral identifier associated with the physical input.

Based on the provided decentral identifier, chemical product data associated with such decentral identifier may be accessed. Access may be granted through authentication and authorization based on authentication and authorization information associated with the decentral identifier. Based on the decentral identifier, chemical product data such as chemical product declaration data, chemical product safety data, certificate of analysis data, emission data, product carbon footprint data, product environmental footprint data, chemical product specification data, product information, technical application data, production data, performance data, quality data, material configuration data, recyclate content data or combinations thereof may be accessed. Chemical product data may be accessed through a data service requesting access to the chemical product data associated with each decentral identifier and controlled by a physical input data owner. Data owner may be the producer of the physical inputs. The data service may include computer executable instructions operating in an at least partially decentral computing environment. Such computer executable instructions may be based on a Json Web Token (JWT) including authentication information, authorization information and/or a digital representation pointing to chemical product data or parts thereof. The digital representation may include an endpoint for data exchange or sharing (resource endpoint) or an endpoint for service interaction (service endpoint), that may be uniquely identified via a communication protocol. The digital representation(s) pointing to chemical product data or parts thereof may be uniquely associated with the decentral identifier. Chemical product data may be used for the manufacturing process of the production facility.

The production facility may produce the physical output based on one or more physical input(s).

The physical output of the production facility may be associated with a physical identifier. The physical output of the production facility may be physically connected to a physical identifier element as described above. The physical identifier may be assigned to identifier information associated with the decentral identifier. For such assignment, the physical identifier element may be read or a data base with physical identifiers may be accessed. A request to provide a decentral identifier may be triggered to assign the physical identifier to the decentral identifier.

This way, the decentral identifier may be assigned to the physical output. Providing the decentral identifier may include accessing a data base with decentral identifiers and associated information such as authentication information. Providing the decentral identifier may include accessing a decentral service to provide the decentral identifier and associated information such as authentication information. In response to the request, the material data set including the decentral identifier and data related to the chemical product data of the chemical product may be generated. The data related to the chemical product data may include a representation such as a pointer or a link to the chemical product data. The decentral identifier may be associated to data related to the chemical product data of the physical output. The decentral identifier may further be related or assigned or linked to the decentral identifier of the physical input. The material data set may be provided to a decentral network for access by other participants or producers of the network. This way the chain of input to output material may be made traceable and usable in further manufacturing steps without exposing the chemical product data in an uncontrolled manner.

The process steps described above may be executed via an operating system of the production facility. In this embodiment, the operating system includes a collector configured to collect chemical product data and/or physical identifiers as described above. The collector may be configured to collect chemical product data associated with the chemical product or chemical product data associated with the production of the chemical product, wherein the chemical product is connected to or comprises the physical identifier. The operating system may in particular include an ID reader configured to provide the physical identity of physical input(s) or output(s) as described above. The system may further include an assignor configured to assign the decentral identifier and associated information to the physical output as described above. Further the operating system may include an ID provider configured to provide the decentral identifier and associated information as described above.

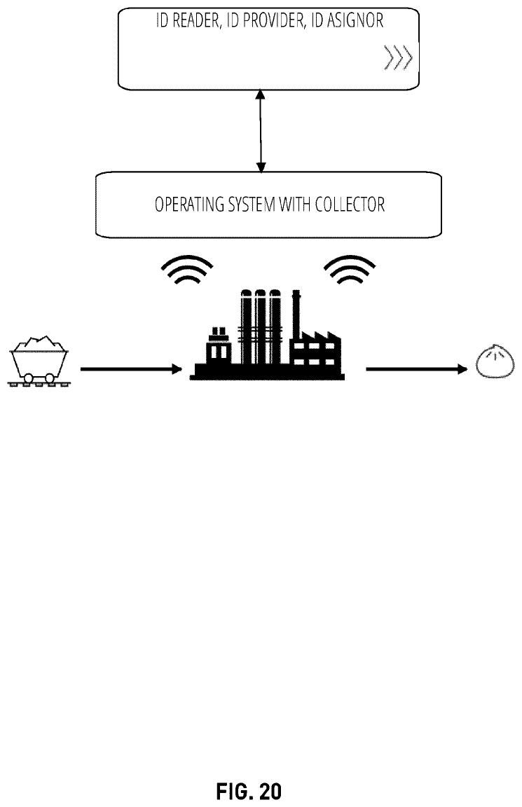

FIG. 20 illustrates another example of a production facility producing a chemical product associated with a material data set.

The process steps described in the context of FIG. 19 may be executed via an operating system of the production facility in interaction with the assignor, the collector or reader or the ID provider. In this embodiment, the operating system may be communicatively connected to the production facility and the assignor, the collector, the ID reader or the ID provider. The operating system may be configured to provide chemical product data from the production facility. The operating system may include a collector configured to provide chemical product data from the production facility. The operating system may include the ID reader configured to read the physical identifier element physically connected to the physical input or output. The assignor may be configured to assign the decentral identifier and associated information to the physical identifier of the physical output as described above in the context of FIG. 19. The ID provider may be configured to provide the decentral identifier and associated information as described above in the context of FIG. 19. The ID reader may be configured to provide the physical identity and associated information of physical input(s) or output(s) as described above in the context of FIG. 19. The assignor, the collector, the ID reader and/or the ID provider may be configured as decentral services or applications executed via the decentral network.

FIGS. 19 and 20 only show two example embodiments and any combination of the system components shown in FIGS. 19 and 20 may be possible. For instance, the ID reader may be configured as part of the operating system, while ID provider and assignor may not be configured as part of the operating system.

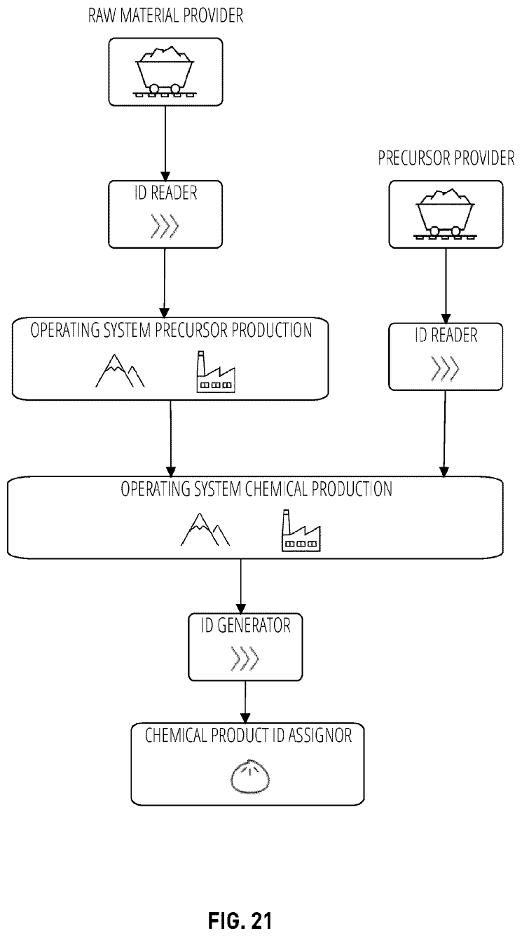

FIG. 21 illustrates an example for tracking material in the production of a chemical product from raw materials to the end product. FIG. 21 specifically illustrates an example for tracking material in the production of a chemical product.

For producing a chemical product raw materials may be provided as physical inputs. The raw materials may comprise precursor materials. The raw materials may include virgin or recycled materials. The raw materials may be associated with a decentral identifier. The decentral identifier may be associated with a digital twin of the raw materials. The decentral identifier may be associated with raw materials data such as a tag for virgin or recyclate material, material properties related to their environmental impact or material properties associated with their origin.

The production of a chemical product may comprise a two-step process: 1) production of precursor material, 2) production of the chemical product. To produce the precursor material, the raw materials may be used as physical inputs. The operating system of the precursor production may access data related to the raw materials based on the decentral identifier e.g. from a raw materials provider. Such data may be used to operate the production. For instance, if the raw materials are recycled materials, production steps purifying the recyclate may be comprised. For instance, if the raw materials are virgin materials, purification steps may be omitted. The precursor material may be formed by co-precipitating the raw materials. Production data from precursor production may be stored and/or associated with a decentral identifier.

In a second step, the precursor material may be provided to produce the chemical product. The precursor material may comprise the precursor produced by the precursor production. The precursor material may comprise recycled precursor material or precursor material produced by a different entity. Such precursor material may be associated with a decentral identifier via which data related to the precursor material may be accessible.

The produced and packaged chemical product may be assigned to a decentral identifier and associated information as lined out above. The packaged electrode active material may, for instance, comprise the physical identifier element, such as a QR-Code, physically attached to the package. Such physical identifier element may be assigned to the decentral identifier. The assignment of physical identifier element and decentral identifier may be executed through an ID generator/assignor running locally, in a decentral system and/or in a distributed system.

For instance, the packaging line may comprise a detector detecting the physical identifier on each package. Based on such recognition the operating system of the chemical product production may request to provide a decentral identifier and the provided decentral identifier may be assigned to the physical identifier. In response to the request, the material data set including the decentral identifier and data related to the chemical product may be generated.

For such generation, data related to the chemical product as recorded prior and/or during production of the chemical product may be gathered or accessed. Such data may be provided by the operating system of the chemical product production, or a storage environment connect to the operating system of the chemical product production. This may include data collected and stored during precursor material production.

The data related to the chemical product may include the identifier of raw materials used to produce the chemical product. The data related to the chemical product may include the data related to the raw material as e.g. accessible via the decentral identifier of the raw materials.

The data related to the chemical product may include data related to the material configuration of the chemical product. The material configuration data may relate to the chemical composition of the chemical product. The material configuration data may specify at least one constituent of the chemical composition of the chemical product.

The data related to the chemical product may include data related to properties related to environmental impact such as CO₂ footprint or recyclate content. For instance, the data related to the chemical product may specify recyclate content for the components or raw materials.

Such recyclate content may either be directly associated with the decentral identifier of the chemical product or it may be indirectly associated with the decentral identifier of the chemical product, e.g. via the decentral identifier of the raw materials or the precursor materials. The data related to the chemical product may include data related to the production conditions as provided by the operating system of the chemical product production. The data related to the chemical product may include data related to the operation conditions as provided by the operating system of the chemical product production. The data related to the chemical product may include data related to the producer, such as producer name, producer brand or producer identifier. The data related to the chemical product may include data related to the product, such as product name, product brand or product identifier.

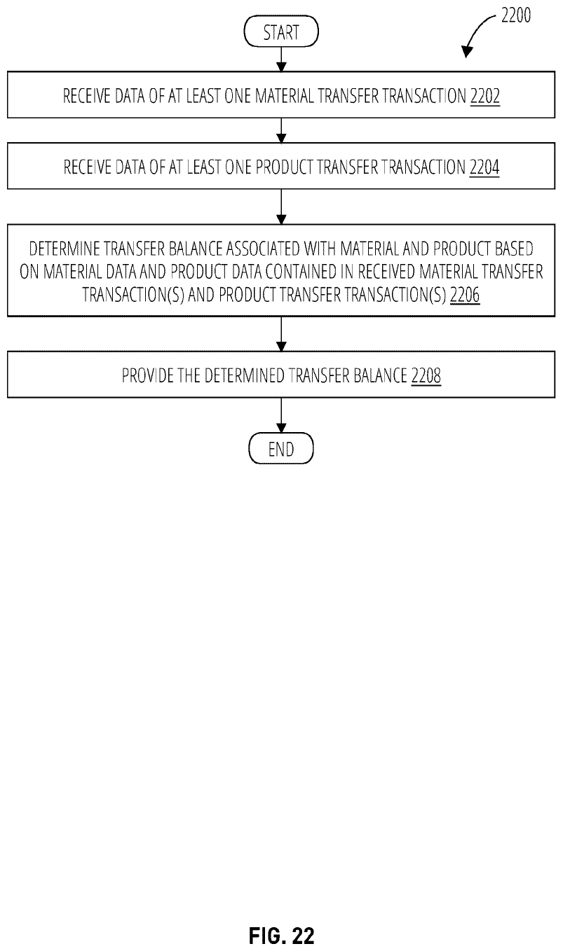

FIG. 22 shows a block diagram illustrating a method 2200 for tracking at least one transfer, in particular for determining a mass balance, of a material and at least one product containing the material in a decentral network comprising a distributed ledger (for example the decentral network of FIG. 2) according to the present disclosure.

In step 2202 of method 2200, data of at least one material transfer transaction is received. Said received data contains material data. In this example, the material data includes the amount of material (either the amount of new material, i.e. material associated for the first time with a transaction committed to the distributed ledger, or the amount of transferred material, i.e. in case the transferred material is associated with a transaction already existing within the distributed ledger) and material transaction meta data, such as a material identifier and/or a material classification and/or material production data. The material identifier may include a digital representation pointing to a material data set as previously described to avoid listing details on the material within a transaction so that every member of the distributed ledger can view said data. The digital representation may be used to retrieve the material data set from a data providing service as previously described. Use of a material data set independently of the information written in the transaction allows to immutably store certain information, like the amount as well as the digital representation pointing to the material data set and thus associating the respective material with said transaction within a distributed ledger while allowing to provide detailed information on the material via a separate channel requiring specific user credentials. This allows to reduce the data contained within each transaction to a minimum, thus reducing the amount of data that needs to be stored within the distributed ledger, and also guarantees the necessary privacy of the sensitive details on the material associated with the respective transaction(s).

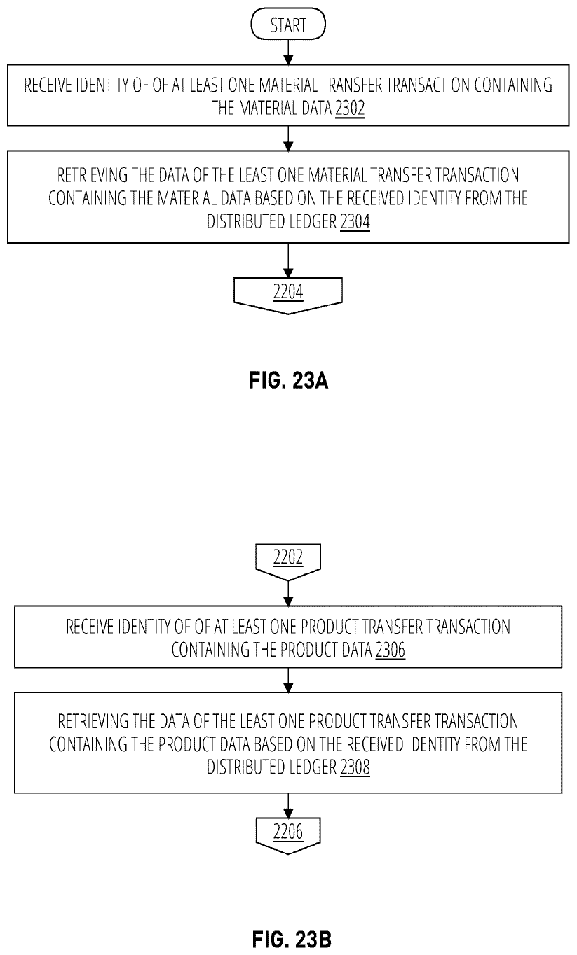

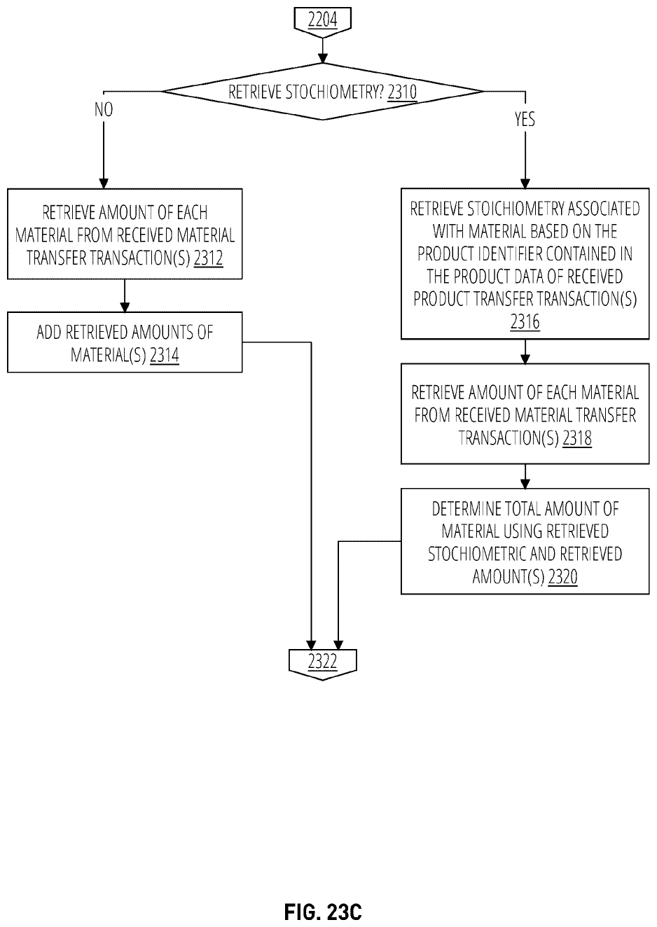

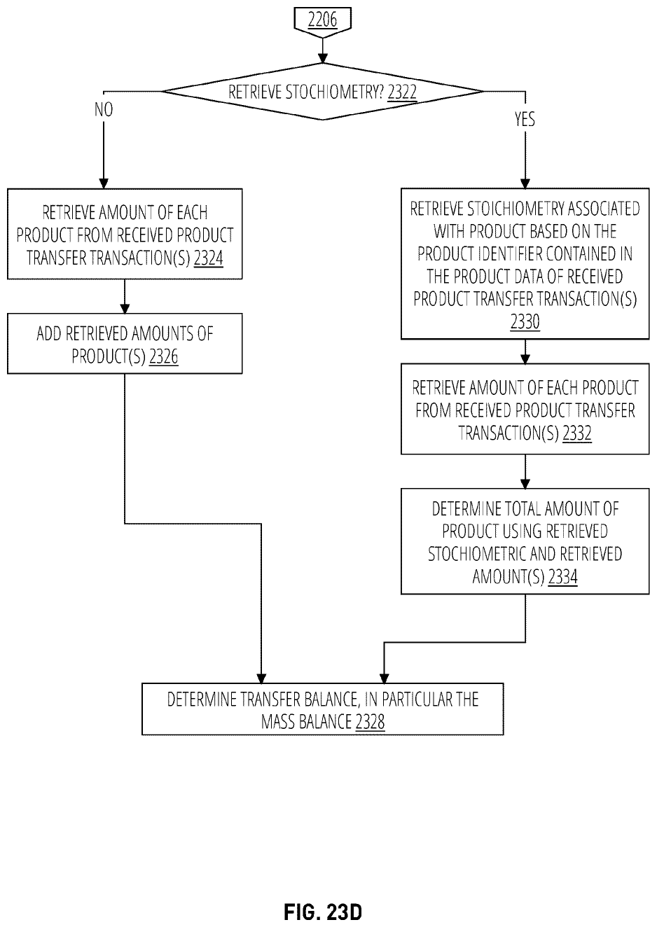

The amount of data received in block 2202 depends on the type of transfer balance, in particular mass balance, that is going to be determined in block 2206. For example, if the overall mass balance of a distributed system is to be determined, the data received in block 2202 corresponds to the total mass in-flow into the distributed system, i.e. the total amount of raw material and/or virgin material. If a mass balance for a single company within a distributed system is to be determined, the data received in block 2202 corresponds to the total mass-in flow into said company. Likewise, if a mass balance for a certain product produced from at least one material is to be determined, the data received in block 2202 corresponds to the total mass-inflow of material used to produce said product. In this example, the data is received in block 2202 as described in relation to FIG. 23A later on.

In block 2204 of method 2200, data of at least one product transfer transaction is received. Said received data contains product data. In this example, the product data includes the amount of product containing the material (either the amount of new product, i.e. product associated for the first time with a transaction committed to the distributed ledger, or the amount of transferred product, i.e. in case the transferred product is associated with a transaction already existing within the distributed ledger) and product transaction meta data, such as a product identifier and/or a product classification and/or product production data. The product identifier may include a digital representation pointing to a product data set as previously described to avoid listing details on the product within a transaction so that every member of the distributed ledger can view said data. The digital representation may be used to retrieve the product data set from a data providing service as previously described. Use of a product data set independently of the information written in the transaction allows to immutably store certain information, like the amount as well as the digital representation pointing to the product data set and thus associating the respective product with said transaction within a distributed ledger while allowing to provide detailed information on the product via a separate channel requiring specific user credentials. This allows to reduce the data contained within each transaction to a minimum, thus reducing the amount of data that needs to be stored within the distributed ledger, and also guarantees the necessary privacy of the sensitive details on the product associated with the respective transaction(s).

The amount of data received in block 2204 depends on the type of transfer balance, in particular mass balance, that is going to be determined in block 2206 as previously described in relation to block 2202. For example, if the overall mass balance of a distributed system is to be determined, the data received in block 2204 corresponds to the total mass out-flow out of the distributed system, i.e. the total amount of product(s) leaving the distributed system. If a mass balance for a single company within a distributed system is to be determined, the data received in block 2202 corresponds to the total mass-in flow out of said company. Likewise, if a mass balance for a certain product produced from at least one material is to be determined, the data received in block 2202 corresponds to the total mass-outflow of said produced product. In this example, the data is received in block 2204 as described in relation to FIG. 23B later on.

In block 2206 of method 2200, the transfer balance associated with the material and the product(s) containing the material is determined based on the data contained in the material transfer transaction(s) and product transfer transaction(s) received in block 2202 and 2204 as previously described. In this example, the transfer balance, in particular the mass balance, is determined as described in relation to FIGS. 23C and 23D later on.

In block 2208 of method 2200, the transfer balance determined in block 2206 is provided, for example via a communication interface. In one example, the transfer balance is determined using application 306 of FIG. 3 and is also provided via said application, for example by displaying the result of the determination performed in block 2206 within a graphical user interface.

FIG. 23A illustrates a block diagram of one embodiment of block 2202 of FIG. 22. In this embodiment, block 2202 comprises 2 sub blocks, i.e. blocks 2302 and 2304. In block 2302, the identity/identities of the respective material transfer transaction(s) is received. In one example, the at least one identity is received from the party which has stored the transaction(s) associated with the material in the distributed ledger and has received said at least one identity upon commitment of the respective transaction(s) to the distributed ledger. In another example, the at least one identity is received by receiving material data set(s) of the material associated with the respective material transfer transactions, the material data set containing the identity of the transaction associated with said material as previously described. In yet another example, the at least one identity is received by receiving material transaction meta data of the material transfer transaction(s) and retrieving the at least one identity associated with said received material transaction meta data from the distributed ledger, in particular from the database layer of the distributed ledger. In yet a further example, the at least one identity is retrieved in block 2302 based on received data of at least one product transfer transaction as described previously in relation to the optional second step.

In this example, the identity of the at least one material transfer transactions include the transaction ID of the at least one material transfer transaction containing the respective material data.

In block 2304, the data of the at least one material transfer transaction is retrieved based on the identity/identities received in block 2302, for example by accessing the database of the respective member node (such as database 204 or 212 or 220 of FIG. 2) using the received identity/identities and retrieving the material data contained in the transactions associated with the received identity/identities. After the end of block 2304, the method proceeds to block 2204 of FIG. 22.

FIG. 23B illustrates a block diagram of one embodiment of block 2204 of FIG. 22. In this embodiment, block 2204 comprises 2 sub blocks, i.e. blocks 2306 and 2308. In block 2306, the identity/identities of the respective product transfer transaction(s) is/are received. In one example, the at least one identity is received from the party which has stored the transaction(s) associated with the product(s) in the distributed ledger and has received said at least one identity upon commitment of the respective transaction(s) to the distributed ledger. In another example, the at least one identity is received by receiving product data set(s) of the product(s) associated with the respective product transfer transactions, the product data set containing the identity of the transaction associated with said product(s) as previously described. In yet another example, the at least one identity is received by receiving product transaction meta data of the product transfer transaction(s) and retrieving the at least one identity associated with said received product transaction meta data from the distributed ledger, in particular from the database layer of the distributed ledger. In yet a further example, the at least one identity is retrieved in block 2306 based on received data of at least one material transfer transaction as described previously in relation to the optional second step.

In this example, the identity of the at least one product transfer transactions include the transaction ID of the at least one product transfer transaction containing the respective product data.

In block 2308 of FIG. 23B, the data of the at least one product transfer transaction is retrieved based on the identity/identities received in block 2306, for example by accessing the database of the respective member node (such as database 204 or 212 or 220 of FIG. 2) using the received identity/identities and retrieving the product data contained in the transactions associated with the received identity/identities. After the end of block 2308, the method proceeds to block 2206 of FIG. 22.

FIGS. 23C and 23D illustrate a flow diagram of one embodiment to determine the transfer balance as described in relation to block 2206 of FIG. 22. For this purpose, the total amount of material is determined as described in FIG. 23C and the total amount of product(s) containing the material is determined as described in FIG. 23D. The determined total amounts are then used to calculate the transfer balance, in particular the mass balance.

In block 2310 of FIG. 23C, it is determined whether to retrieve the stoichiometry. This determination may be made, for example, depending on the type of transfer balance, in particular mass balance, that is going to be determined. For example, if the overall mass balance of the distributed system or the mass balance of one company being part of a distributed system is to be determined, the stoichiometry is not necessary, and the total amount of material is determined as described in blocks 2312 and 2314. However, if the transfer balance for a specific product is to be determined, the stoichiometry is required and needs to be retrieved as described in relation to block 2316 later on. If it is determined in block 2310 that the stoichiometry is not required, the method proceeds to block 2312, otherwise it proceeds to block 2316 described later on.

In block 2312, the amount of each material is retrieved from the material data retrieved in block 2304 of FIG. 23A.

The amounts retrieved in block 2312 are then added in block 2314 to obtain the total amount of material. After block 2314, the method proceeds to block 2206 of FIG. 22.

In block 2316, the stoichiometry associated with the material is retrieved based on the product identifier contained in the product data of the product transfer transaction(s) retrieved in block 2308 of FIG. 23B. For this purpose, the product identifier, in particular the digital representation pointing to the product data set, is retrieved from said product transfer transaction(s) and is used to retrieve product property data, for example via a data providing service as described previously. The product property data contains the respective stoichiometry necessary to determine the total amount of material.

In block 2318, the amount of material is retrieved from each retrieved material transfer transaction as described in relation to block 2312.

In block 2320, the total amount of material is determined using the stoichiometry retrieved in block 2316 and the amount of material retrieved in block 2320. After block 2320, the method proceeds to block 2322 of FIG. 23D.

In block 2322 of FIG. 23D, it is determined whether to retrieve the stoichiometry. This determination may be made, for example, depending on the type of transfer balance, in particular mass balance, that is going to be determined. For example, if the overall mass balance of the distributed system or the mass balance of one company being part of a distributed system is to be determined, the stoichiometry is not necessary, and the total amount of product(s) is determined as described in blocks 2324 and 2326. However, if the transfer balance for a specific product is to be determined, the stoichiometry is required and needs to be retrieved as described in relation to block 2328 later on. If it is determined in block 2322 that the stoichiometry is not required, the method proceeds to block 2324, otherwise it proceeds to block 2328 described later on.

In block 2324, the amount of each product is retrieved from the product data retrieved in block 2308 of FIG. 23B. The amounts retrieved in block 2324 are then added in block 2326 to obtain the total amount of product(s). After block 2326, the method proceeds to block 2334 described later on.

In block 2330, the stoichiometry associated with the product is retrieved based on the product identifier contained in the product data of the product transfer transaction(s) retrieved in block 2308 of FIG. 23B. For this purpose, the product identifier, in particular the digital representation pointing to the product data set, is retrieved from said product transfer transaction(s) and is used to retrieve product property data, for example via a data providing service as described previously. The product property data contains the respective stoichiometry necessary to determine the total amount of material.

In block 2232, the amount of product is retrieved from each retrieved product transfer transaction as described in relation to block 2312.

In block 2334, the total amount of product is determined using the stoichiometry retrieved in block 2330 and the amount of product retrieved in block 2332. After block 2334, the method proceeds to block 2328.

In block 2328, the transfer balance, in particular the mass balance, is determined using the total amount of material determined in block 2314 or 2320 of FIG. 25C as well as the total amount of product(s) containing the material determined in block 2326 or 2334 by comparing the total amount of material to the total amount of product(s). If said amounts are equal, the mass balance is valid, i.e. all material is used to produce the respective product(s). With respect to circular systems, the mass balance allows to detect unaccounted product losses, such as waste which is illegally disposed on landfills because the amount of product(s) is not equal to the amount of material in case of illegally deposited waste.

In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

The present disclosure has been described in conjunction with preferred embodiments and examples as well. However, other variations can be understood and effected by those persons skilled in the art and practicing the claimed invention, from the studies of the drawings, this disclosure and the claims. Notably, in particular, the any steps presented can be performed in any order, i.e. the present invention is not limited to a specific order of these steps. Moreover, it is also not required that the different steps are performed at a certain place or at one node of a distributed system, i.e. each of the steps may be performed at different nodes using different equipment/data processing.

1. A computer-implemented method for tracking at least one transfer associated with a material and at least one product containing said material in a decentral network comprising a distributed ledger that includes multiple member nodes, the distributed ledger including material transfer transactions containing material data associated with the material and product transfer transactions containing product data associated with the at least one product containing the material, the method including the steps of:
receiving at least one data set, each data set including data of at least one material transfer transaction containing the material data and/or data of at least one product transfer transaction containing the product data associated with the product(s) containing the material,
retrieving the material data and the product data based on the received data set(s),
tracking at least one transfer by determining a transfer balance associated with the material and the at least one product based on the received or retrieved material data and the received or retrieved product data, and
providing the at least one tracked transfer.

2. The method of claim 1, wherein the material is a chemical raw material or chemical material.

3. The method of claim 1, wherein the material data includes material transaction meta data and the amount of the material.

4. The method of claim 1, wherein the product data includes product transaction meta data and the amount of the product containing the material.

5. The method of claim 1, wherein each data set includes a decentral identifier, and data related to the material or data related to the product containing the material.

6. The method according to claim 1, wherein each data set is received from a data providing service.

7. The method of claim 1, wherein the material and the at least one product containing the material are transferred in a linear production process or in a circular process.

8. The method according to claim 1, wherein retrieving material data based on the received data set(s) includes determining the identity of at least one material transfer transaction based on the data of the material transfer transaction(s) contained in the received data set(s) and retrieving the material data associated with the determined at least one identity of the material transfer transaction(s).

9. The method according to claim 1, wherein retrieving material data based on the received data set(s) includes determining at least one material transfer transaction associated with the product(s) containing the material based on the data of the product transfer transaction(s) contained in the received data set(s) and retrieving the material data associated with the determined material transfer transaction(s).

10. The method according to claim 1, wherein retrieving product data based on the received data set(s) includes determining the identity of at least one product transfer transaction based on the data of the product transfer transaction(s) contained in the received data set(s) and retrieving the product data associated with the determined at least one identity of the product transfer transaction(s).

11. The method according to claim 1, wherein retrieving product data based on the received data set(s) includes determining at least one product transfer transaction associated with the material based on the data of the material transfer transaction(s) contained in the received data set(s) and retrieving the product data of the determined product transfer transaction(s).

12. The method of claim 1, wherein determining the transfer balance includes:
determining the total amount of material from the retrieved material data and determining the total amount of product(s) containing the material from the retrieved product, and
comparing the determined total amount of material with the determined total amount of product(s).

13. An apparatus for tracking at least one transfer associated with a material and at least one product containing said material in a decentral material network comprising a distributed ledger that includes multiple member nodes, the distributed ledger including transfer transactions containing material data associated with the material and transfer transactions containing product data associated with the at least one product containing the material, the apparatus comprising:
one or more computing nodes; and one or more computer-readable media having thereon computer-executable instructions that are structured such that, when executed by the one or more computing nodes, cause the apparatus to perform the method as claimed in claim 1.

14. A method of using the material transfer balance as generated according to claim 1, the method comprising using the material transfer balance to validate material transfers associated with a material and product(s) containing the material.

15. A computer element with instructions, which when executed on one or more computing node(s) is configured to carry out the steps of the method of claim 1.

16. A method of using the material transfer balance as generated by the apparatus of claim 13, the method comprising using the material transfer balance to validate material transfers associated with a material and product(s) containing the material.

17. A computer element with instructions, which when executed on one or more computing node(s) is configured to be carried out by the apparatus of claim 13.
